(19) United States
(12) Patent Application Publication
(10) Pub. No.: US 2025/0155976 A1
(43) Pub. Date: May 15, 2025

(54) NONLINEAR AND FLEXIBLE INFERENCE OF LATENT FACTORS AND BEHAVIOR FROM SINGLE-MODAL AND MULTI-MODAL BRAIN SIGNALS

(71) Applicant: UNIVERSITY OF SOUTHERN CALIFORNIA, Los Angeles, CA (US)

(72) Inventors: Maryam Shanechi, Los Angeles, CA (US); Hamidreza Abbaspourazad, Los Angeles, CA (US); Eray Erturk, Los Angeles, CA (US)

(73) Assignee: UNIVERSITY OF SOUTHERN CALIFORNIA, Los Angeles, CA (US)

(21) Appl. No.: 18/945,162

(22) Filed: Nov. 12, 2024

Related U.S. Application Data
(60) Provisional application No. 63/597,635, filed on Nov. 9, 2023.

(51) Int. Cl. G06F 3/01; G06F 17/13

(52) U.S. Cl. CPC G06F 3/015; G06F 17/13

(57) ABSTRACT

A system for nonlinear flexible inference of latent factors and/or nonlinear flexible decoding of behavior from brain signals can include one or more processors configured to: receive a plurality of brain signals; and perform flexible inference of latent factors and/or flexible decoding of behavior from the plurality of brain signals via a neural network. A brain-computer interface can include the system for nonlinear flexible inference of latent factors and/or nonlinear flexible decoding of behavior from brain signals.

### CROSS-REFERENCE TO RELATED APPLICATIONS

This application is based upon and claims the benefit of and priority to U.S. Provisional Patent Application No. 63/597,635 entitled “NONLINEAR AND FLEXIBLE INFERENCE OF LATENT FACTORS AND BEHAVIOR FROM SINGLE-MODAL AND MULTI-MODAL BRAIN SIGNALS,” filed on Nov. 9, 2023, the entire content of which is incorporated by reference herein.

### STATEMENT AS TO FEDERALLY SPONSORED RESEARCH

This invention was made with government support under Grant No(s). DP2-MH126378 and CCF-1453868, awarded by the National Institutes of Health (NIH) and the National Science Foundation (NSF), respectively. The government has certain rights in the invention.

### FIELD

The present disclosure generally relates to systems, apparatuses, and methods for flexible and real-time decoding of neural/brain activity using deep learning approaches.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

Neural population activity exhibits rich spatiotemporal dynamical patterns that underlie human or animal behaviors and functions. Developing precise data-driven models of these complex dynamical patterns to study the neural basis of behavior and to develop advanced neurotechnology for decoding and modulation of brain states is desirable. Given the spatiotemporal correlations in population activity, how this activity evolves in time can be modeled more efficiently in terms of lower-dimensional latent factors. These factors can lead to new scientific discovery by revealing new low-dimensional structures in coordinated population activity, which are not directly evident from the high-dimensional activity itself or from single-unit activities. These latent factors can also decode behavior to enable enhanced neurotechnology and brain-computer interfaces (BCIs) also referred to as brain-machine interfaces (BMIs). However, to enable incorporating latent factor models across broad biomedical engineering applications such as BCIs, developing models that not only are accurate by characterizing potential nonlinearities, but also enable the flexible inference of latent factors to seamlessly extract them is desirable. Despite much progress, this objective of simultaneously enabling both accurate nonlinear dynamical modeling and flexible inference has remained elusive.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a model architecture for a Dynamical Flexible Inference for Nonlinear Embeddings” (DFINE) with two sets of latent factors and an inference procedure for the model, in accordance with various embodiments.

FIG. 2 illustrates events for various experimental tasks, in accordance with various embodiments.

FIG. 3 illustrates a DFINE model learning the dynamics on nonlinear manifolds and enabling inference in the presence of missing observations in simulated datasets, in accordance with various embodiments.

FIG. 4 illustrates a DFINE model outperforming benchmark methods in behavior and neural prediction accuracy, and more robustly extracting the ring-like manifold in single-trials in a saccade dataset, in accordance with various embodiments.

FIG. 5 illustrates a DFINE model outperforming benchmark methods in behavior and neural prediction accuracy, and more robustly identifying the more predictive ring-like manifold structure in single-trials in motor datasets, in accordance with various embodiments.

FIG. 6 illustrates a supervised DFINE model extracting latent factors that are more behavior predictive, in accordance with various embodiments.

FIG. 7 illustrates that a DFINE model can perform both causal and non-causal inference with missing observations and do so more accurately through non-causal inference, in accordance with various embodiments.

FIG. 8 illustrates neural prediction accuracy as a function of the latent factor dimension for various datasets and methods, in accordance with various embodiments.

FIG. 9 illustrates a DFINE model's neural reconstruction accuracy with smoothing is also better than that of a sequential autoencoder (SAE) method, in accordance with various embodiments.

FIG. 10 illustrates example latent factor trajectories for the motor datasets, in accordance with various embodiments.

FIG. 11 illustrates a DFINE model more robustly extracts the ring-like manifold structure in single-trials during the preparation period of the saccade task, in accordance with various embodiments.

FIG. 12 illustrates an unsupervised DFINE model having higher neural prediction accuracy compared to the supervised model as expected as the latter optimizes for both neural and behavior prediction rather than just for neural prediction, in accordance with various embodiments.

FIG. 13 illustrates the DFINE model outperforms various other models in the presence of missing observations and the improvements growing with more missing samples.

FIG. 14 illustrates example behavior trajectories for the four experimental datasets, in accordance with various embodiments.

FIG. 15 illustrates analysis directly on the observed neural population activity, revealing a ring-like manifold structure, in accordance with various embodiments.

FIG. 16 illustrates neural prediction accuracy as a function of latent factor dimensions of a DFINE model, in accordance with various embodiments.

FIG. 17 illustrates characterization of performance vs. the observation noise and the amount of training data for a DFINE model, in accordance with various embodiments.

FIG. 18 illustrates that a DFINE model outperforms SAE model in the presence of stochasticity in the nonlinear temporal dynamics of the Lorenz attractor system.

FIG. 19 illustrates how a DFINE model outperforms various other models in the 3D naturalistic reach-and-grasp task also when using a local field potentials (LFP) modality as the neural observations instead of Gaussian-smoothed firing rates.

FIG. 20 illustrates how a DFINE model outperforms another model across the four experimental datasets.

FIG. 21 illustrates visualizations of simulated nonlinear manifolds, in accordance with various embodiments.

FIG. 22 illustrates a model architecture for a Multiscale Real-time Inference of Nonlinear Embeddings (MRINE) model, in accordance with various embodiments.

FIG. 23 illustrates an MRINE multiscale encoder design, in accordance with various embodiments.

FIG. 24 illustrates latent reconstruction accuracies for the stochastic Lorenz attractor simulations, in accordance with various embodiments.

FIG. 25 illustrates behavior decoding accuracies for a dataset when spike and LFP channels had the same (top row) and different (bottom row) timescales, in accordance with various embodiments.

FIG. 26 illustrates behavior decoding accuracies in a dataset when spike and LFP channels had both missing samples and different timescales, in accordance with various embodiments.

FIG. 27 illustrates behavior decoding accuracies for a dataset when spike and LFP channels had missing samples and the same timescale, in accordance with various embodiments.

FIG. 28 illustrates cross-modal one-step-ahead prediction accuracies for the nonhuman primate dataset when spike and LFP channels had different timescales, in accordance with various embodiments.

FIG. 29 illustrates 3D PCA visualizations of trial-averaged latent factors inferred by various models, in accordance with various embodiments.

FIG. 30 illustrates behavior decoding accuracies in a dataset when time-dropout was disabled (ρₜ=0), and spike and LFP channels had both missing samples and different timescales, in accordance with various embodiments.

FIG. 31 illustrates a system for at least one of nonlinear flexible inference of latent factors and flexible decoding of behavior from brain signals, in accordance with various embodiments.

FIG. 32 illustrates a method for training a nonlinear neural network to form a trained machine learning model, in accordance with various embodiments.

FIG. 33 illustrates a method for utilizing the trained machine learning model, in accordance with various embodiments.

FIG. 34 illustrates a method for utilizing the trained machine learning model, in accordance with various embodiments.

FIG. 35 illustrates a system for modeling a plurality of brain signals, in accordance with various embodiments.

FIG. 36 illustrates a schematic view of a brain-computer interface, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Disclosed herein is process and method for developing a non-linear dynamic model and deploying a developed non-linear dynamic model. In various embodiments, the developed non-linear dynamic model can (i) capture potential nonlinearities in neural population activity and (ii) have a data-efficient architecture for generalizable data-driven training. To enable flexible inference, the developed non-linear dynamic model can (iii) be capable of both causal/real-time and non-causal inference simultaneously and/or (iv) allow for inference in the presence of missing neural measurements, which commonly happen in wireless neural interfaces due to wireless link interruptions. Flexible inference for biomedical engineering applications to develop neurotechnology and advanced implantable and/or wireless neural interfaces such as BCIs or closed-loop deep brain stimulation (DBS) systems may be desirable. Accordingly, a flexible inference is also important for neuroscience investigations that involve causal validations or closed-loop perturbations, long-term monitoring of brain states such as mood and other mental states, or behaviors in unconstrained environments. A flexible nonlinear inference can enable the same developed non-linear dynamic model (i.e., a trained model) not only to operate causally and recursively in real-time, but also to leverage the entire length of data non-causally for more accurate inference; this ability is important for causal validation of a model of population dynamics, or for model-based closed-loop control of neural states with neurostimulation or DBS, e.g., in mental disorders. A flexible inference can also make the model robust to missing or noisy neural measurements that happen commonly in wireless neural interfaces. Current dynamical models of neural population activity do not satisfy all the above four properties simultaneously.

Many of the existing models for studying the neural basis of behavior and/or decoding and modulation of brain states are linear or generalized linear, often in the form of linear dynamical models (LDMs) and are used to infer low-dimensional latent factors or build BCIs. However, while LDMs are data-efficient to train and allow for flexible inference with Kalman filtering, they cannot capture the potential nonlinearities in the neural population activity to describe it more accurately. Beyond linear models, recent studies have leveraged the richness of deep learning to develop generative dynamical models of neural population activity. However, while these models can capture nonlinearity, they do not meet all the flexible inference properties outlined above. Because the inference for these models is not solvable analytically unlike LDMs, they need to empirically train an inference or recognition network simultaneously with their generative network, usually requiring the entire length of data over a trial. Thus, their inference depends on how the specific inference network is structured and is not flexible to satisfy all the above properties. Indeed, in prior generative models, including sequential autoencoders (SAEs) or LDMs with nonlinear embeddings, inference is non-causal, and real-time and/or recursive inference is not addressed. Further, in these models, inference in the presence of missing observations is not addressed and using zeros instead of missing observations can yield sub-optimal performance by changing the inherent values of missing observations during inference. Similarly to these generative models, predictive dynamical models of neural activity that use forward recurrent neural networks (RNNs) also do not enable the flexible inference properties above. While these models can perform causal inference, they do not allow for non-causal inference to leverage all data, and they do not address inference with missing observations similar to above generative models.

Disclosed herein is a method and process for developing a neural network model that encompasses both flexible inference and accurate nonlinear description of neural population activity via a network architecture comprising two sets of latent factors rather than one as follows. One set, referred to herein as “dynamic factors,” captures how neural population activity evolves over a low-dimensional nonlinear manifold and approximates this evolution as linear or locally linear or piece-wise linear. The other set, referred to herein as “manifold factors” characterizes how this nonlinear manifold is embedded in the high-dimensional neural activity space. By separating these two sets of factors while training them together end-to-end, the nonlinearity can be captured in the manifold factors while keeping the dynamics on the manifold linear, thus enabling flexible inference by exploiting the Kalman filter on the nonlinear manifold. This method is referred to herein as a “Dynamical Flexible Inference for Nonlinear Embeddings” (DFINE). DFINE models the temporal dynamics as linear on top of the nonlinear manifold layer but not in the space of neural population activity. Using nonlinear simulations with the Lorenz attractor system that DFINE can still capture nonlinear dynamics well through the combination and joint training of the nonlinear manifold and linear dynamics on this nonlinearity, which is a design choice made to enable flexible inference. DFINE can find the best nonlinear latent manifold/embedding over which dynamics can be approximated as linearly as possible because the dynamics and manifold are trained together rather than separately.

As described further herein, DFINE was validated in nonlinear simulations with multiple manifolds and with the stochastic Lorenz attractor system and then compared to benchmark linear LDM and nonlinear SAE methods across diverse behavioral tasks, brain regions and neural signal modalities. DFINE not only enabled flexible inference capabilities in nonlinear modeling, but also performed significantly more accurately than both linear and nonlinear benchmarks on these neural datasets. First, given its flexible inference, DFINE robustly compensated for missing observations and seamlessly performed both causal and non-causal inference of latent factors. Second, compared to the linear and nonlinear benchmarks, DFINE significantly improved the accuracy in predicting neural activity and behavior, and in recovering the low-dimensional nonlinear neural manifold in single trials. Finally, DFINE was extended, in accordance with various embodiments, to supervise the model training with behavior data, such that the extracted latent factors from neural activity are more predictive of behavior. DFINE enables the new capability of flexible inference in nonlinear neural network modeling and enhances neural description, which are desirable for biomedical engineering and neurotechnology such as BCIs and closed-loop neuroscience applications.

### Experimental Results

### Methods Discussion

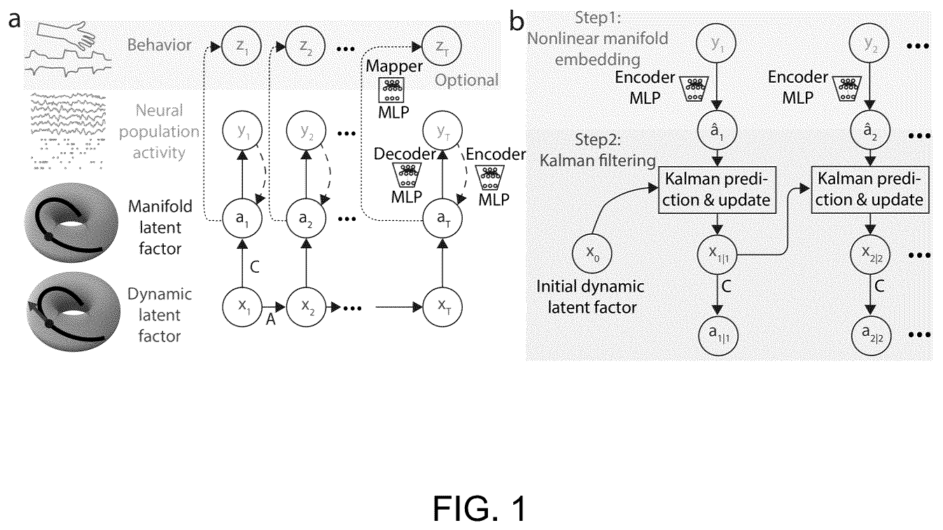

First, DFINE was developed as a neural network model of neural population activity with the ability to perform flexible nonlinear inference by jointly learning both the nonlinear latent manifold structure in neural data and a linear model of temporal dynamics on this nonlinearity. The associated learning and inference methods were also developed. To model neural population activity, two sets of latent factors were defined: the dynamic latent factors which characterize the linear temporal dynamics on a nonlinear manifold, and the manifold latent factors which describe this low-dimensional nonlinear manifold that is embedded in the high-dimensional neural population activity space, as shown in FIG. 1a. This separation allows the model to capture nonlinearity with the link between the manifold factors and neural population activity, while keeping the dynamics on the manifold linear, which is a design choice to enable flexible inference. As such, these two separate sets of latent factors together enable all the above flexible inference properties by allowing for Kalman filtering on the manifold while also capturing nonlinearity via the manifold embedding. This flexible inference includes the ability to perform both causal (filtering) and non-causal (smoothing) inference, and to perform inference in the presence of missing observations. Further, inference is done recursively-such that the current inferred factor can be used to get the next inferred factor without the need to reprocess the neural data-, thus enabling computational efficiency and real-time implementation as shown in Table 1 below. Also, flexible inference can be done directly on continuous neural data streams common in BCIs.

TABLE 1

| | | | Latent factor | Latent factor |
|---|---|---|---|---|
| Method | Training Time | Training time | interface | inference |
| Name | (total, sec) | (per epoch, sec) | (train, sec) | (test, sec) |
| LDM | 13.63 ± 0.17 | NA | 1.45 ± 0.03 | 0.36 ± 0.01 |
| SAE | 6224.73 ± 329.55 | 4.44 ± 0.18 | 291.64 ± 24.40 | 72.04 ± 6.29 |
| fLDS | 11573.04 ± 129.80 | 57.87 ± 0.65 | 11.03 ± 0.18 | 2.73 ± 0.03 |
| DFINE | 723.94 ± 16.55 | 3.62 ± 0.08 | 2.21 ± 0.21 | 0.51 ± 0.07 |

The total training and total inference run-times in seconds for a toy dataset with 250 trials where each trial has 200 time-steps.
Run times are provided for all methods in this study.
The data was trained and tested in a 5-fold cross-validation manner providing 5 run-time values for each case.
The numbers are reported in mean ± std across the 5 folds.
The inference times are the total time for inferring all time-steps across all trials within the train/test sets.
The models are trained on xeon-2650v2 CPU with CentOS Linux 7 operating system.
The developer's Python code and deep learning framework was used in each instance, the details of which are provided in their codebase and prior papers.
For LDM, there is no iterative optimization like the other methods, so the total and per-epoch training times are identical.

The manifold latent factors were taken as a lower-dimensional representation of the neural population activity, and the mapping between the two is characterized with an autoencoder whose decoder and encoder networks were modeled by multi-layer perceptrons (MLP), as shown in FIG. 1a. MLPs were used to model nonlinearities because they are universal approximators of any nonlinear function under mild conditions. Having captured the embedding nonlinearity with the autoencoder, the model was now enabled to have flexible inference properties by having the dynamic and manifold latent factors form an LDM which is learned together with the manifold embedding, as shown in FIG. 1a. In this LDM, the manifold latent factors are noisy observations from the dynamic latent factors that constitute the LDM states and whose time-evolution is described through a linear dynamic model with additive noise (FIG. 1a). Using backpropagation, all the model parameters were jointly learned by minimizing the prediction error of future neural observations from past neural observations (future-step-ahead prediction error), measured using the mean-squared error (MSE). Instead of MSE, any other prediction error measure or any other measure of interest for the observations can also be optimized for training. Since both dynamic and manifold latent factors are learned together in an end-to-end gradient-descent optimization, DFINE learns the best nonlinear manifold over which dynamics can be approximated as linearly as possible. Alternatively, a variational approach to optimize evidence lower bound (ELBO) can be employed to learn DFINE model parameters. This can be done by also optimizing a Kullback-Leibler (KL) divergence term computed between a fixed prior distribution and approximate posterior distribution obtained via nonlinear manifold embedding and Kalman filtering/smoothing.

For situations when specific behavioral variables are of interest and available during training, DFINE was extended to supervised DFINE so that learning of the model is informed by how predictive the learned manifold latent factors would be not only of future neural observations but also of behavioral variables. This can be done during training by introducing an extra link from the manifold latent factors to behavior variables (FIG. 1a)—termed the mapper network modeled with an MLP—, and by modifying the cost function to include both behavior and neural prediction errors. Instead, or in addition to, these prediction errors, any other measure of interest related to behavior and/or neural observations can also be used. This additional link can be purely added during training and removed afterwards during inference on test data. This leads to a learned model that is identical to the original model in terms of architecture and inference but just with different parameter values. Inference is again done purely from neural observations.

In addition to showing that DFINE enables the new capability of combining neural network modeling with flexible inference, DFINE was also compared to benchmarks of linear LDM and nonlinear SAE. To show the generalizability of DFINE across behavioral tasks, brain regions and neural signal modalities, analyses was performed across multiple independent datasets. For SAE, the architecture named latent factor analysis via dynamical systems or LFADS was used, which is a common benchmark nonlinear model of neural population activity. For each dataset and algorithm, the latent factors were inferred from the trained models. The latent factors correspond to the manifold latent factors in DFINE, to the state in the state-space model in LDM, and to the dynamic factors (the representation layer right after the generator RNN) in SAE. In various embodiments, smoothing was used to infer the latent factors for all methods for consistency in comparisons. The quantifications disclosed herein are reported using five-fold cross-validation, where the values are calculated in the held-out test set. After extracting the latent factors, in the training set, classification or regression models were learned for discrete or continuous behavioral variables, respectively.

The cross-validated behavior prediction accuracy was evaluated with area under the curve (AUC) of the receiver operating characteristic for discrete classifiers and with Pearson's correlation coefficient (CC) for continuous regressions. The neural prediction accuracy is calculated with one-step-ahead prediction accuracy, the accuracy of predicting neural observations one step into the future from their past. The neural reconstruction accuracy, defined as how well inferred latent factors-whether via causal filtering or via non-causal smoothing-reconstruct the current neural observations, was also evaluated. Error values are computed in normalized root MSE (NRMSE) defined as root MSE normalized by the variance of the ground-truth observations to allow pooling the values across sessions given scaling differences. To assess how well the structure of the manifold is revealed in single-trials, topological data analysis (TDA) was applied on the extracted latent factor trajectories in test sets.

Referring now to FIG. 1a, the DFINE model with two sets of latent factors is illustrated, in accordance with various embodiments. These sets comprise the dynamic latent factors and manifold latent factors, respectively, which are separated to enable flexible inference but trained/learned jointly end-to-end. The relationship between the manifold latent factors and neural observations is modeled with an autoencoder with MLP encoder and decoder networks, where the manifold latent factor is the bottleneck representation. The dashed line from neural observations to the manifold latent factor is only used for inference and is not part of the generative model. The dynamic and manifold latent factors together form an LDM with the manifold factors being noisy observations of the dynamic factors, which constitute the LDM states. The temporal evolution of the dynamic latent factors is described with a linear dynamic equation. All model parameters (LDM, autoencoder) are learned jointly in a single optimization by minimizing the prediction error of future neural observations from their past. In the unsupervised version, after training the DFINE model, a mapper MLP network was used to learn the mapping between the manifold latent factors and behavior variables. In various embodiments, DFINE was also extended to supervised DFINE where the mapper MLP network is simultaneously trained with all other model parameters in an optimization that now minimizes both neural and behavior prediction errors.

Referring now to FIG. 1b, the inference procedure with DFINE is illustrated, in accordance with various embodiments. A noisy estimate of manifold latent factors using the nonlinear manifold embedding at every time point was determined. With the aid of the dynamic equation, Kalman filtering was used to infer the dynamic latent factors x_{t|k} and refine an estimate of the manifold latent factors a_{t|k}, with subscript t|k denoting inference at time t from all neural observations up to time k, y_{1:k}. In addition to real-time filtering (t|t) which is displayed, DFINE can also perform smoothing or filtering in the presence of missing observations. Inference method is the same for unsupervised and supervised DFINE and is done purely based on neural observations as shown here (only model training is different).

### Neural Recordings and Experimental Task

The DFINE method was demonstrated using both extensive numerical simulations with multiple nonlinear manifolds and with the stochastic Lorenz attractor system as well as four diverse existing datasets containing distinct behavioral tasks, brain regions, and neural signal modalities to show the generalizability of the method. Two neural modalities were modeled that are commonly used, which are smoothed neuronal firing rates and LFP. These datasets contained four behavioral tasks, and three out of the four datasets had unit-based recordings with a relatively high number of tuned channels (at least 40 per session). The details of these four datasets are as follows: a saccade dataset and three independent motor datasets.

### Saccade Dataset

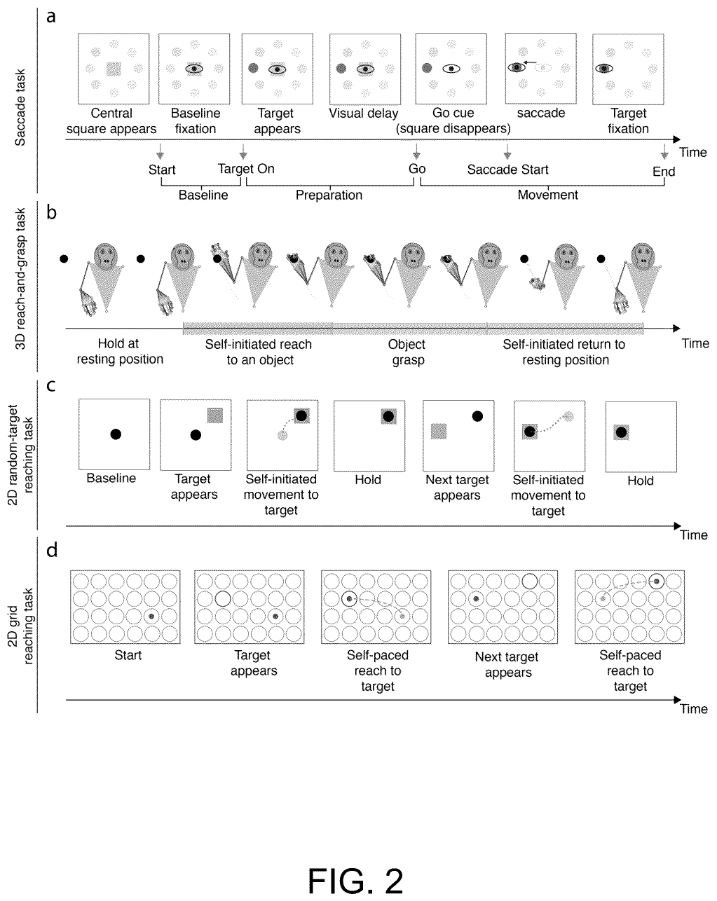

A macaque monkey (Monkey A) performed saccadic eye movements toward 1 of 8 peripheral targets on a screen in a visually-guided oculomotor delayed response task, which is referred to as the saccade task in short (FIG. 2a). Each trial started by presenting a central fixation square to which the monkey was required to maintain fixation, followed by Target On, Go, Saccade Start and End time events (FIG. 2a). The preparation period was defined as the time between Target On and Go events, and the movement period as the time between Go and End events (FIG. 2a). Raw LFP signals in lateral prefrontal cortex (PFC) were processed given their importance in saccadic eye movement representation.

### Motor Datasets

Three independent motor datasets were used to show generalizability. For all motor datasets, the Gaussian-smoothed firing rates were taken as the neural signal to be modeled. For one of the datasets (3D naturalistic reach-and-grasp), the LFPs were also modeled. The first motor dataset was a 3D naturalistic reach-and-grasp task, where the monkey performed naturalistic reach-and-grasps toward diverse locations in 3D space while the 3D endpoint hand position and velocity were measured and taken as the behavior variables (Monkey J, FIG. 2b). The neural recordings covered primary motor cortex (M1), dorsal premotor cortex (PMd), ventral premotor cortex (PMv) and PFC. The second motor dataset was a publicly available 2D random-target reaching task, where PMd activity was recorded while the monkey made sequential 2D reaches on a screen using a cursor controlled with a manipulandum, and the 2D cursor position and velocity were tracked as the behavior (Monkey T, FIG. 2c). The third motor dataset was a publicly available 2D grid reaching task, where M1 activity was recorded while the monkey controlled a cursor on a 2D surface in a virtual reality environment via its fingertip movements whose 2D position and velocity were tracked as the behavior (Monkey I, FIG. 2d).

Referring now to FIG. 2a, Events for the saccade task are shown. At the beginning of each trial, the subject is required to fixate its eyes on a baseline location. After fixation, the target is illuminated on the screen (Target On event). After a visual delay, the fixation square disappears, which signals a go command (Go event). Then the subject performs the saccade (Saccade Start event) and holds fixation on target to receive a liquid reward (End event). The preparation and movement periods were defined as the durations between Target On and Go events, and the duration between Go and End events, respectively.

Referring now to FIG. 2b, in the naturalistic 3D reach-and-grasp task, an experimenter continuously moved a wand to diverse locations within a 3D area in front of the subject. The subject naturalistically reached to the object on the wand, grasped it, and returned its arm to the resting position. Movements were self-initiated without a specific go cue or timing instructions to isolate any parts of movements.

Referring now to FIG. 2c, in the 2D random-target reaching task, the subject controlled a cursor using a manipulandum. The task consisted of several sections, with each section having 4 sequential reaches to random targets (shown by the shaded squares) that appeared on the screen (only 2 reaches are shown here for simplicity). The subject performed self-initiated movements towards the targets. After a brief hold on a target, the next random target appeared at a pseudo-random location on the screen.

Referring now to FIG. 2d, in the 2D grid reaching task, the subject controlled a cursor on a 2D grid in a virtual reality environment by moving its fingertip. Once the target appeared on one of the circular locations on the grid, the subject performed a self-paced movement towards the target, after which another target appeared from the set of possible targets.

### In Various Embodiments, DFINE Successfully Learned the Dynamics on Diverse Nonlinear Manifolds and Enabled Flexible Inference in Simulated Datasets.

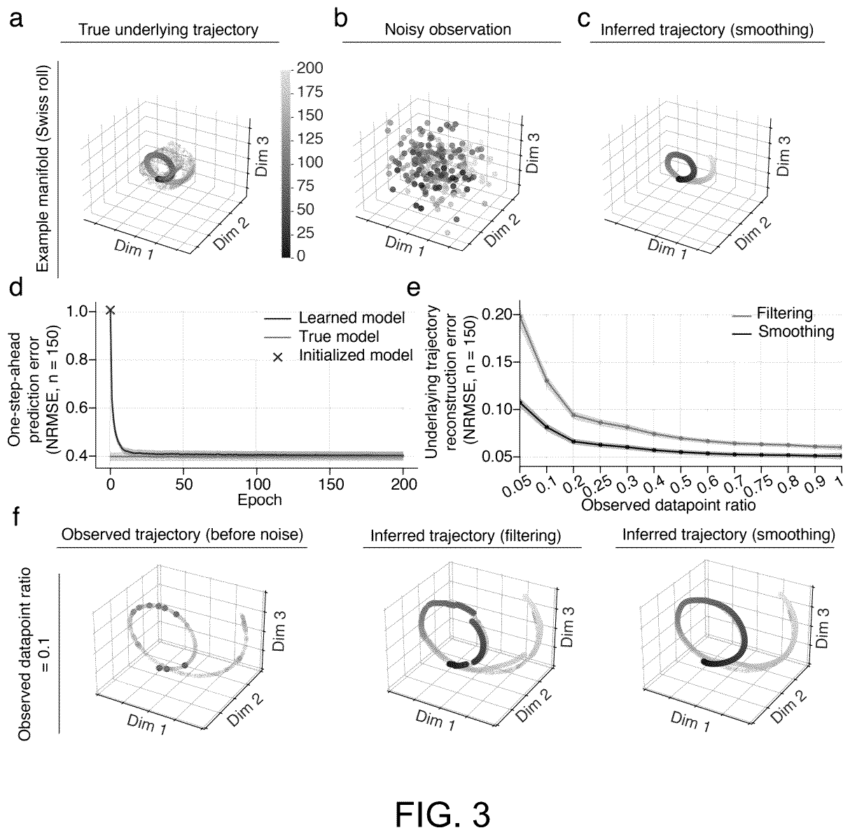

The DFINE model and its learning algorithm in numerical simulations was validated first. Given the plausibility of ring-like, spiral-like and toroidal structures in neural population activity in prior studies, and to show the generality of the method to manifold types, trajectories on Swiss roll, Torus, and ring-like manifolds were simulated as a proof of concept (FIG. 3). Thirty different simulated sessions (each with 250 trials) were synthesized with randomly selected noise values and with the manifolds uniformly chosen from the above possibilities. Given the noisy nature of neural recordings, the simulation observations were taken as the noisy realizations of the trajectories on the manifold (FIG. 3b).

It was found that DFINE can correctly infer the trajectories on the manifolds both with causal filtering and with non-causal smoothing, even from noisy observations (FIGS. 3a-c) and even in the presence of missing observations (FIGS. 3e, 3f). One-step-ahead prediction error was used as a measure of convergence to the true model. First, the learned model's one-step-ahead prediction error converged to that of the true model (FIG. 3d). Indeed, the difference between learned and true model errors, normalized by the true model error, decreased from 1.564±0.110 (mean±sem) for randomly initialized models to 0.012±0.004 for the learned model, indicating convergence (FIG. 3d). Second, the same DFINE model enabled inference both causally and non-causally, and even in the presence of missing observations (FIGS. 3e, 3f). To show this, neural observation datapoints were randomly dropped from each trial to achieve a desired observed datapoint ratio, which is defined as the ratio of the datapoints that are maintained/not-dropped to the total number of datapoints. This random drop was done to emulate the common problem of data drop in wireless neural interfaces. DFINE predictions, even for ratios as low as 0.2, were similar to when all datapoints were retained. This showed that DFINE could use the learned dynamics to compensate for missing observations (FIG. 3e, smoothing curve). Further, even for ratios as low as 0.05, DFINE still performed better than chance-level of 1 (FIG. 3e; P<8.7×10⁻⁷, Nₛ=150, one-sided Wilcoxon signed-rank test). Third, smoothing significantly improved the inference of trajectories (P<8.7×10⁻⁷, Nₛ=150, one-sided Wilcoxon signed-rank test) because it could also leverage the future neural observations, and this improvement due to smoothing was more prominent in the lower observed datapoint ratios (FIG. 3e). Indeed, smoothing led to successful predictions even for ratios as low as 0.1 (FIG. 3f). Overall, the simulation analysis showed that DFINE can learn the dynamics on diverse nonlinear manifolds, perform flexible inference both causally (filtering) and non-causally (smoothing), and succeed even in the presence of missing observations.

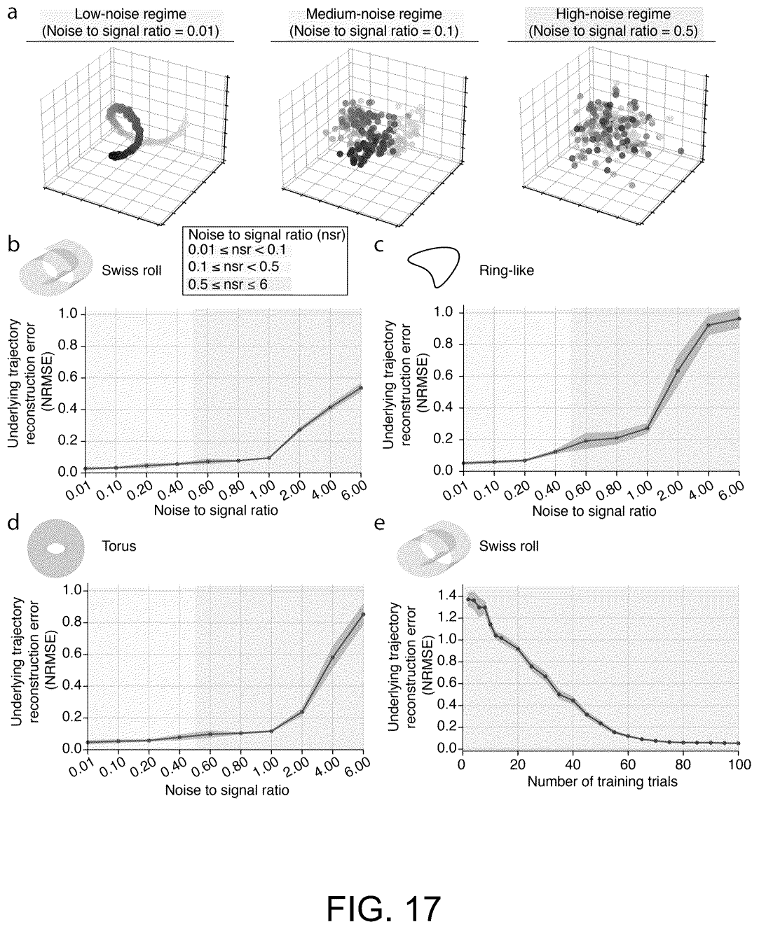

Having established DFINE's capability in learning the dynamics on nonlinear manifolds and enabling flexible inference, how the observation noise and amount of training data affect DFINE's performance were characterized (FIG. 17). For each manifold type, the observation noise was swept to obtain low to high noise to signal ratios, defined as the ratio of noise standard deviation to the ground-truth signal standard deviation (FIGS. 17a-d). It was found that while DFINE's performance decreased with higher noise as expected, its performance stayed robust in a wide range of noise to signal ratios even including high ratios (FIGS. 17b-d). Also, this robustness held for all three manifolds examined here but the range for robustness varied across manifolds with the Swiss roll manifold and the ring-like manifold being the most and the least robust to noise, respectively in these simulations (compare FIG. 17b vs. FIG. 17c). To characterize DFINE's performance with the available training data, the number of training trials were varied for the Swiss roll manifold from 1 to 100 at a noise to signal value similar to that in the main simulations in FIG. 3 and it was observed that DFINE started to predict significantly in the test set at around 20 training trials and converged at around 75 training trials (FIG. 17e).

Referring now to FIG. 3, DFINE successfully learning the dynamics on nonlinear manifolds and enabling inference in the presence of missing observations in simulated datasets is illustrated, in accordance with various embodiments. Referring now to FIG. 3a, A sample simulated trajectory is shown for an example manifold (Swiss roll). Shaded evolution on the trajectory indicates time evolution into a trial as shown in the shaded bar. Referring now to FIG. 3b, noisy observations of the trajectory are shown with the same shaded convention as in FIG. 3a. Referring now to FIG. 3c, After learning the DFINE model, inferred trajectory with smoothing is shown, which is essentially on top of the true trajectory. Referring now to FIG. 3d, the learned models' one-step-ahead prediction error converges to that of the true models. The plot shows the mean of one-step-ahead prediction error for the learned and true models across all simulated sessions, cross-validation folds and trials. The shaded areas represent the 95% confidence bound of the mean. DFINE starts from a randomly initialized model, which has a chance-level one-step-ahead-prediction of 1. Referring now to FIG. 3e, Neural reconstruction error between the inferred and true trajectories is shown for smoothing and filtering across various observed datapoint ratios. Dots represent the mean across simulated sessions and cross-validation folds and shaded area represents the 95% confidence bound. Smoothing and filtering errors are essentially unchanged as samples are dropped even up to 0.2 and 0.5 observed datapoint ratios, respectively. These errors are significantly lower than chance-level of 1 for all ratios (P<8.7×10⁻⁷), one-sided Wilcoxon signed-rank test). Smoothing is more accurate than filtering across all ratios (P<8.7×10⁻⁷, one-sided Wilcoxon signed-rank test). Referring now to FIG. 3f, an example trajectory with missing observations and its smoothing and filtering inference for observed datapoint ratio of 0.1.

DFINE Extracts Single-Trial Latent Factors that Accurately Predict Neural Activity and Behavior.

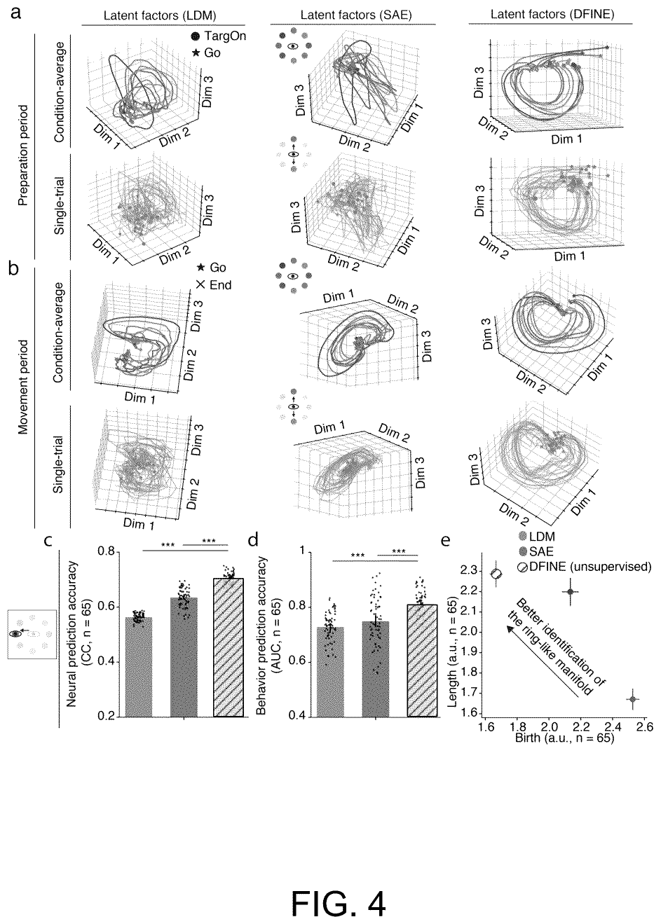

DFINE was then applied on the four independent datasets to show that it not only allows for flexible inference but also for accurate neural and behavior prediction. DFINE's single-trial latent factors were compared to those of the linear (LDM) and nonlinear (SAE) benchmarks. The condition-average and single-trial latent factor trajectories was first visualized for the saccade task during both preparation (FIG. 4a) and movement periods (FIG. 4b), where condition was defined as the saccade target. It was found that the latent factors inferred with DFINE not only captured inter-condition variabilities during movements even in single-trials (FIG. 4b), but also exhibited smooth trajectories with a discernable manifold structure in these noisy single-trials (FIGS. 4a and 4b). This was unlike LDM that generally had noisier single-trial latent factor trajectories, and unlike SAE whose latent factor trajectories, while smooth, captured smaller inter-condition variabilities in single-trials (FIGS. 4a and 4b).

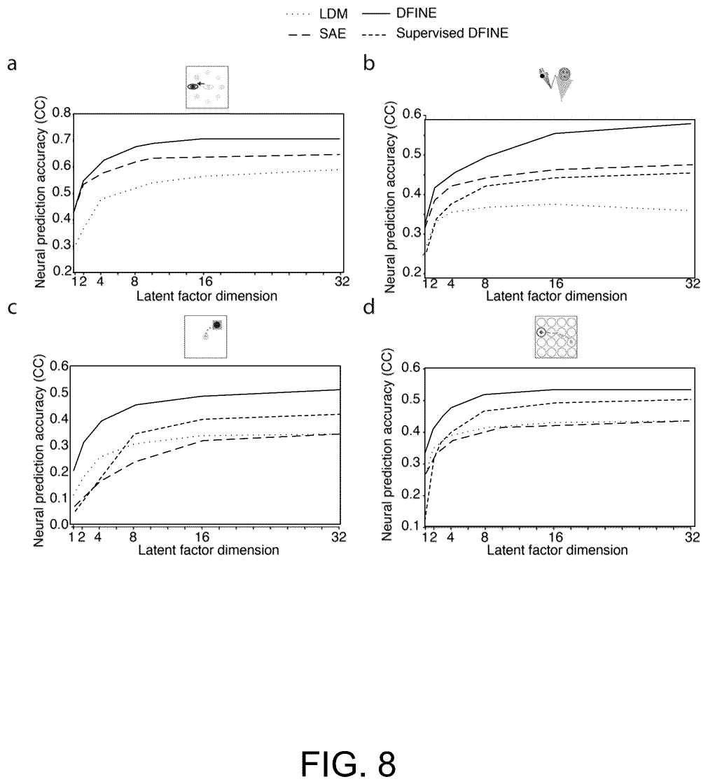

This ability to capture inter-condition variability was quantified by computing the single-trial neural and behavior prediction accuracies of 16-dimensional (16D) latent factors for each method. This dimension was picked because it was sufficient for the performance of all methods to converge across all datasets (FIG. 8; SAE's dynamic state dimension is taken to be much higher at 64). Note that during a given trial, SAE does not predict the neural observations into the future from its past because it needs to use all neural observations until the end of a trial to get the initial condition and then to extract the factor trajectories at every time-step from this initial condition. Thus, while the one-step-ahead neural prediction error for DFINE and LDM was computed using only past neural observations, SAE was given the advantage of doing neural reconstruction with smoothing based on both past and future neural observations instead.

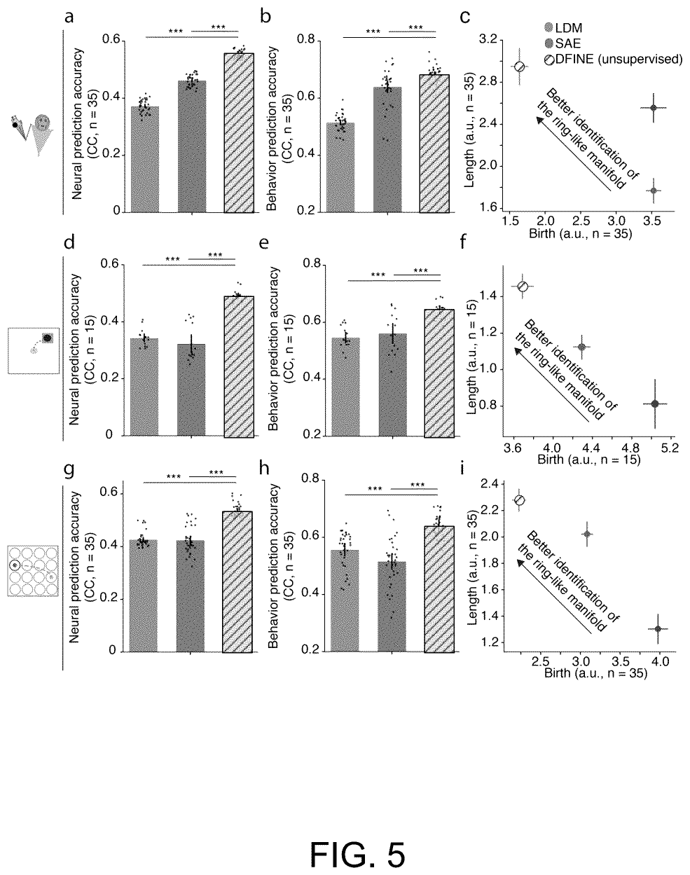

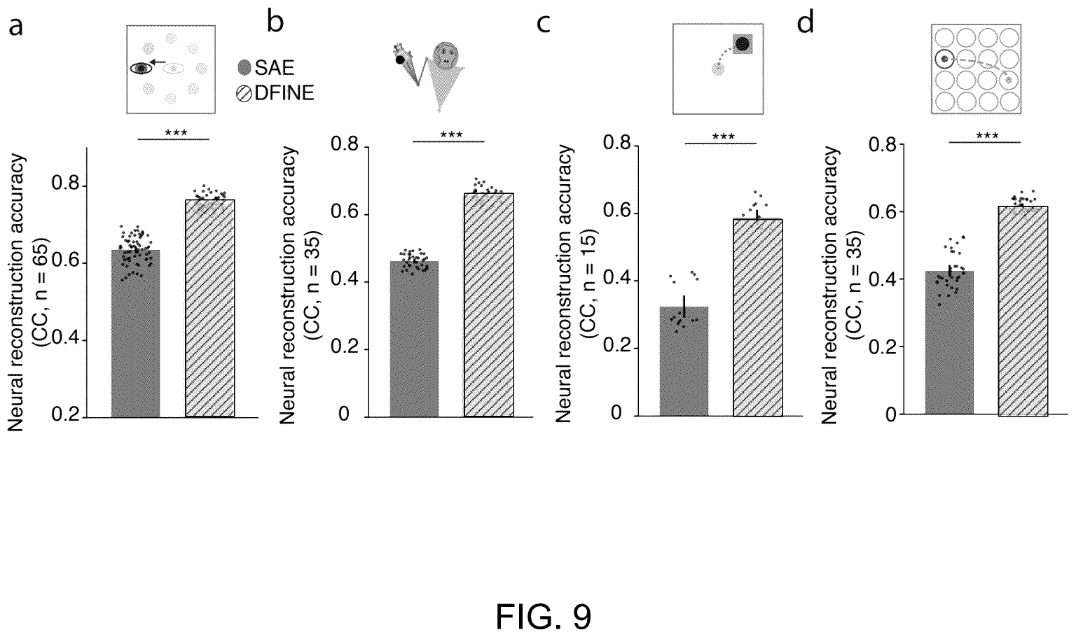

DFINE was better at neural prediction not only compared with LDM but also compared with SAE across all datasets (FIG. 4c, FIGS. 5a, 5d and 5g). In comparison with SAE and LDM, respectively, DFINE improved the accuracy of neural prediction in the 3D naturalistic reach-and-grasp task by 19.9±1.8% and 49.0±3.7% (FIG. 5a; P<1.2×10⁻⁷, Nₛ=35, one-sided Wilcoxon signed-rank test), in the 2D random-target reaching task by 56.7±26.7% and 43.9±7.3% (FIG. 5d; P<3.1×10⁻⁵, Nₛ=15, one-sided Wilcoxon signed-rank test), in the 2D grid reaching task by 27.8±6.5% and 25.9±2.2% (FIG. 5g; P<1.2×10⁻⁷, Nₛ=35, one-sided Wilcoxon signed-rank test), and in the saccade task by 10.9±1.7% and 24.7±1.3% (FIG. 4c; P<1.2×10⁻¹², Nₛ=65, one-sided Wilcoxon signed-rank test). Similar results held for the comparison of DFINE with SAE in terms of neural reconstruction with smoothing (FIG. 9).

In addition to its better neural prediction, DFINE also had higher behavior prediction accuracy compared to LDM and SAE in all tasks. In the motor tasks, improvements compared to SAE and LDM, respectively, were 7.7±5.7% and 33.0±4.0% in the 3D naturalistic reach-and-grasp task (FIG. 5b; P<3.7×10⁻⁵, Nₛ=35, one-sided Wilcoxon signed-rank test), 16.8±17.1% and 17.9±3.9% in the 2D random-target reaching task (FIG. 5e; P<2.6×10⁻⁴, Nₛ=15, one-sided Wilcoxon signed-rank test), and 21.2±7.5% and 11.6±7.0% in the 2D grid reaching task (FIG. 5h; P<5.2×10⁻⁷, Nₛ=35, one-sided Wilcoxon signed-rank test). Also, for the saccade task, DFINE latent factors better predicted the saccade target class during the movement periods, with the saccade target classification AUC being 9.7±3.9% and 11.8±2.9% better than SAE and LDM, respectively (FIG. 4d; P<9.6×10⁻⁷, Nₛ=65, one-sided Wilcoxon signed-rank test.

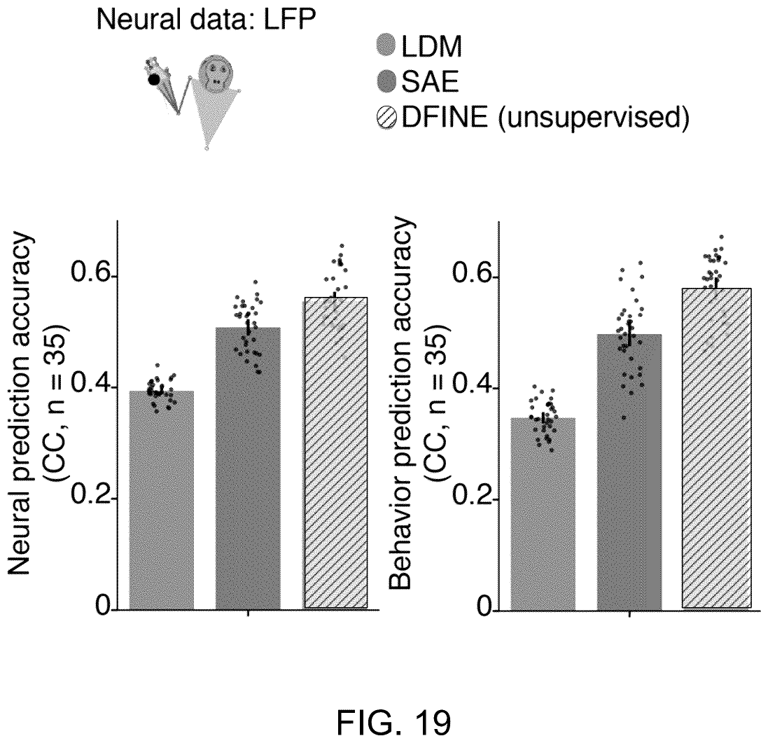

To show that DFINE improvements in the motor datasets are not specific to the smoothed firing rate modality and to provide further comparative evidence, DFINE was compared with LDM and SAE in the 3D naturalistic reach-and-grasp dataset by processing the LFP signals instead of Gaussian-smoothed firing rates. DFINE again had a higher neural and behavior prediction accuracy for LFPs (FIG. 19; P<2.7×10⁻⁵, Nₛ=35, one-sided Wilcoxon signed-rank test).

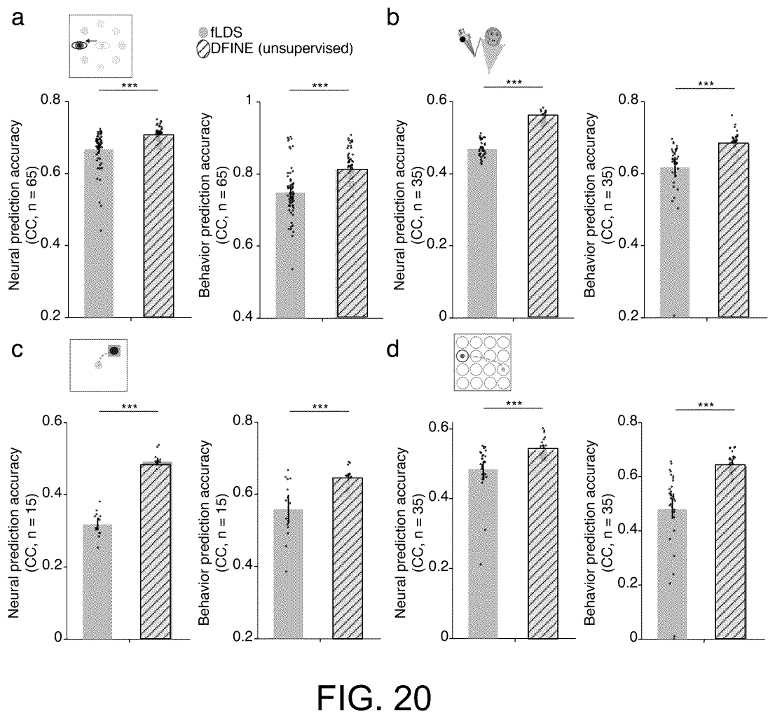

As another comparative evidence and to further highlight the methodological advances of DFINE, DFINE was also compared to fLDS, which is another competitive model of neural population activity that uses a linear dynamical model with a direct nonlinear observation equation. First, the new flexible inference capability that is a main goal of DFINE is not enabled with fLDS, which instead performs non-causal smoothing and does not address missing data. Second, it was found that in addition to the benefit that DFINE's inference is flexible, DFINE also had a higher neural and behavior prediction accuracy compared with fLDS across all the four experimental datasets (FIG. 20; P<3.1×10⁻⁵, Nₛ>15, one-sided Wilcoxon signed-rank test). The comparison with fLDS also shows the benefit of the methodological advances in DFINE, in accordance with various embodiments, including its extra noisy manifold factor layer, its new flexible inference capability, its future-step-ahead prediction cost, and/or ultimately its better performance. Finally, DFINE's runtime for learning and inference was also faster than the other nonlinear benchmark methods, i.e., SAE and fLDS (see Table 1 disclosed previously herein).

These results demonstrate that in addition to enabling flexible inference, DFINE's single-trial latent factors were more predictive of both behavior and neural activity compared to the benchmark linear and nonlinear methods, in accordance with various embodiments.

Simulations with the Nonlinear Stochastic Lorenz Attractor System

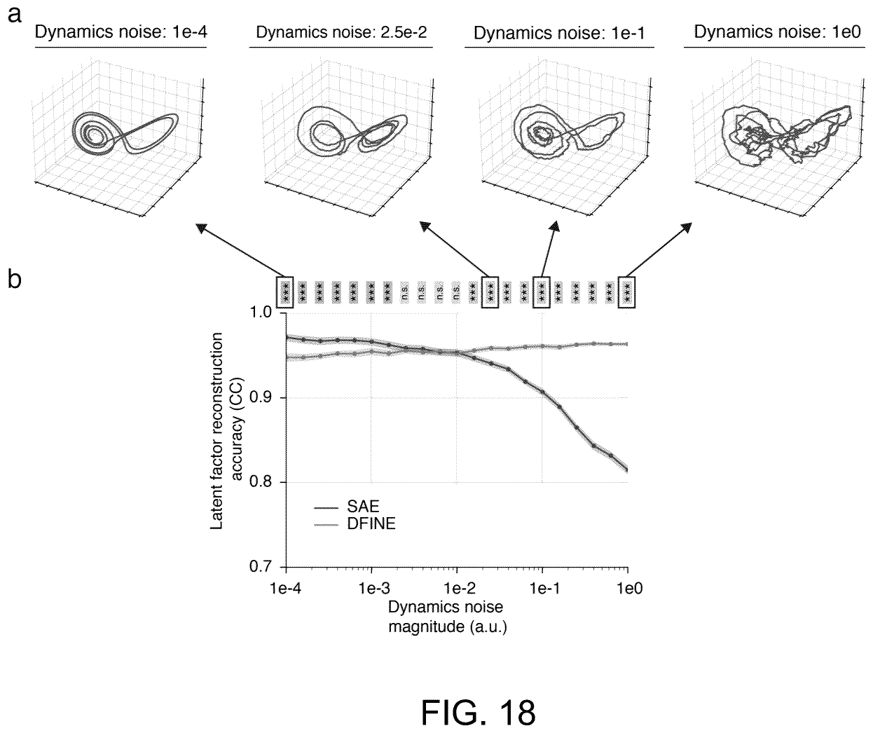

To gain intuition as to why DFINE outperforms SAE in the data, a stochastic Lorenz attractor system was simulated, which is a dynamical system with nonlinear temporal dynamics. The stochasticity/noise in state dynamics was swept in these simulations. FIG. 18a shows examples of latent factor trajectories for the Lorenz attractor system under various stochasticity/noise regimes. After training the DFINE and SAE models in the training set, the reconstruction accuracy of the latent factors in the test set was then quantified. First, DFINE was able to capture the Lorenz nonlinear temporal dynamics through its combined learning of a nonlinear latent manifold and linear dynamics on this manifold, resulting in accurate latent trajectory reconstruction, as shown in FIG. 18b. Second, as the stochasticity increased in nonlinear dynamics: 1) SAE performance degraded while DFINE's performance stayed robust, as shown in FIG. 18b, and 2) DFINE significantly outperformed SAE (FIG. 18b when the state dynamics noise is larger than ˜10⁻²). These Lorenz simulations suggest that one reason why DFINE outperforms SAE on the four neural datasets can be because of inherent stochasticity in these neural dynamics, and because potential model mismatches can exist for any model of real-world data and these mismatches can also be captured as noise/stochasticity (no model is perfect for data). It is also noted that DFINE's inference does take into account stochasticity and directly uses the stochastic noise variables.

Referring now to FIG. 4, in the saccade dataset, DFINE outperformed benchmark methods in behavior and neural prediction accuracy, and more robustly extracted the ring-like manifold in single-trials. Referring now to FIGS. 4a and 4b, condition-average (top row) and single-trial (bottom row) latent factor trajectories for an example session are shown for DFINE, LDM and SAE during the preparation period (FIG. 4a) and for the movement period (FIG. 4b). Each line represents one target, i.e., condition. Referring now to FIG. 4c, DFINE had significantly higher neural prediction accuracy compared to LDM and SAE. All models had 16-dimensional latent factors (see FIG. 8 for convergence). Dots represent the accuracy in each cross-validation fold of each session, bars represent the mean, and error bars represent the 95% confidence bound. Asterisks indicate significance of comparison (*: P<0.05, **: P<0.005 and ***: P<0.0005, one-sided Wilcoxon signed-rank test). Referring now to FIG. 4d, behavior prediction measured by target classification accuracy was better with DFINE compared to LDM and SAE with convention being the same as in FIG. 4c. Referring now to FIG. 4e, TDA analysis on single-trial latent factors during the movement period is shown. The top left area of the plots corresponds to more robust extraction of the ring-like manifold. Circles represent mean across sessions and cross-validation folds and error bars represent the 95% confidence bound. TDA's most persistent 1-dimensional hole had a significantly earlier birth and lasted significantly longer for DFINE compared to LDM and SAE (P<5×10⁻⁴, one-sided Wilcoxon signed-rank test.

In Accordance with Various Embodiments, DFINE More Robustly Extracts the Manifold Structure in Single-Trials.

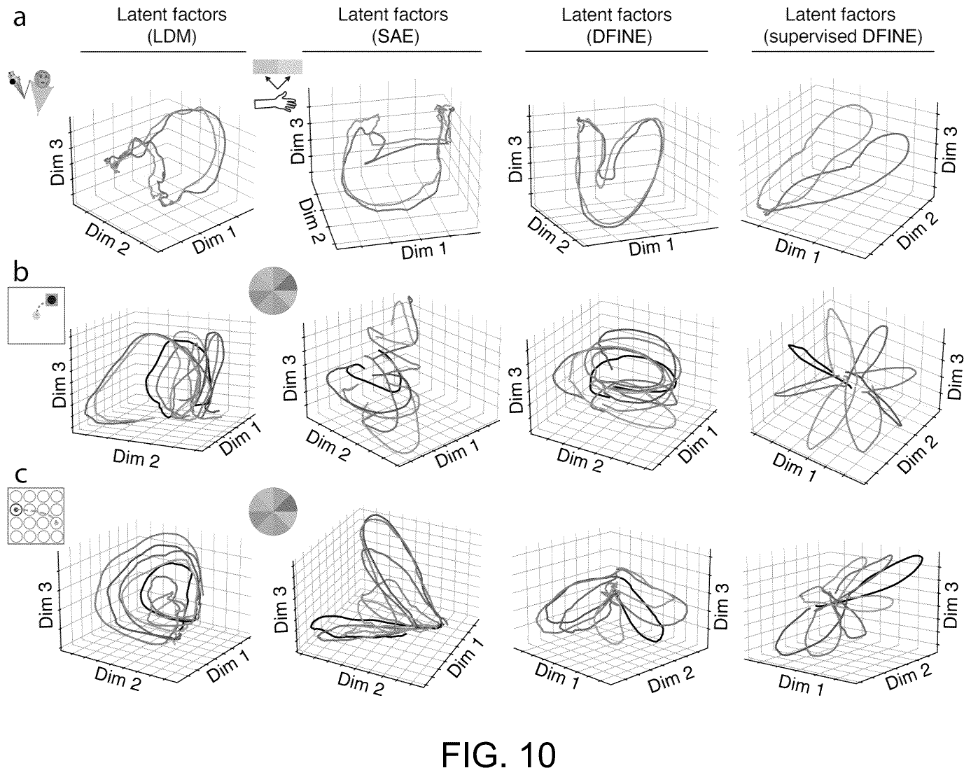

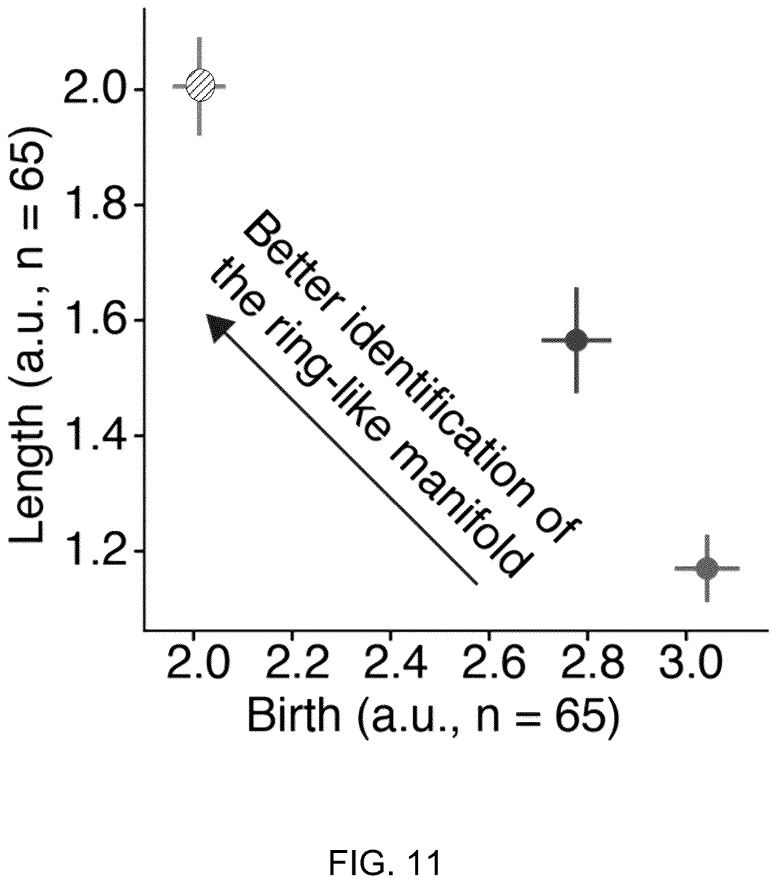

Because the latent trajectories in DFINE were more predictive of neural activity and behavior, visualization and TDA analyses were used on these trajectories to study the latent manifold structure in data and it was found that these trajectories reveal a ring-like manifold structure (FIGS. 4a and 4b, and FIG. 10). Further, DFINE more robustly captured this ring-like nonlinear manifold structure in single-trial data compared with LDM and SAE. First, visualization of DFINE revealed a ring-like manifold structure in both condition-average and single-trial latent factors during both preparation and movement periods in the saccade task (FIGS. 4a and 4b) and during the movement periods in the motor tasks (FIG. 10). This ring-like structure was much less apparent in single trials for LDM and SAE (e.g., FIG. 4a), while it could be seen in their condition-average trajectories (e.g., FIG. 4b and FIG. 10). To quantify this observation and whether DFINE was better able to extract this manifold in single-trials, TDA was used, which uses persistent homology to quantify whether there exist holes in data, and if so how many. TDA finds multi-dimensional holes (e.g., 1D hole is a ring and 2D hole is a 2D void) in data by growing the radius of E-balls around datapoints. If holes exist, a model that finds holes which are born earlier and last longer—i.e., are more persistent—is more robust in revealing the manifold structure in single-trials. Consistent with observing a ring in low-dimensional visualizations above, TDA revealed a persistent 1D hole in low-dimensional latent factors, which was then analyzed. Compared with the other methods, in DFINE, the birth of the TDA's most persistent 1D hole was significantly earlier and its length was significantly larger during both preparation and movement periods for the saccade task (FIG. 4e and FIG. 11; P<5×10⁻⁴, one-sided Wilcoxon signed-rank test), and during movement periods for all motor tasks (FIGS. 5c, 5f, 5i; P<5×10⁻⁴, one-sided Wilcoxon signed-rank test).

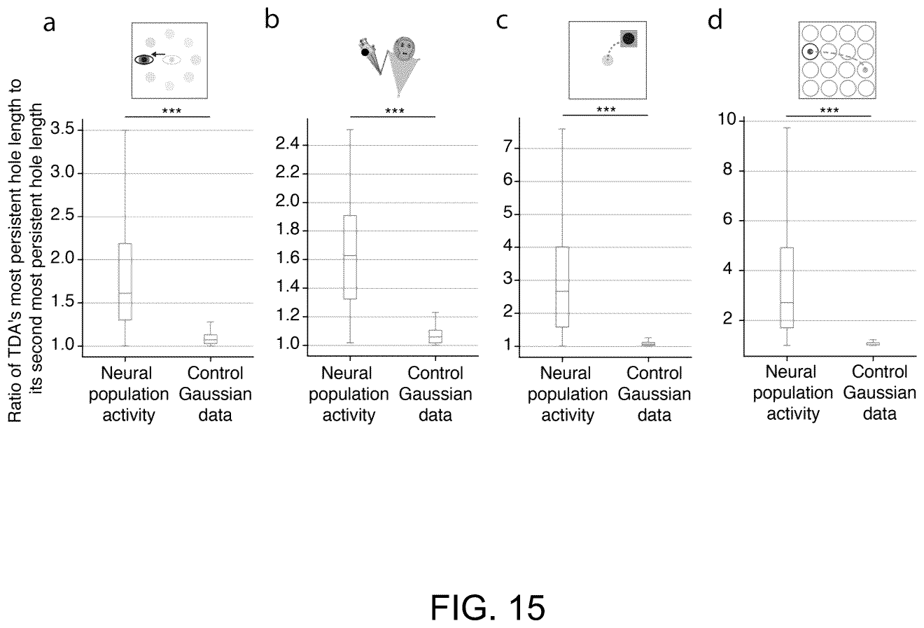

To show that the ring-like manifold structure is not an artifact of DFINE or other models, TDA was directly performed on the neural population activity without any modeling. TDA determined a significant ring-like manifold structure across all four datasets (FIG. 15). It is not desired nor is it assumed in DFINE to have a ring-like manifold in data, as shown for example in the Torus or Swiss Roll simulations neither of which has a ring-like manifold (FIG. 3). To conclude that the ring-like manifold is a good description of neural data, the TDA metric was combined with the neural prediction metric; together, these metrics show not only that there exists a ring-like manifold in DFINE latent trajectories but also that this manifold predicts the neural dynamics better in FIGS. 4 and 5. Overall, these results show that the more predictive ring-like manifold structure was more robustly captured with DFINE, in accordance with various embodiments.

Referring now to FIG. 5, In the motor datasets, DFINE outperforms benchmark methods in behavior and neural prediction accuracy, and more robustly identifies the more predictive ring-like manifold structure in single-trials. Figure convention for bars, asterisks for significance and for the TDA plots are the same as FIG. 4. DFINE again outperformed benchmarks in terms of neural prediction, behavior prediction, and robust extraction of the manifold structure in the naturalistic reach-and-grasp task (FIGS. 5a-c), random-target reaching task (FIGS. 5d-f), and 2D grid reaching task (FIGS. 5g-i).

### In Various Embodiments, DFINE can Also be Extended to Enable Supervision and Improve Behavior Prediction Accuracy.

To allow for considering behavior measurements when available during training, a supervised DFINE was developed to train a model with latent factors that are optimized for both neural and behavior predictions (FIG. 1a). To validate the supervised DFINE method, it was applied to the motor datasets in which behavior measurements were available during training. Note that once trained, the supervised DFINE inference only takes neural activity as input to infer the latent factors.

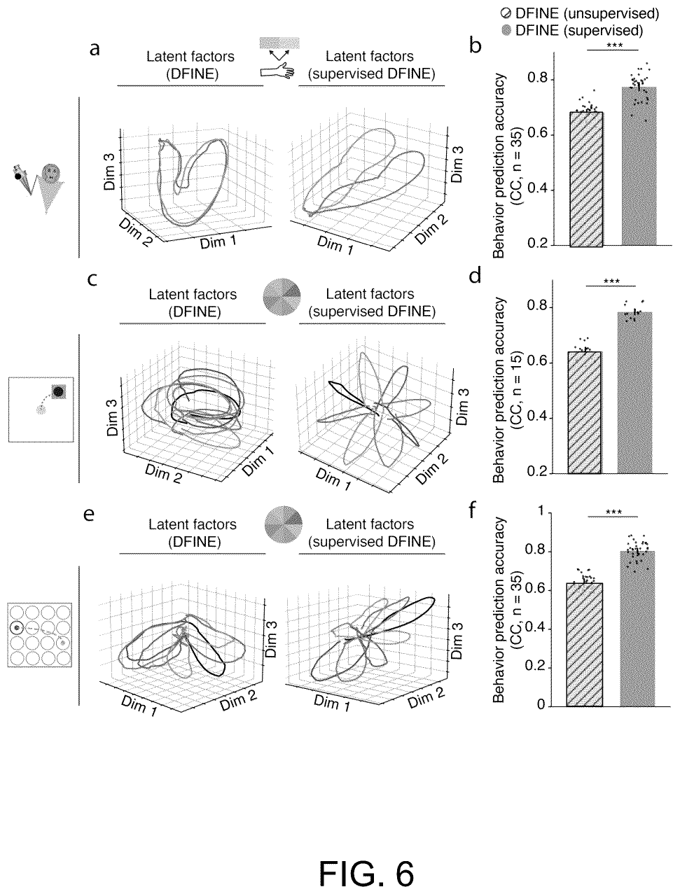

In accordance with various embodiments, supervised DFINE successfully improves the behavior prediction accuracy even though its model and inference architectures are identical to those in the unsupervised DFINE, and even though its inference only takes the same neural observations as input (FIG. 6). The latent factors of supervised DFINE better distinguished different task conditions across all motor datasets compared to those of unsupervised DFINE (FIGS. 6a, 6c and 6e). Consistent with this observation, supervised DFINE significantly improved the behavior prediction accuracy compared to unsupervised DFINE across all motor datasets (FIGS. 6b, 6d and 6f). These improvements were 13.6±2.7% in the 3D naturalistic reach-and-grasp task (FIG. 6b; P<3.1×10⁻⁵, Nₛ=35, one-sided Wilcoxon signed-rank test), 22.3±1.8% in the 2D random-target reaching task (FIG. 6d; P<2.6×10⁻⁴, Nₛ=15, one-sided Wilcoxon signed-rank test), and 24.5±2.5% for the 2D grid reaching task (FIG. 6f; P<1.2×10⁻⁷, Nₛ=35, one-sided Wilcoxon signed-rank test). The above analyses serve to confirm the success of supervised DFINE because the fact that behavior variables are considered during model training does not definitively imply that latent factors extracted in the test set will be more behavior predictive. This is because in the test set, the inference method for extraction is identical to the unsupervised DFINE just with different parameter values and the behavior variables are still unknown during inference. Thus, this analysis shows that supervised DFINE learns a model with the same flexible inference properties that can this time extract more behavior predictive latent factors from neural data alone.

Referring now to FIG. 6, supervised DFINE extracting latent factors that are more behavior predictive is illustrated, in accordance with various embodiments. FIG. 6a shows examples of condition-average latent factor trajectories for the unsupervised (left) and supervised (right) DFINE for the 3D reach-and-grasp task. Each line represents one condition (i.e., movement to left or right). Supervised DFINE better separates different conditions. FIG. 6b shows supervised DFINE improved the prediction of behavior, i.e., continuous position and velocity, in the 3D reach-and-grasp task. Dots represent cross-validation folds across experimental sessions and the convention for bars, error bars and asterisks are the same as FIG. 4. Similar results held for the 2D random target reaching task (FIGS. 6c-d) and 2D grid reaching task (FIGS. 6e-f), where here each condition is a direction angle interval/sector (for example, all movements whose direction angle is between 0-45 degrees regardless of where they start/end).

In Various Embodiments, DFINE can Perform Flexible Inference with Missing Observations.

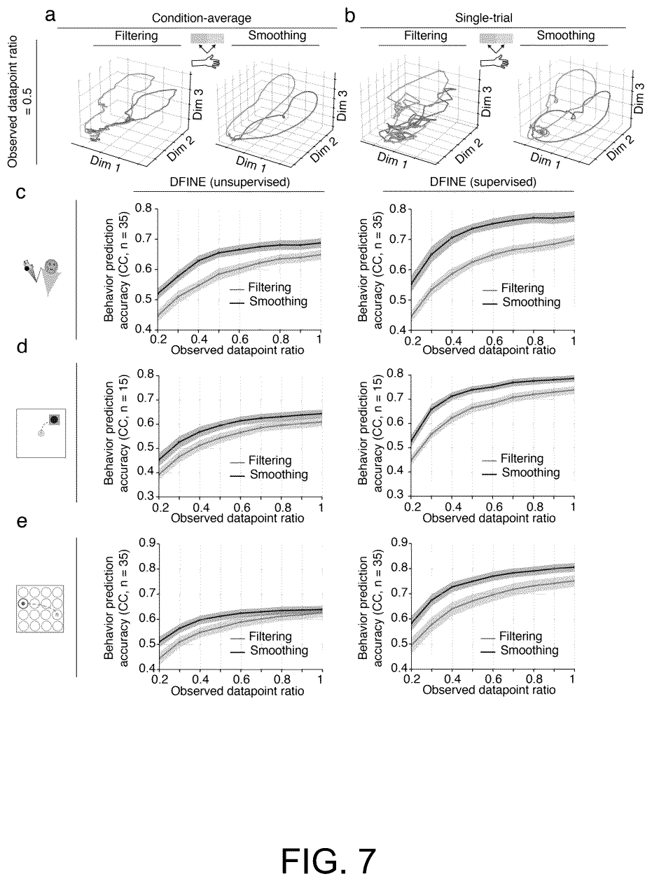

It was next investigated whether DFINE can perform inference even in the presence of missing neural observations, which can for example commonly happen in wireless neural interfaces (FIG. 7). To do so, neural observations were dropped throughout the recordings and inference was performed in two ways: 1) filtering inference (causal) that only uses the past and present available neural observations, 2) smoothing inference (non-causal) that uses all available neural observations.

Behavior prediction accuracies of DFINE remained relatively unchanged even when dropping up to 40% of observations (0.6 ratio), and remained well above the chance-level of 0 even when dropping 80% of observations (lowest 0.2 ratio) (FIGS. 7c-e; P<5×10⁻⁴, one-sided Wilcoxon signed-rank test). Indeed, both filtering and smoothing inferences were robust to data drop. Also, behavior prediction accuracy with smoothing inference was significantly better than that with filtering inference across all observed datapoint ratios (FIGS. 7c-e). FIGS. 7a and 7b visually demonstrate that the smoothing inference yields more accurate reconstruction of the low-dimensional latent trajectories as it leverages both past and future available observations. Indeed, the smoothed trajectories at observed datapoint ratio of 0.5 (FIG. 7a) look very similar to those for observed datapoint ratio of 1 (FIG. 6a right panel), showing ability to compensate for missing observations.

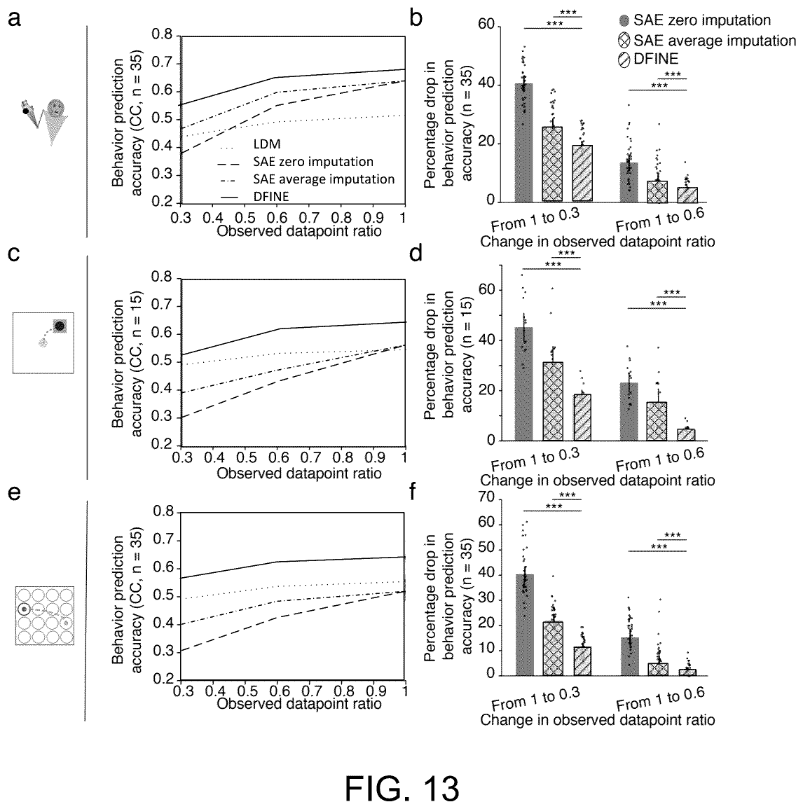

DFINE was then compared with SAE in terms of inference in the presence of missing observations. Because SAE's decoder network is modeled with an RNN, it is structured to take neural observation inputs at every time-step. To handle missing observations for SAE at inference, they were imputed with zeros in the test set as previously done, the latent factors were extracted, and the associated behavior prediction accuracy was computed. DFINE outperformed SAE and, interestingly, this improvement grew larger at lower observed datapoint ratios (FIG. 13). Indeed, DFINE's degradation in performance due to missing observations was lower than that of SAE (FIGS. 13b, 13d and 13f). In a control analysis, another imputation technique was performed for SAE, where the missing observations were imputed with the average of the last and the next/future seen observation samples. Again, with this imputation technique, DFINE outperformed SAE (FIG. 13) and showed more robustness as the observed datapoint ratio decreased (FIGS. 13b, 13d and 13f). In addition, DFINE's performance remained above LDM's performance even in the lower observed datapoint ratios (FIGS. 13a, 13c and 13e). These analyses show that DFINE can flexibly compensate for missing observations and perform both causal and non-causal inference with missing data. These analyses also show that DFINE's non-causal inference can leverage future data for more accurate prediction when real-time processing is not needed.

Referring now to FIG. 7, DFINE can perform both causal and non-causal inference with missing observations and do so more accurately through non-causal inference, in accordance with various embodiments. FIGS. 7a-b show examples of condition-average (a) and single-trial (b) latent factor trajectories for filtering and smoothing inference with missing observations in the 3D reach-and-grasp task. Both DFINE filtering and smoothing captured the low-dimensional structure in single-trials, with smoothing doing so more accurately than filtering. FIG. 7c shows behavior prediction accuracies of filtering and smoothing inferences across various observed datapoint ratios for the 3D naturalistic reach-and-grasp task. Lines represent the mean across experimental sessions and cross-validation folds, and the shaded areas represent the 95% confidence bound. Similar to FIG. 7c, FIG. 7d illustrates the 2D random-target reaching task. FIG. 7e is also similar to FIG. 7c, showing the 2D grid reaching task. See also FIG. 13.

DFINE, a new neural network model of neural population activity, was developed in accordance with various methods described herein. DFINE allows for flexible inference, whether causally or recursively in real-time, non-causally to leverage the entire data length, or in the presence of missing neural observations. DFINE jointly learned the combination of a nonlinear latent manifold and linear dynamics on top of this manifold, which together allowed it to achieve flexible inference and accurate prediction in diverse neural datasets and in nonlinear simulations including several manifolds and the Lorenz attractor system. In various embodiments, this flexible inference capability is beneficial for biomedical engineering applications such as neurotechnology and BCI design or wireless neural interfaces, and when studying the neural basis of behavior through causal closed-loop perturbation or through long-term or unconstrained experiments. In addition to enabling flexible inference, DFINE more accurately predicted both the neural and behavioral data and more robustly discovered the low-dimensional neural manifold compared with linear and nonlinear benchmarks, for example for smoothed firing rates and LFP. A new learning procedure was also developed. The new learning procedure also utilized a new cost function to allow supervision for DFINE and to extract latent factors that are more behavior predictive, with no changes to the model architecture and inference properties otherwise. These capabilities and advantages generalized across four independent datasets with different behavioral tasks, brain regions, and neural signal modalities.

DFINE Allows for Neural Network Modeling while Also Enabling Flexible Inference.

Many studies have shown that neural population activity can be summarized with a significantly lower-dimensional latent manifold structure, often using linear dimensionality reduction methods. To model the nonlinearities in neural population activity and better learn the underlying manifold structure, while some studies have used spline loop fitting or extensions of isometric feature mapping (Isomap), most works have leveraged the power of neural networks. As models of neural data, neural networks have either been in the form of generative models, whether static or dynamic, or in the form of predictive models or decoders. DFINE provides a dynamic generative model of neural data but with the major difference that it provides the new capability for flexible inference, in addition to being accurate in neural, behavior, and manifold prediction. DFINE has flexible inference in that it simultaneously enables recursive real-time/causal inference, non-causal inference, and inference in the presence of missing observations. Such flexible inference is critical for neurotechnology design but is not achieved by prior neural network models of population activity.

Prior generative network models do not provide these flexible inference properties. This is because their inference cannot be solved analytically and is usually performed with an inference/recognition network that is trained in conjunction with the generative network to approximate the posterior distribution of latent factors. Therefore, inference properties depend on how the inference network architecture is structured to process the neural observations. In many cases, the inference network structure does not allow for real-time recursive estimation of latent factors, and/or does not directly enable inference in the presence of missing observations. For example, SAEs, which are often used as benchmarks for neural data, are most suitable for non-causal processing and are not amenable to recursive or causal/real-time inference in ongoing time-series as has been shown for example in natural language processing or speech recognition literature. This is because of the sequential autoencoder structure in which, with every new neural observation, the encoder RNN has to update the generator RNN's initial latent state at time zero; then the generator RNN needs to reset and re-estimate its latent states throughout all time-steps to infer the latent factor at the time of the new neural observation. This non-recursive procedure is a large burden for real-time inference as the current estimate of latent factors cannot be utilized to get the next time-step's factors. Indeed, all the latent factors have to be re-computed for every single new neural observation. In contrast, DFINE allows for recursive inference without the need to re-compute any of the past or current factors. Also, while the initial condition in autoencoders has a critical role by summarizing the time-series information and by enabling their powerful structure, the initial condition does not have an important role in DFINE or LDM and its effect disappears as the filter goes to steady state. Another difference is that DFINE works on continuous data streams, which are encountered in neurotechnologies such as BCIs, both for inference and training.

In terms of addressing missing observations, while imputation techniques such as zero-padding have been used for SAEs or in general for models with RNNs, it is known that such techniques usually yield sub-optimal performance. This is because imputing missing observations with zero in inference distorts the observation values. Similar to SAEs, in prior linear dynamical models with nonlinear embeddings, i.e., fLDS that is compared to, inference again needs to use all neural observations and is non-causal, therefore recursive causal inference or inference with missing observations is not addressed. Similarly to these prior generative networks, prior predictive networks with RNN-based methods also do not allow for flexible inference because, this time, they do not enable non-causal inference given their forward RNN architecture and do not address missing observations as RNNs are structured to take inputs at every time-step. Further, unlike DFINE, these predictive networks do not directly learn a generative model of neural population activity and thus are largely used for decoding purposes rather than to study/infer neural population latent structure.

Beyond biomedical engineering, neurotechnology, and neuroscience, dynamical modeling of sequential data has great importance for other domains such as for processing of videos or text. However, neural data introduce distinct challenges that DFINE's modeling architecture was specifically designed to handle. First, to consider the noisy nature of neural activity, stochastic noise variables were modeled and learned in DFINE. This allows uncertainties to be modeled and allows for fitting the noise values to any specific dataset across diverse tasks, brain regions, and neural data modalities (e.g., firing rates or LFP). In contrast, because video or text observations are deterministically observed or are much less noisy, in applications of videos and text, the stochastic noise variables are not necessarily included in the modeling or are tuned manually as hyperparameters. In addition, instead of the common method of optimizing the evidence lower bound (ELBO) of data likelihood when noise variables exist, the prediction accuracy of data was optimized into the future because optimizing ELBO could be challenging and a major goal of a dynamic model is future prediction; indeed, instabilities were observed when using ELBO as the optimization cost. The reason DFINE can leverage this future-step-ahead prediction as its cost is its new flexible inference capability that can efficiently and recursively compute this cost during training. Finally, unlike video/text applications, a supervised learning algorithm was developed for DFINE to allow for modeling two different but related sets of sequential data (neural activity and behavior here) and motivate the latent factors to be predictive of not just one but both time-series/sequences. In addition to modeling of neural/behavior data in neuroscience, this supervised learning algorithm in DFINE can be used for future applications of video/text data where another measured time-series/sequence is also of interest, e.g., inferring latent factors of videos regarding movements.

### Linear Temporal Dynamics on the Nonlinear Manifold and Extension Across Neural Modalities.

While DFINE develops a neural network model with nonlinear manifold embeddings, it keeps the temporal dynamics on the manifold linear for several reasons. First, the separation of the dynamic and manifold latent factors and the linear form of the former is what allows for the flexible inference capability, which is critical for biomedical engineering applications such as neurotechnology and BCIs and various neuroscience applications. Second, since all manifold and dynamic model parameters are trained together in an end-to-end single optimization, DFINE learns the best nonlinear manifold over which dynamics can be approximated as linearly as possible. Indeed, it was shown herein in simulations with the nonlinear stochastic Lorenz attractor system that through this combined manifold-dynamics approach, DFINE could capture the nonlinear temporal dynamics well. Third, linear dynamics in the presence of other nonlinearities such as embeddings can be sufficient in explaining the neural observations, as suggested by DFINE results. These results suggest that the linear description of temporal dynamics on the nonlinear manifold in DFINE does not degrade the neural and behavior prediction as DFINE outperforms fully nonlinear SAEs with nonlinear temporal dynamics. Finally, DFINE can be extended to allow for locally linear dynamics to better capture potential nonlinearities in the temporal dynamics that may not be fully captured using the joint optimization of the nonlinear manifold factors and linear dynamic factors.

In the DFINE model, a Gaussian distribution was used for neural observations such that the architecture can generalize across various commonly used neural data modalities including not only spike counts and smoothed firing rates, but also field potentials, which are continuous-valued. Indeed, field potentials such as LFP or electrocorticography (ECoG) or electroencephalography (EEG) or intracranial EEG (iEEG) are sometimes the only available modality in implantable or non-implantable neural interfaces and in many human neurophysiology experiments. Also, field potentials can provide a robust modality for neurotechnologies and BCIs as they can be long-lasting and can provide comparable information to spiking activity when decoding certain behavior variables. Field potentials can also reveal larger-scale network computations during behavior for basic science investigations. DFINE is also extended to support other observation distributions as well, as described herein.

In various embodiments, DFINE's target objective is to allow for flexible inference in its neural network model, which is not achieved with prior nonlinear latent state models of neural population activity including SAEs. In various embodiments, this can be beneficial for neurotechnology because, regardless of performance, a nonlinear latent state model requires flexible inference to be applicable in many neurotechnology applications, BCIs, and closed-loop or naturalistic/long-term neuroscience applications. Nevertheless, to show that in addition to enabling this new capability, DFINE still allows for accurate modeling and inference, it was compared with SAEs using the LFADS architecture as a benchmark as described further herein. For a fair comparison, similar to DFINE, LFADS used a Gaussian observation distribution to make it applicable to both Gaussian-smoothed firing rates and field potentials. To get a conservative estimate of the improvements in DFINE, LFADS was allowed to have a higher dynamics state dimension than DFINE (64 vs. 16). For the choice of hyperparameters in LFADS, the values that were picked were given for one of the datasets in the original work that had the closest number of trials to the datasets herein. The Lorenz simulation in FIG. 18 suggests that DFINE outperforms SAE on neural datasets potentially because of stochasticity in neural dynamics and the inevitable model mismatches that also introduce uncertainty which can be captured via stochastic noise variables (no model is perfect for data). Indeed, DFINE performed better than SAE when there was some stochasticity in the Lorenz dynamics.

DFINE also outperformed LDM because of incorporating embedding nonlinearities. Further, it was observed that DFINE outperformed another benchmark method termed fLDS that has linear dynamics and a direct nonlinear observation model (FIG. 20). DFINE is different from fLDS in terms of model architecture, inference procedure, and learning cost function. DFINE's model architecture is different from that in fLDS because DFINE has a two-layer factor architecture with two distinct factors rather than one factor in fLDS, and because DFINE incorporates stochastic nonlinearity on its dynamic factors while fLDS has deterministic nonlinearity. This architecture change is why DFINE can enable flexible inference unlike fLDS, can optimize the distinct future-step-ahead prediction as the cost function unlike fLDS's ELBO cost, and can ultimately improve performance compared with fLDS (FIG. 20). Indeed, DFINE can swiftly compute the future-step-ahead prediction error cost during learning because of its new capability for flexible recursive inference, without which using this cost is not practically feasible (Table 1). As such, the reasons for DFINE's new capability for flexible inference are the above architectural differences including the additional noisy manifold layer. These differences combined with the new cost also led to the performance improvements of DFINE over fLDS, potentially given the known issues with the trade-off between the reconstruction term and the KL penalty term in the ELBO cost used by fLDS.

The two-layer factor idea in DFINE is distinct from applying data preprocessing, for example in the form of principal component analysis, prior to model learning to mitigate model overfitting. In particular, the manifold embedding encoder/decoder in DFINE are nonlinear and further are learned end-to-end in conjunction with the linear dynamical part of the model (as distinct from separate preprocessing whether linear or nonlinear). This joint manifold-dynamics learning enforces the encoder network to learn the best nonlinear manifold embedding over which dynamics can be described well with an LDM. The joint learning also helps with the difficult problem of identifying a nonlinear manifold in noisy data through dynamic denoising over time. It was shown that this joint manifold-dynamics learning allows DFINE to capture the latent trajectories of a system with nonlinear temporal dynamics in the Lorenz simulations while still allowing for flexible inference (FIG. 18).

### Revealing Low-Dimensional Manifold Structure in the Saccade and Motor Datasets.

Latent factor models have led to significant insight about neural population coding during various behavioral tasks. For example, rotatory low-dimensional structure in the neural population activity has been prevalently observed, in the motor system during movements as well as other systems during tasks such as a syllables task, in a ready-set-go task while performing a saccade, in an exploration task in the head direction system, and during auditory stimulation. Here, DFINE found latent factors that consistently had ring-like manifold structures as revealed by visualization and TDA analysis and that were more predictive of neural activity and behavior, thus suggesting they were good descriptions of neural data. Importantly, DFINE extracted such ring-like manifold structures more robustly in single-trials compared with LDM and SAE in all datasets. Moreover, compared with alternative models, DFINE required fewer latent factors to predict neural population activity with a given accuracy (FIG. 8), showing that DFINE is also useful for dimensionality reduction in neural datasets.

In addition to allowing for flexible inference, the separation of dynamic and manifold factors in DFINE can facilitate neuroscientific interpretation. The manifold latent factors can be interpreted as capturing the global latent structure of the population code and the dynamic latent factors as revealing its local properties and variations. This is because the same manifold can be traversed in many ways, which are captured by the dynamic latent factors; thus, dynamic factors may correspond to local changes in behavior while manifold factors may relate to global changes in behavior. Combined with its accurate and robust discovery of the latent structure, this separation can also facilitate the use of DFINE for investigations and interpretations across diverse domains of neuroscience.

### The Applications of Flexible Inference Enabled in DFINE.

A major contribution of DFINE compared with prior nonlinear latent state models is its novel capability for flexible inference. This is because, regardless of performance, flexible inference is required to enable the use of nonlinear latent state models in many critical biomedical engineering applications such as real-time neurotechnology, BCIs, or advanced implantable and/or wireless neural interfaces. This capability is also important for neuroscience studies that involve causal perturbations/validations, long-term monitoring of brain states (e.g., mood, mental states), or behaviors in unconstrained environments as expanded on herein. Additionally, this capability is critical in closed-loop control of neurostimulation or closed-loop DBS systems, e.g., in mental disorders such as major depression. Further, DFINE performs accurately not only for neuronal firing rates but also for field potentials, which are a critical modality for neurotechnology and human neurophysiology.

One major feature of DFINE is enabling inference in the presence of missing observations, which is a major challenge in wireless implantable neural interfaces and BCIs due to intermittent wireless disruptions that cause all neural observations from all channels to be lost at random disruption times. These random disruptions have been shown to occur in recent wireless BCIs or DBS systems for example due to the appearance of other individuals, signals around the user's environment, or in general any random event breaking the wireless transmission. This random disruption scenario was emulated in the data drop analyses by making the probability of data loss approximately equal for every time-point. It was found that DFINE makes the inference robust to such data loss. Thus, this capability of DFINE is important for neurotechnology applications to facilitate the use of powerful nonlinear decoders for wireless BCIs or closed-loop DBS technologies that can be utilized in daily life. Further, in neuroscience, there is recent interest to study more naturalistic behaviors in unconstrained environments or to investigate brain states that have slow timescales such as mood or chronic pain. In both cases, having the user tethered to the decoding system is infeasible or difficult and transition to wireless interfaces is imperative to enable operation in unconstrained environment and/or over long timescales (e.g., for 24/7 monitoring or therapy), improve user mobility and convenience during daily/naturalistic tasks, and minimize risks of infection.

DFINE allows the same model to perform both real-time causal and non-causal inference. This capability is important in moving from correlational validations of a model of neural population dynamics to its causal validation. Given the challenges of causal real-time studies, many neuroscientific studies rely on correlative analysis to build knowledge about the associations between a given neural model and behavioral variables. However, the next level validation of the same model will be to establish the causal associations between its latent factors and behavioral variables for example through causal closed-loop perturbation experiments. Since the goal is to validate the same model, this same model should be used to infer the latent factors in real-time and use them as feedback to decide on the perturbation, modulate the latent factors, and see the causal effect of such closed-loop modulation on behavior. Thus, ideally, models that not only enable offline and accurate non-causal inference of brain states to test various correlative hypotheses, but also allow causal investigations and closed-loop perturbations enabled by real-time flexible inference are desirable. In addition, training generative models with deep learning requires significant resources and hyperparameter tuning, which becomes a challenge especially for chronic neurotechnologies in which models need to be retrained often to track adaptation and plasticity, e.g., due to electrical stimulation. Instead of training different models, DFINE can just train the same model for both causal and non-causal inference. Finally, flexible inference is important to enable model-based closed-loop control with neurostimulation such as DBS or electrical stimulation in brain disorders such as neurological and neuropsychiatric disorders. This is because flexible inference allows offline neural biomarker models of symptom states to be used in a real-time closed-loop control paradigm to take the neural biomarker to a target level, which can be a major goal in neurotechnology.

### Extensions

DFINE enables flexible inference in its neural network model. DFINE can be extended to learn piece-wise linear dynamics on the manifold to improve the modeling, which still keeps the flexible inference capability intact. Also, in addition to the Gaussian distribution for output neural observations that is generalizable across various neural modalities whether smoothed firing rates or field potentials, DFINE was extended to other output distributions such as generalized linear models (GLM) including Poisson/point process likelihoods, exponential family distributions, and multiscale likelihoods further herein. Finally, inputs can be modeled by incorporating them in the LDM part of the model for example for closed-loop neurostimulation and closed-loop DBS applications.

Taken together, DFINE provides a novel neural network tool that allows for flexible inference of low-dimensional latent factors and enables accurate neural, behavior, and manifold prediction. As such, DFINE can be used for developing future neurotechnology and BCIs and for probing neural population activity especially in closed loop.

Description of Datasets on which the Method was Validated.

### Neural Data Recordings.

Analyses was performed on four diverse datasets containing distinct behavioral tasks, brain regions, and neural signal modalities to show the generalizability of the results.

### Saccade Task.

A macaque monkey (Monkey A) performed saccadic eye movements during visually-guided oculomotor delayed response task (FIG. 2a). Each experimental session (13 sessions in total) consisted of several trials towards one of eight peripheral targets on a screen. Trials began with the illumination of a central fixation square. The subject was trained to maintain its eyes on the square for about 500-800 ms. After this baseline period, a visual cue was flashed for 300 ms at one of the eight peripheral locations to indicate the target of the saccade (Target On event). After a delay, the central fixation square was extinguished, indicating the Go command to start the saccade (Go event). The subject was trained to perform the saccade (Saccade Start event) and maintain fixation on the target for an additional 300 ms. A fluid reward was then delivered. The visual stimuli were controlled via custom LabVIEW (National Instruments) software. Eye position was tracked with an infrared optical eye tracking system (ISCAN) and from these positions some of the task events such as Saccade Start were identified. In this task, there are eight task conditions, each representing trials to one of the eight targets. During the task, LFP signals were recorded from lateral PFC with a semi-chronic 32-microelectrode array microdrive (SC32-1, Gray Matter Research). Raw LFP signals were low-pass filtered at 300 Hz and down-sampled to 20 Hz leading to a LFP observation every 50 ms.

### Naturalistic 3D Reach-and-Grasp Task.

A macaque monkey (Monkey J) performed a naturalistic reach-and-grasp task in a 50×50×50 cm³ workspace for a liquid reward across seven experimental sessions (FIG. 2b). During the task, the subject naturalistically reached for an object positioned on a wand, grasped it, released it and then returned its hand to a natural resting position. The wand was continuously moved around by the experimenter within a diverse spatial area in front of the subject. The task was performed continuously in time without any instructions to isolate reach-and-grasp movement components. A total of 23 retroreflective markers were attached on the subject's right arm and monitored using infrared and near-infrared motion capture cameras (Osprey Digital RealTime System, Motion Analysis Corp., USA) at a sampling rate of 100 frames s⁻¹. The 3D marker trajectories on the arm and hand were labeled (Cortex, Motion Analysis Corp., USA). The behavior variables were taken as the arm kinematics, i.e., the position and velocity of the wrist marker in the x, y and z directions. On each frame, motion capture camera data acquisition was synchronized to the neural recordings using a synchronization trigger pulse. The task lacked pre-defined trial structure or pre-defined target locations. Therefore, the trial starts and ends from the velocity of the hand movement, where the start of the trials was set to the start of the reach, and the end of the trials was set as the end of return and hold durations of the movement (FIG. 2b). To show condition-average visualizations, the trials were partitioned into two different conditions corresponding to left-ward or right-ward reaches along the horizontal axis in front of the subject, respectively. The horizontal axis was chosen for this division because it explained the largest variability in the reach locations.

Neural activity was recorded from M1, PMd, PMv and PFC in the left (contralateral) hemisphere with an array containing 137 microelectrodes (large-scale micro-drive system, Gray Matter Research, USA). The pool of top 30 spiking channels sorted based on the individual channel behavior prediction accuracies was analyzed. Gaussian-smoothed firing rates were calculated by counting the spikes in 10-ms bins and applying a causal Gaussian kernel smoother (with 30 ms standard deviation), followed by down-sampling to have observations every 50 ms. Raw LFP signals from the pool of top 30 LFP channels were also analyzed and sorted based on the individual channel behavior prediction accuracies. Raw LFP signals were low-pass filtered at 400 Hz and down-sampled to 20 Hz leading to a LFP observation every 50 ms.

### 2D Random-Target Reaching Task.

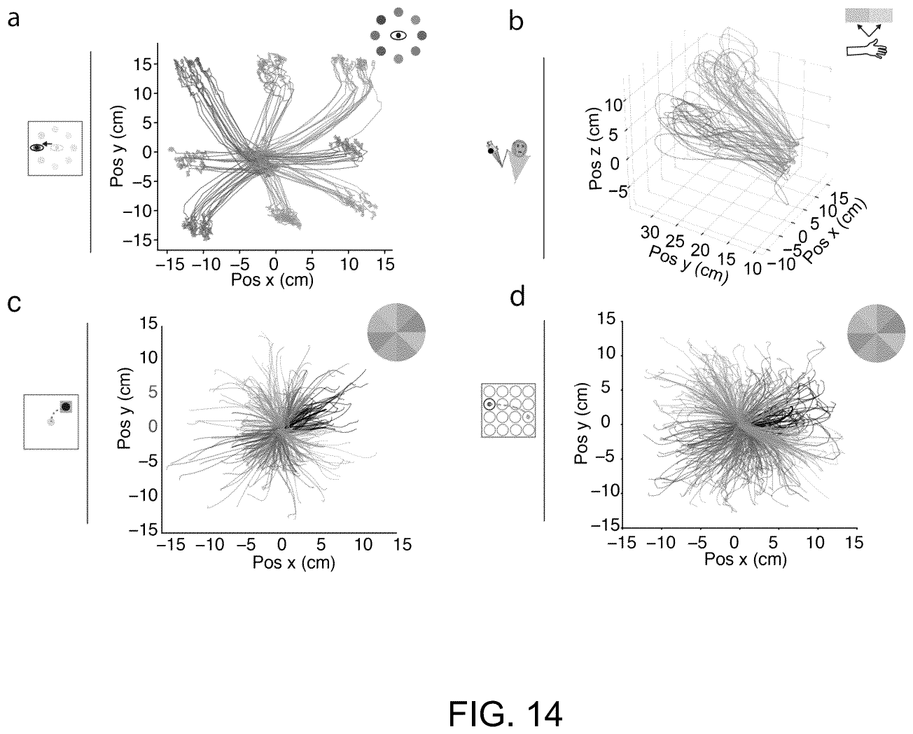

A macaque monkey (Monkey T) performed a 2D random-target reaching task with an on-screen cursor in a total of three experimental sessions (FIG. 2c). The subject controlled the cursor using a two-link planar manipulandum while seated in a primate chair. Hand movements were constrained to a horizontal plane within a 20×20 cm² workspace. The task consisted of several sections in each of which the subject performed 4 sequential reaches to random visual targets that appeared on the screen to receive a liquid reward (FIG. 2c). Within each section, after reaching the target and holding for a short period, the next target appeared in a pseudo-random location within a circular region (radius=5-15 cm, angle=360 degrees) centered on the current target. On average, the next target appeared approximately 200 ms after the subject reached the current target. The task naturally consisted of non-stereotyped reaches to different locations on a 2D screen unlike traditional center-out cursor control tasks with stereotyped conditions. Here, 2D cursor position and velocity in x and y directions were used as behavior variables. To show condition-average visualizations, the reaches were partitioned into 8 different conditions given the direction angle between the start and end point of the cursor trajectory (FIG. 14). The angle of movement specifies the 8 conditions, which correspond to movement angle intervals of 0-45, 45-90, 90-135, 135-180, 180-225, 225-270, 270-315, and 315-360, respectively.

The subject was implanted with a 100-electrode array (Blackrock Microsystems) in PMd. After spike sorting, two sets of units were excluded from analysis in the original work: 1) the units with low firing rates (smaller than 2 spike/s), 2) the units that had high correlations with other units. This led to 46, 49 and 57 number of units across different recording sessions. Gaussian-smoothed firing rates were calculated by counting the spikes in 10-ms bins and applying a causal Gaussian kernel smoother (with 30 ms standard deviation), followed by down-sampling to have observations every 50 ms.

### 2D Grid Reaching Task.

A macaque monkey (Monkey I) performed a 2D grid reaching task by controlling a cursor on a 2D surface in a virtual reality environment (FIG. 2d). Circular targets with 5 mm visual radius within an 8-by-8 square grid or an 8-by-17 rectangular grid were presented to the subject and the cursor was controlled with the subject's fingertip position. Fingertip position was monitored by a six-axis electromagnetic position sensor (Polhemus Liberty, Colchester, VT) at 250 Hz and then non-causally low-pass filtered to reject sensor noise (4th order Butterworth filter with 10 Hz cutoff). The subject was trained to acquire the target by holding the cursor in the respective target-acceptance zone, a square of 7.5 mm edge length centered around each target, for 450 ms. After acquiring the target, a new target was drawn from the possible set of targets. In most sessions, this set was generated by replacement, i.e., the last acquired target could be drawn as the new target. However, the last acquired target was removed from the set in some sessions. Even though there was no inter-trial interval between consecutive reaches, there existed a 200 ms “lockout interval” after target acquisition where no new target could be acquired. 2D cursor position and velocity in x and y directions were used as behavior variables. To show condition-average visualizations, the reaches were partitioned into 8 different conditions based on their direction angle as in the 2D random-target reaching task.

One 96-channel silicon microelectrode array (Blackrock Microsystems, Salt Lake City, UT) was implanted into the subject's right hemisphere (contralateral) M1. Total of seven sessions (sessions 20160622/01 to 20160921/01) were used. The pool of top 30 neurons were analyzed and sorted based on the individual neuron behavior prediction accuracies. Gaussian-smoothed firing rates were calculated by counting the spikes in 10-ms bins and applying a causal Gaussian kernel smoother (with 30 ms standard deviation), followed by down-sampling to have observations every 50 ms.

### Methods.

### DFINE Model.

A neural network architecture was developed, named DFINE, that allows for nonlinear description of data similar to deep neural networks, but in a manner that enables flexible inference (similar to LDM). This was done by combining a nonlinear latent manifold structure with linear dynamics on it, and training them together. This training could be done to optimize a future-step-ahead prediction cost. To do so, two distinct sets of latent factors were introduced in the neural network for n_{y}-dimensional neural population activity yₜ∈ [symbol] ⁿ^{_{y}}^{×1}, dynamic latent factors xₜ∈ [symbol] ⁿ^{ₓ}^{×1}, and manifold latent factors aₜ∈ [symbol] ⁿ^{ₐ}^{×1}, where nₓ and nₐ are the factor dimensions/hyperparameters to be picked. One key idea here is to incorporate a middle noisy manifold layer a between the dynamic latent factors x and neural observations y, which allows for separation of the model into a nonlinear manifold component and a linear dynamical component evolving on this nonlinear manifold (FIG. 1a). This separation plays a key role by enabling the new flexible inference capability of the network to optimally perform: 1) recursive causal inference (filtering), 2) non-causal inference with all observations (smoothing), and 3) inference in the presence of missing observations. Specifically, the separation enables flexible inference using a Kalman filter for the bottom dynamic part of the model in FIG. 1a that infers the dynamic factors x from the manifold factors a (FIG. 1b). Another key idea is to optimize a future-step-ahead prediction cost during learning, which is enabled by flexible inference as described herein. The network architecture consisting of the dynamic and manifold factors is described further herein.

First, the dynamic latent factor evolves in time with a linear Gaussian model:

$${x}_{t + 1} = A {x}_{t} + {w}_{t} . \qquad ( 1 )$$

where wₜ∈ [symbol] ⁿ^{ₓ}^{×1} is a zero-mean Gaussian noise with covariance matrix W∈ [symbol] ⁿ^{ₓ}^{×n}^{ₓ} and A∈ [symbol] ⁿ^{ₓ}^{×n}^{ₓ} is the state transition matrix. The manifold latent factor at is related to the dynamic latent factor xₜ as:

$${a}_{t} = C {x}_{t} + {r}_{t} , \qquad ( 2 )$$

where C∈ [symbol] ⁿ^{ₐ}^{×n}^{ₓ} is the emission matrix and rₜ∈ [symbol] ⁿ^{ₐ}^{×1} is a white Gaussian noise with covariance matrix [symbol] ∈ [symbol] ⁿ^{ₐ}^{×n}^{ₐ}. Equations (1) and (2) together form an LDM with aₜ being the Gaussian noisy observations. The parameter set of this LDM is denoted by ψ={A, W, C, R, μ₀, Λ₀}, where μ₀ and Λ₀ are the initial estimate and covariance of the dynamic latent factors, respectively.

Second, to model nonlinear mappings, autoencoders were used to learn the mapping between neural observations yₜ and manifold latent factors aₜ. In general, autoencoders are static generative models made of two parts: the encoder that maps the observations to a bottleneck representation and the decoder that takes this bottleneck representation to the observations. Here, autoencoder observations are the neural observations and autoencoder bottleneck representation is given by the manifold latent factors. The decoder part was modeled as a nonlinear mapping f_{θ}(⋅) from manifold latent factors to neural observations:

$${y}_{t} = {f}_{θ} ( {a}_{t} ) + {v}_{t} , \qquad ( 3 )$$

where θ are parameters and vₜ∈ [symbol] ⁿ^{_{y}}^{×1} is a white Gaussian noise with covariance V∈ [symbol] ⁿ^{_{y}}^{×n}^{_{y}}. Nonlinear mappings were modeled with MLPs as they are universal approximators of any nonlinear function under mild conditions. Equations (1)-(3) together form the generative model (FIG. 1a). For inference (next section), the mapping from yₜ to aₜ was also needed, which was characterized as:

$${a}_{t} = {f}_{ϕ} ( {y}_{t} ) \qquad ( 4 )$$

where f_{ϕ}(⋅) represents the encoder in the autoencoder structure and is parameterized by another MLP (FIG. 1a).

Equations (1)-(4) were trained together and end-to-end (rather than separately). Further, the middle manifold layer in equation (2) explicitly incorporates a stochastic noise variable rₜ, whose covariance is learned during training. This stochastic noise variable allows for the nonlinearity with respect to the dynamic latent factors to be stochastic in DFINE, i.e., function ƒ_{θ}(⋅) is stochastic with respect to xₜ as it has noise inside it. Finally, to help with robustness to noise and stochasticity during inference, DFINE learns stochastic noise variables during training, which are then explicitly accounted for at inference as can be seen below, in accordance with various embodiments.

### The Inference Problem.

Using the model in equations (1)-(4), both the manifold and dynamic latent factors are inferred from neural observations y_{1:T}, where T is the total number of time steps for the observations. The subscript t|k is used to denote the inferred latent factors at time t given y_{1:k}. Therefore, t|t denotes filtering (causal) inference given y_{1:t} and t|T denotes smoothing (non-causal) inference given y_{1:T}. As an intermediate step called nonlinear manifold embedding, an initial estimate of aₜ based on yₜ from equation (4) as âₜ=f_{ϕ}(yₜ) is directly but statically received as an initial estimate to provide the noisy observations of the dynamical model, i.e. âₜ, in FIG. 1b. Having obtained âₜ, the dynamical part of the model can now be used in equations (1) and (2) to infer x_{t|t} with Kalman filtering from â_{1:t}, and infer x_{t|T} with Kalman smoothing from â_{1:T}. The manifold latent factor can then be inferred as a_{t|t}=Cx_{t|t} and a_{t|T}=Cx_{t|T} based on equation (2). Note that a_{t|t} is inferred not only based on the neural observations but also based on the learned dynamical model using the Kalman filter, and thus this inference aggregates information over time dynamically. Given this procedure, DFINE's inference explicitly accounts for the stochastic noise variables during inference by using them to optimally combine the dynamical model and the noisy neural observations in inferring the latent factors. Further, in general, identifying a nonlinear manifold embedding in noisy data is challenging. DFINE aims to facilitate this identification by learning the manifold embedding (MLP) and dynamical model jointly together, which also allows it to then infer the manifold latent factors dynamically in time and denoise them over time (i.e., via a_{t|T}=Cx_{t|T}).

The inference above has the following major advantages compared with prior generative neural network models that train a non-causal inference network and use all observations in a trial/segment. First, latent factors can be inferred recursively in real-time, i.e., the current inferred dynamic latent factors x_{t|t} can be used to calculate the next step's inferred factors x_{t+1|t+1}; this recursive nature also considerably reduces computation time as shown in Table 1 herein. Second, missing observations can be handled by doing only forward prediction with the Kalman predictor at time-steps when observations are missing, without any need to impute 0 value for these missing observations as done previously. Third, both causal filtering and non-causal smoothing inference can be performed with the same learned model. Finally, DFINE can directly perform inference (and training) on continuous data time-series that are encountered in BCIs unlike inference in SAEs that requires having trials and/or segmenting the data to mimic trial-structured data.

### The Learning Problem.

Neural network model parameters are learned to optimize a cost function. When stochastic noise variables exist, this cost is typically taken as the ELBO. But optimizing ELBO can be difficult and the direct goal of dynamical modeling is to predict neural and/or behavior dynamics. Thus, the cost in DFINE is instead defined as the k-step-ahead prediction error in predicting neural observations k time-steps into the future, i.e., the error between yₜ₊ₖ and its prediction from y_{1:t} denoted by y_{t+k|t}. The DFINE model enables efficient recursive inference/prediction, which allows it to compute the k-step-ahead prediction error during training (FIG. 1b) in the presence of noise, which enables utilization of this cost; this is because all forward predictions can be run with a single run of Kalman filtering. Thus, the cost L is a function of all parameters as:

$$L ( ψ , θ , ϕ ) = {\sum }_{k = 1}^{K} {\sum }_{i = 1}^{T - k} e ( {y}_{t + k \vert t} , {y}_{t + k} ) + {λ}_{reg} {L}_{2} ( θ , ϕ ) , \qquad ( 5 )$$

where K denotes the maximum horizon for future-step-ahead prediction and e(⋅,⋅) denotes the error measure. T is the length of the time-series, i.e., the length of each batch in the mini-batch gradient descent. L₂(θ, ϕ) is an L₂ penalty for the autoencoder parameters {θ, ϕ} to prevent overfitting with regularization hyperparameter λ_{reg}. Mean-squared error (MSE) was used for the error measure e(⋅,⋅) but other error measures can also be used. As an alternative approach, DFINE parameters can also be learned by optimizing ELBO by incorporating a KL divergence term between a fixed prior distribution and approximate posterior distribution of latent factors obtained via nonlinear manifold embedding and Kalman filtering/smoothing, in addition to current and/or future predictions of neural observations and/or behavior.

### Supervised DFINE Learning.

In the unsupervised DFINE, latent factors are optimized to be predictive of neural population activity. To address situations in which neural dynamics of a specific behavior are of interest, a new learning algorithm is developed for DFINE that aims to extract latent factors that are more predictive of that behavior. The resulting algorithm is called supervised DFINE. In particular, when behavior variables zₜ∈ [symbol] ⁿ^{_{z}}^{×1} are available during training, they can be used to supervise the training and learn latent factors that are predictive of not only neural observations but also behavior variables. This is done by adding an auxiliary neural network, termed mapper MLP network, to the DFINE graphical model during training only (FIG. 1a); this mapper network maps the manifold latent factor aₜ to behavior variables zₜ during training (the link from a to z in FIG. 1a) and is written as zₜ=f_{γ}(aₜ)+qₜ, where qₜ∈ [symbol] ⁿ^{_{z}}^{×1} is white Gaussian noise. To motivate the network to learn latent factors that are predictive of both behavior and neural observations, the behavior prediction error was added to the cost function in equation (5) as follows:

$$L ( ψ , θ , ϕ , γ ) = {\sum }_{k = 1}^{K} {\sum }_{t = 1}^{T - k} e ( {y}_{t + k \vert t} , {y}_{t + k} ) + {λ}_{b e h} {\sum }_{t = 1}^{T} e ( {f}_{γ} ( {a}_{t} ) , {z}_{t} ) + {λ}_{reg} {L}_{2} ( θ , ϕ , γ ) , \qquad ( 6 )$$

where λ_{beh} is a hyperparameter. Larger values of λ_{beh} put more-emphasis on behavior prediction vs. neural prediction and vice versa. Note that the parameters of the auxiliary MLP (γ) are also added to the regularization term in the cost function.

After training of supervised DFINE is completed, the mapper MLP can be discarded and not used for inference. The inference of latent factors remains identical to that in unsupervised DFINE, and is done purely based on neural observations and independent of behavior variables (FIG. 1b). The only difference is that supervised DFINE's learned model has different parameter values given that its learning procedure is distinct as described above.

### DFINE Learning: Hyperparameters and Details.

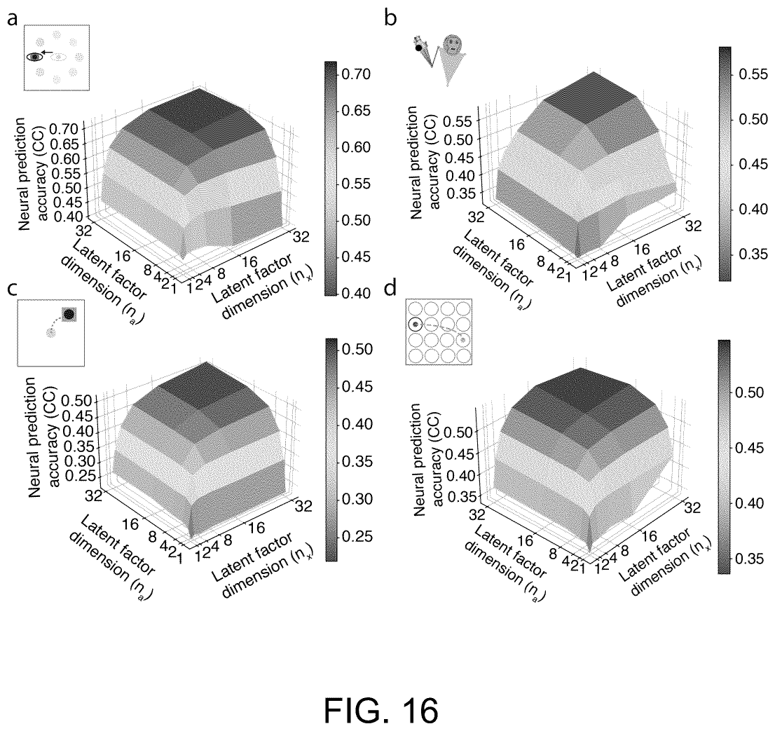

Given a set of observations, the model parameters are learned by minimizing the cost function in equation (5). As an example, MLP architectures containing 3 hidden layers each with 32 units for f_{θ}(⋅) and f_{ϕ}(⋅) were used in decoder and encoder parts of the model, respectively. However, any MLP or neural network with any number of hidden layers or any number of units can be used here instead. The activation function used for the units was set to tanh(⋅), though other activation functions are also possible. To reduce the computational complexity, nₓ=nₐ was taken in all the analyses. Indeed, by characterizing the DFINE neural prediction accuracy with various pairwise (nₓ, nₐ) dimensions in FIG. 16, it was observed that increasing nₓ and nₐ together improved the neural prediction accuracy the most. It is thus reasonable to increase nₓ and nₐ together for maximum performance and less computational complexity for the dimension search. However, any other choices are also possible for the pair (nₓ, nₐ). Back propagation was used with mini-batch gradient descent implemented by ADAM optimizer to learn the model parameters and the training was continued for 200 epochs. The model parameters were learned via back propagation through an iterative process of mini-batch gradient descent implemented using the ADAM optimizer. In each iteration, the optimizer computes the cost function L(ψ, θ, ϕ) given the current model parameters {ψ, θ, ϕ}, then calculates the gradient of the cost with respect to the parameters using back propagation, then computes the modified gradient direction and step size, and takes a step from the current parameter values in the opposite direction of the gradient to minimize the value of the cost. The modification of the gradient direction and the amount of the step size at each iteration are determined by the ADAM optimizer rules. For the initial learning rate of the ADAM optimizer 0.02 was used and the training was continued for 200 epochs, where each epoch is a full iteration over the entire training set. Note that these are examples and other optimization approaches for the cost optimization and other number of epochs and other values of learning rates can also be used. The maximum horizon for future-step-ahead prediction K was set such that the future predictions cover at least 100 ms into the future, therefore K=2-4 was used to optimize the cost function across various datasets (note that the time step is 50 ms). However, any value of K can be used for the maximum horizon. The following parameters were used for the PyTorch implementation as examples but any other values can also be used. The regularization parameter λ_{reg}=0.002 was used to prevent overfitting. λ_{beh} was set to 20 across all the supervised DFINE models to put emphasis on the improved behavior prediction accuracy. However, any other parameter sets or number of epochs can be chosen by the user depending on their data properties.

### Evaluation Using Five-Fold Cross-Validation.

For all analyses herein, five-fold cross-validation was performed, where the data was divided into five equal-sized folds, 4 folds were used as the training set to learn the model, and one fold was left out for the test set to evaluate the learned models. Below, the evaluation metrics used herein is expanded upon. Of note, before training, z-scoring was applied on neural and continuous behavior signals.

### Behavior Prediction Accuracy.

Saccade task: For any method, the behavior prediction accuracy of the latent factor time-series during movement periods was quantified by calculating the target classification accuracy using these factors (FIG. 2a). To address the inter-trial variability in the length of movement periods so that the classifier can be applied to latent factors in any trial, an identical preprocessing step was performed for the latent factors from all methods. For this preprocessing, the latent factor time-series duration was linearly interpolated to 400 datapoints and uniformly sampled 10 datapoints (i.e., every 40 datapoints after interpolation). After this preprocessing and by flattening the processed factors, the classification features was obtained with dimension equal to 10× latent factor dimension. For training and test trials, these processed features were used to learn classifiers and perform classification. In addition, to compute the performance given the limited number of trials in the training and test sets, for all methods, the classification accuracies of all binary classifiers (for each class vs. another class) were averaged rather than performing an 8-class classification. Nonlinear support vector machines (SVM) were used with Gaussian kernels to perform the binary classification. The width or standard deviation of the Gaussian kernel for each training fold was picked based on inner cross-validation. To assess the target classification accuracy, AUC of the receiver's operating curve were used for all binary classifiers and the mean performance for each test cross-validation fold was computed.

Motor datasets: Here behavior variables were continuous. For any method, to quantify the behavior prediction accuracy, an MLP regression model was learned from the smoothed latent factors to the observed behavior variables in the training set. In the test set, the learned MLP regression model was used to get the predicted behavior variables from the latent factors. Pearson's correlation coefficient (CC) was used to quantify the behavior prediction accuracy in each test cross-validation fold.

### Neural Prediction Accuracy.

The neural prediction accuracy was quantified by calculating how accurately models predict neural observations one-step-ahead into the future from their own past. For the DFINE model, y_{t+1|t}=f_{θ}(a_{t+1|t}) was used as the one-step-ahead neural prediction. For LDM, neural prediction is given by the classic Kalman predictor. However, sequential autoencoders (SAE) do not perform one-step-ahead prediction during the trials as they have a non-causal inference architecture and need to observe all neural observations to infer the latent factors and reconstruct the neural observations. SAEs were thus given an advantage by allowing them to use all neural observations (instead of just past observations) and thus to perform neural reconstruction instead of one-step-ahead neural prediction. DFINE's neural reconstruction accuracy given by y_{t|T}=f_{θ}(a_{t|T}) was also compared to SAE's neural reconstruction accuracy in FIG. 9 with similar conclusions. Pearson's correlation coefficient (CC) was used to quantify the neural prediction accuracy in each test cross-validation fold.

### Topological Data Analysis (TDA) Metrics.

To quantify how robustly models identify the latent manifold structure in single-trials, TDA was applied on smoothed latent factors. TDA uses persistent homology to find multi-dimensional holes (e.g. 1D hole is a ring, 2D hole is a 2D void) in data by growing the radius of ε-balls around datapoints, which are connected when they touch. TDA finds the manifold type by counting the number of persistent multi-dimensional holes in the data-manifold. For example, a torus has one 2D hole and two 1D holes. TDA was run on smoothed single-trial latent factors of the learned models in the cross-validation test set and the most persistent hole's birth and length were assessed with TDA. The most persistent hole is the hole that lasts the longest. The birth happens at the E value at which the hole appears (smaller values correspond to earlier births) and the length is the ε interval for which the hole lasts. To assess robustness in single-trials, the method was found for which TDA finds holes that are born earlier and last longer, i.e., are more persistent: the sooner a hole is born (at shorter radius) and the longer it lasts (at longer radius), the more prevalent/robust it is in the latent factors extracted. To take into account scaling differences in the latent space of each method, single-trial latent factors were z-scored in each dimension before running TDA. To visualize the TDA results, for the most persistent holes, their lengths vs. births were plotted. On this plot, the optimal frontier is the top left area of the plot indicating earlier births and longer lengths. To aggregate the results in each test cross-validation fold, the birth and length values of TDA were averaged for single-trial latent factors in that test fold.

### Implementation Details for Benchmark Methods.

SAE: For SAE, the architecture named LFADS was used, which is a common benchmark nonlinear model of neural population activity. LFADS is a RNN-based variational SAE. LFADS takes fixed-length segments of data as input and encodes each segment into a bottleneck latent factor, which serves as the initial condition for the decoder's network (i.e., generator). Given this initial condition, the generator RNN propagates the latent states, generates a factor time-series, which then reconstructs a smoothed copy of the input data segment. LFADS was trained using the publicly available source code and using hyperparameters in row 2 of the Supplementary Table 1 in the original manuscript because the number of trials in the dataset associated with row 2 was closest to the datasets. The dimensionality of the generator RNN's latent state in LFADS represents its dynamical memory and the number of values used at any given time-step to generate the dynamics/states of the next time-step, thus representing its dynamics state dimension. The generator RNN's latent state dimension (and thus the initial condition latent factor dimension) was kept high enough and set to 64. This gives an advantage to LFADS in terms of modeling the dynamics because it gives LFADS a higher dynamics state dimension of 64 compared to DFINE that has this dimension at 16. A Gaussian observation distribution was used to train LFADS so that, like DFINE, it can be applied for all neural modalities considered here whether Gaussian-smoothed firing rates or LFP. The developers' LFADS implementation was used, which provides the option for the Gaussian observation distribution. The LFADS factor time-series as the latent factors of LFADS was used in the analyses/comparisons as was done in the original LFADS manuscript.

LFADS can only be trained on 3D data tensors (trial×time×observation dimension) given its SAE structure. Thus, for its model training and inference, the continuous data was split into smaller 1s segments to create 3D data tensors in both training and test sets. The LFADS model was then trained with the training set and inference was performed in each 1s segment of data. The smoothed latent factors for the full duration of training and test sets were achieved by concatenating the inferred latent factors across segments. The inference ran 50 times—as LFADS inference is stochastic given its variational autoencoder format—and the inferred latent factors from these 50 realizations were averaged.

fLDS: A comparison against fLDS was also conducted, which provided another competitive nonlinear dynamical model of neural population activity. In fLDS, the latent factors xₜ are modeled with a linear state equation and the observations are modeled with a nonlinear function of the latent factors yₜ=g(xₜ)+vₜ. This is different from DFINE model architecture that has two sets of latent factors including the extra noisy manifold latent factor. Further, the nonlinearity applied in DFINE on the dynamic latent factors is stochastic (see DFINE Model section above) while the nonlinearity in fLDS is deterministic. In terms of inference, fLDS performs non-causal (smoothing) inference and does not directly address missing neural observations. In terms of learning, fLDS optimizes the ELBO cost while DFINE optimizes the future-step-ahead prediction cost and can do so because of its flexible inference capability to efficiently and recursively compute this cost during training. The hyperparameters in the developers' Github repository were used to learn fLDS on the data. Similar to all other benchmark methods the observation distribution was set to be Gaussian in fLDS using the developers' code. Since fLDS only allows for smoothing inference and to get the one-step-ahead prediction estimates at each time t, smoothing inference (from y_{1:t}) was performed to get x_{t|t} and get the one-step-ahead prediction of the observations as g(Ax_{t|t}). Throughout the manuscript, xₜ in the fLDS model is used as its latent factors.

LDM: LDM models were trained using a publicly available Python package that performs subspace identification. The states of the LDM model were used as the latent factors. The latent factors are inferred using Kalman filtering and smoothing.

### Numerical Simulations.

### Nonlinear Manifold Simulations.

The DFINE model was validated on numerical simulations first. Since prior studies on neural population activity have shown significant evidence for rotatory dynamics and ring-like/Toroidal manifolds, the nonlinear manifold structure was simulated using 3 different manifold types to show generality: ring-like, Torus and Swiss roll manifolds. Nonlinear trajectories were simulated over these manifolds by first generating a driven-walk using a linear dynamical model on the manifold local coordinates and then embedding these coordinates in 3D cartesian space using the manifold equations (see Details of numerical simulations provided further herein). To get the neural observations, 40D output signals were generated by first applying a random output emission matrix (of size 40×3) on the 3D trajectories and then adding additive white Gaussian noise to the 40D signal to realize noisy observations. Without loss of generality and only for illustration purposes, the first 3 dimensions of the observations were kept the same as the 3D trajectories (i.e., using identity output submatrix for the first 3 dimensions) so that the first 3 dimensions for the 3D visualizations can be illustrated without any linear distortions. All quantifications are calculated with 40D observations (see Details of numerical simulations provided further herein). 30 different sessions (10 from each manifold type) were simulated, where the white Gaussian noise standard deviations were randomly picked. In each session, 250 trials were simulated, each containing 200 time-steps. The validations are all based on five-fold cross-validation on these trials.

In addition to visualization, the success of learning was quantified with the convergence of one-step-ahead neural prediction error in the learned models to that of the true model. The one-step-ahead prediction error was calculated using NRMSE; this normalization allows for pooling the results across sessions given potential scaling differences across various simulated sessions. Given a one-dimensional signal yₜ and its prediction ŷₜ, NRMSE is calculated as:

$$NRMSE = \frac{\sqrt{{\sum }_{t} {( {y}_{t} - {\hat{y}}_{t} )}^{2}}}{\sqrt{{\sum }_{t} {( {y}_{t} - \overline{y} )}^{2}}} , \qquad ( 7 )$$

where y̅ is the mean of the signal. The NRMSE was calculated for each dimension and its mean across dimensions for the 40D observations in this case is reported. To calculate the one-step-ahead prediction error, the NRMSE was calculated between the true observations (yₜ) and their predictions one-step into the future (ŷ_{t|t-1}). For the true models, the one-step-ahead predictions was calculated using Unscented Kalman filtering (UKF) as the true manifolds have nonlinear embeddings, which can be written analytically for the true model and a UKF can be written for them.

### Lorenz Attractor System Simulations.

A simulation analysis was performed using a well-known system with nonlinear temporal dynamics, stochastic Lorenz attractor system. This system is commonly used to test nonlinear latent state methods. Stochastic Lorenz attractor system is a set of nonlinear dynamical equations with 3 dynamic latent factors:

$$d {x}_{1} = σ ( {x}_{2} - {x}_{1} ) d t + {q}_{1} d {x}_{2} = ( ρ {x}_{1} - {x}_{1} {x}_{3} - {x}_{2} ) dt + {q}_{2} d {x}_{3} = ( {x}_{1} {x}_{2} - β {x}_{3} ) d t + {q}_{3} , \qquad ( 8 )$$

where x₁, x₂ and x₃ are the latent factors, and q₁, q₂ and q₃ are the white Gaussian noise for each latent factor dimension. The infinitesimal change in variables is denoted by d. σ=10, ρ=28 and

$$β = \frac{8}{3}$$

were used for Lorenz model parameters, and Euler integration was used with dt=0.01 to simulate the system dynamics. 40D output signals were generated by first applying a random output emission matrix (of size 40×3) on the 3D Lorenz trajectories and then adding additive white Gaussian noise (variance=1) to the 40D signal to realize noisy observations. The dynamics noise variable magnitude (variance of qᵢ) were swept from 10⁻⁴ to 1 and for each value 20 simulated sessions were generated. 750 trials were simulated for 200 time-steps for each session, and 5-fold cross-validation was performed to assess the results. The initial condition for each trial of the stochastic Lorenz simulation is obtained after 500 burn-in steps starting from a random latent factor sampled from a normal distribution.

DFINE and SAE models were used with latent factor dimension of 3 to learn the stochastic Lorenz attractor system's dynamics. For SAE, the LFADS architecture was used with the hyperparameter set corresponding to the Lorenz attractor simulations reported in Supplementary Table 1 in the original LFADS paper. For each method, the linear projection from the inferred latent factors to the actual Lorenz latent factors were learned, the linear projection to reconstruct the Lorenz latent factors in the test set were used, and then the Lorenz latent factor reconstruction accuracy with CC were quantified.

Inference Analysis with Missing Observations.

The inference was assessed/visualized in the presence of missing observations across various observed datapoint ratios. Observed datapoint ratio, denoted by ρ, quantifies the ratio between the number of observed datapoints versus the total number of datapoints. Both the DFINE and SAE models were trained on fully observed training sets, and then their inference on test sets with missing observations was tested. For simulation analyses, p was varied from 0.05 to 1 by randomly dropping datapoints in each test trial, the latent factors in the presence of missing/dropped observations were inferred, and then the error between the true and reconstructed manifold trajectories via filtering/smoothing was quantified. For motor datasets, missing observations were introduced by randomly and uniformly dropping neural observations with various observed datapoint ratios (p ranging from 0.2 to 1). Since the motor datasets contained continuous recordings and to make sure that datapoints were dropped uniformly throughout the duration of time-series, (1-φ×100 datapoints were randomly dropped in every 100 time-steps of the neural observation time-series.

Using the learned DFINE models, in the test set, the latent factors at all time-steps were inferred even though observations were missing at some random time-steps. From these latent factors, the behavior variables were predicted in the test set using the learned MLP models and thus the cross-validated behavior prediction accuracy was computed. Note that, even though the observations are missing at random time-steps, the latent factors and thus behavior variables are inferred at all time-steps. In a control analysis, inference with LDM and SAE was performed in the presence of missing observations as described above. For LDM, the latent factors were inferred with Kalman filtering/smoothing where at the time of missing observations the latent estimate in the forward pass was obtained by the Kalman predictor. For SAEs, two different imputation techniques were used since SAE's generator RNN is designed to take inputs at every time-step: 1) impute the missing observations with zeros as done previously, 2) impute the missing observations with the average of the last and next/future available observations. Given the SAE models that are trained on fully observed training sets, the latent factors in the test sets with missing observations were inferred, behavior variables were predicted with the learned MLP models, and cross-validated behavior prediction accuracy was computed.

### Statistical Analysis.

For all analyses herein, significance was declared if P<0.05. All statistical tests were performed with non-parametric Wilcoxon signed-rank tests.

Referring now to FIG. 8, neural prediction accuracy as a function of the latent factor dimension is shown for all datasets and methods, in accordance with various embodiments. Solid lines show the mean neural prediction accuracy across sessions and cross validation folds for the FIG. 8a saccade task (observation dimension n_{y}=32), FIG. 8b: 3D naturalistic reach-and-grasp task (observation dimension n_{y}=30), FIG. 8c: 2D random-target reaching task (observation dimension n_{y}=46-57), and FIG. 8d: 2D grid reaching task (observation dimension n_{y}=30). For SAE, the dimension shown is the factor dimension and the dynamic dimension (generator RNN's latent state dimension and initial condition dimension) is always 64.

Referring now to FIG. 9, DFINE's neural reconstruction accuracy with smoothing is also illustrated and is better than that of SAE, in accordance with various embodiments. Figure convention is as in FIG. 4. The neural reconstruction accuracy with smoothing is shown for the FIG. 9a: saccade task, FIG. 9b: 3D naturalistic reach-and-grasp task, FIG. 9c: 2D random-target reaching task, and FIG. 9d: 2D grid reaching task.

Referring now to FIG. 10, example latent factor trajectories for the motor datasets is illustrated, in accordance with various embodiments. Figure convention for the conditions is as in FIG. 6. The condition-average latent factor trajectories are shown for all methods in the FIG. 10a: 3D naturalistic reach-and-grasp task, FIG. 10b: 2D random-target reaching task, and FIG. 10c: 2D grid reaching task. A ring-like manifold structure was observed during movement periods and DFINE more robustly identified this ring-like structure in single-trials as evidenced by the TDA results in FIGS. 4 and 5. DFINE's ring-like manifold structure was more predictive of neural activity (FIGS. 4 and 5), suggesting that it provided a good description of data.

Referring now to FIG. 11, DFINE more robustly extracts the ring-like manifold structure in single-trials during the preparation period of the saccade task, in accordance with various embodiments. TDA analysis on single-trial latent factors during the preparation period is shown. TDA's most persistent 1D hole had a significantly earlier birth and lasted significantly longer for DFINE compared to LDM and SAE (P<5×10⁻⁴, one-sided Wilcoxon signed-rank test, n=65). Figure convention is the same as FIG. 4e. Example condition-average and single-trial latent factor trajectories during the preparation period are shown in FIG. 4a.

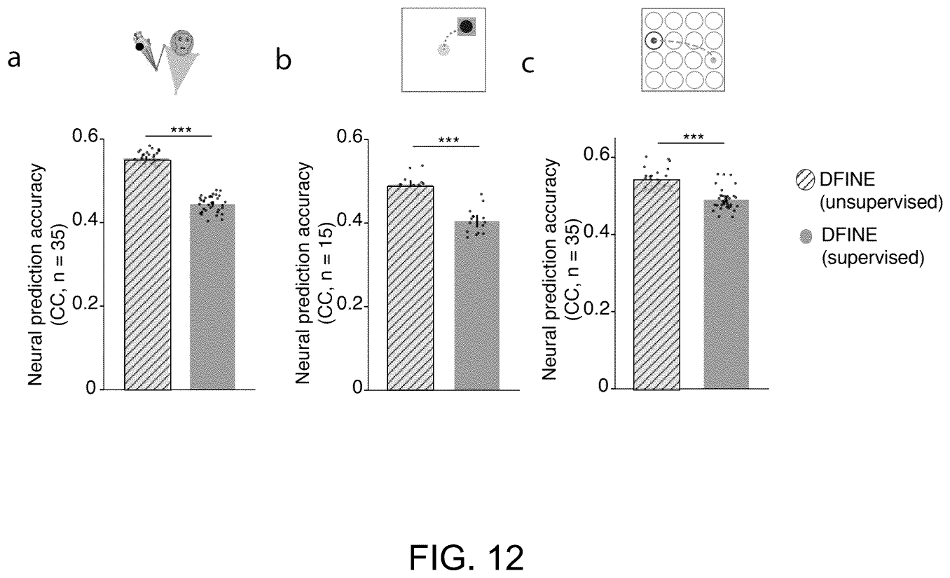

Referring now to FIG. 12, unsupervised DFINE had higher neural prediction accuracy compared to supervised DFINE as expected as the latter optimizes for both neural and behavior prediction rather than just for neural prediction, in accordance with various embodiments. Figure convention is as in FIG. 6b. Neural prediction accuracies are shown for the: FIG. 12a: 3D naturalistic reach-and-grasp task, FIG. 12b: 2D random-target reaching task, and FIG. 12c: 2D grid reaching task.

Referring now to FIG. 13, DFINE outperforms LDM and SAE in the presence of missing observations and the improvement vs. SAE grows with more missing samples, in accordance with various embodiments. As shown in FIG. 13a, LDM, SAE and DFINE's behavior prediction accuracy across various observed datapoint ratios in the 3D naturalistic reach-and-grasp task. Figure convention for FIG. 13 is similar to that in FIG. 7 but without the shaded areas. Given models trained on fully observed neural observations, latent factors were inferred in the test set that had missing observations. LDM did so with the Kalman filter. SAE did so by imputing missing observations in the test set to zero (SAE zero imputation), or by imputing them to the average of the last and next/future seen observations (SAE average imputation). DFINE did so through its new flexible inference method. The inferred factors were then used in the test set to predict behavior variables. This process was done at 0.3 and 0.6 observed datapoint ratios. For all models, the behavior prediction accuracy of the smoothed latent factors was shown. DFINE's behavior prediction accuracy remains better than other models even in the lower observed datapoint ratios. FIG. 13b shows the percentage drop in the behavior prediction accuracy of nonlinear models, SAE zero imputation, SAE average imputation and DFINE, as the observed datapoint ratio was varied from 1 to 0.3 and from 1 to 0.6. The percentage drop in behavior prediction accuracy of DFINE is significantly lower than that of SAE with both imputation techniques, showing that DFINE can better compensate for missing observations. Figure convention for bars, dots and asterisks is similar to that in FIG. 4. Similar results held for the 2D random target reaching task (FIG. 13c,d), and for the 2D grid reaching task (FIG. 13e,f).

Referring now to FIG. 14, example behavior trajectories for the four experimental datasets is illustrated, in accordance with various embodiments. FIG. 14a illustrates eye movement trajectories for the saccade task. Each shade represents one target, i.e., condition. FIG. 14b illustrates hand movement trajectories for the 3D naturalistic reach-and grasp task. Each shade represents one condition, i.e., movement to left or right. 2D cursor trajectories for the FIG. 14c: 2D random-target reaching task and FIG. 14d: 2D grid reaching task are shown, when shifted in space to start from the center. Each condition is shown with a different shades and represents reaches that have similar direction angles. Regardless of start or end position, the angle of movement specifies the 8 conditions, which correspond to movement angle intervals of 0-45, 45-90, 90-135, 135-180, 180-225, 225-270, 270-315, and 315-360, respectively.

Referring now to FIG. 15, TDA analysis directly on the observed neural population activity reveals a ring-like manifold structure in FIG. 15a: the saccade task, FIG. 15b: the 3D naturalistic reach-and-grasp task, FIG. 15c: the 2D random-target reaching task, and FIG. 15d the 2D grid reaching task, in accordance with various embodiments. TDA was performed directly on the observed neural population activity yₜ∈Rⁿ^{_{y}}^{×1} without any modeling and quantified the ratio between the length (duration between birth and death) of the most persistent one-dimensional hole to that of the second most persistent one-dimensional hole. This ratio was significantly larger than the control data in all datasets (FIGS. 15a-d), again indicating the existence of a ring-like manifold structure in the data (even without any modeling). The control data is taken as a unit-norm Gaussian noise in Rⁿ^{_{y}}^{×1} because each trial's latent factors were z-scored for the TDA analysis to remove scaling differences. The line inside boxes shows median, box edges represent the 25^{th} and 75^{th} percentiles, and whiskers show the minimum and maximum values after removing the outliers. Outliers that were outside the 3-standard-deviation range from the mean on each side were removed. Figure convention for asterisks is similar to FIG. 4.

Referring now to FIG. 16, neural prediction accuracy of DFINE by varying nₓ and nₐ, in accordance with various embodiments. Neural prediction accuracy for the FIG. 16a: saccade task, FIG. 16b: 3D naturalistic reach-and-grasp task, FIG. 16c: 2D random-target reaching task, and FIG. 16d: 2D grid reaching task, for the pairwise values of (nₓ, nₐ). This analysis shows that taking nₓ=nₐ comes at no loss of generality in the neural prediction accuracy as neural prediction accuracy increased the most by increasing nₓ and nₐ together. Since both the dynamic and the manifold latent factors can be the bottleneck for information, it intuitively makes sense to increase their dimensionality together for maximum performance and least computational complexity for dimension search.

Referring now to FIG. 17, characterization of DFINE's performance vs. the observation noise and the amount of training data, is illustrated in accordance with various embodiments. FIG. 17a illustrates examples of noisy observations of the latent factor trajectory in three different noise regimes. Figure convention is similar to FIG. 3b. In FIG. 17b the underlying trajectory reconstruction error is shown for the Swiss-roll manifold at various noise to signal ratios (nsr). Noise to signal ratio is calculated by dividing the standard deviation of the observation noise to that of the original signal. Each dot represents the mean reconstruction error across simulated sessions and cross-validation folds (n=50). The solid line represents the mean and the shaded area shows the 95% confidence bound of the mean. FIG. 17c is similar to FIG. 17b for the ring-like manifold. FIG. 17d is similar to FIG. 17b for the Torus manifold. In FIG. 17e, the cross-validated reconstruction error of the underlying trajectory is shown for the Swiss roll manifold at a given noise to signal ratio (0.5, corresponding to the right-most panel in FIG. 17a vs. the number of training trials. DFINE performance converges when around 75 trials are available. Similar to FIGS. 17b-d, each dot represents the mean reconstruction error across simulated sessions and cross-validation folds (n=50), the solid line represents the mean, and the shaded area shows the 95% confidence bound of the mean.

Referring now to FIG. 18, DFINE outperforms SAE in the presence of stochasticity in the nonlinear temporal dynamics of the Lorenz attractor system, while SAE outperforms DFINE when the dynamics are almost deterministic, in accordance with various embodiments. In FIG. 18a, examples of latent factor trajectories for the stochastic Lorenz attractor system across various dynamics noise magnitudes (quantified as the noise variance) are illustrated. The arrows associate example trajectories with the comparisons in FIG. 18b to provide visualization. In FIG. 18b, the cross-validated reconstruction accuracies of the ground-truth Lorenz latent factors for SAE and DFINE are shown for various dynamics noise magnitudes. The solid lines are the mean latent factor reconstruction accuracy across simulated systems and cross-validation folds (n=100). The shaded area around the mean represents the 95% confidence bound. Figure convention for the significance asterisks is similar to FIG. 4. With the increase in the dynamics noise magnitude, SAE performance degraded while DFINE performance stayed robust. DFINE significantly outperformed SAE when there was stochasticity in nonlinear temporal dynamics and specifically when the dynamics noise magnitude was larger than ˜10⁻². The x axis is in log scale and shows the variance of the dynamics noise.

Referring now to FIG. 19, DFINE outperforms LDM and SAE in the 3D naturalistic reach-and-grasp task also when using the LFP modality instead of Gaussian-smoothed firing rates, in accordance with various embodiments. Neural and behavior prediction accuracy of DFINE versus the benchmark methods are shown in FIG. 19a and FIG. 19b, respectively. Figure convention is similar to FIG. 5. In both neural and behavior prediction accuracy DFINE was again better than SAE (P<2.7×10⁻⁵, Nₛ=35, one-sided Wilcoxon signed-rank test) while SAE was better than LDM (P<2.5×10⁻⁷, Nₛ=35, one-sided Wilcoxon signed-rank test).

Referring now to FIG. 20, DFINE outperforms fLDS across the four experimental datasets, in accordance with various embodiments. Neural and behavior prediction accuracies are both significantly higher in DFINE compared with fLDS in the saccade dataset in FIG. 20a, the 3D naturalistic reach-and-grasp task in FIG. 20b, the 2D random-target reaching task in FIG. 20c, and the 2D random-grid reaching task in FIG. 20d. Figure convention is similar to FIGS. 4 and 5. Beyond performance gains, as a major goal and benefit, DFINE provides the new capability for flexible inference unlike fLDS that does non-causal inference and does not directly address missing data.

### Details of Numerical Simulations.

Three different manifold types including ring-like, Torus and Swiss roll manifolds were simulated. Here, the numerical simulations are expanded upon.

### Manifold Equations.

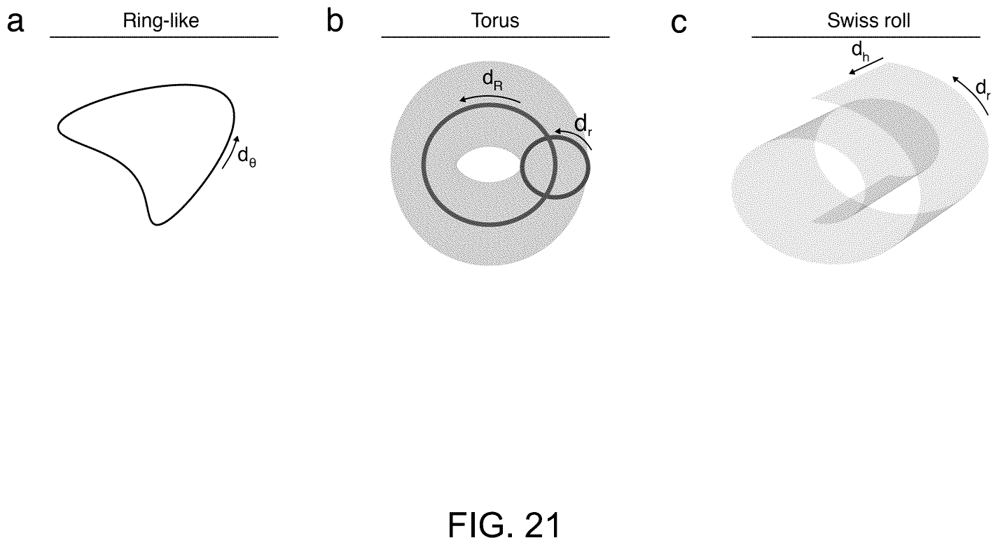

For each manifold type, the 3-dimensional (3D) manifold embeddings were taken, which specify how the manifold is embedded in 3D Cartesian space and are used as visualizations (FIG. 21). These embeddings were then transformed using a random output emission matrix to a 40D space to get the neural observations (see next section). To get the 3D manifold embeddings, each manifold type has its own equation, which was expanded on in the following sections. Below, the 3 dimensions of the 3D embeddings were denoted as e₁, e₂ and e₃.

Ring-like manifold: the ring-like manifold embeddings were generated from the 1D ring manifold coordinate (de), which is an angle between 0-2π, using the following equations (FIG. 21a).

$${e}_{1} = cos ( {d}_{θ} ) , {e}_{2} = sin ( 2 {d}_{θ} ) , {e}_{3} = sin ( {d}_{θ} ) , \qquad ( 9 )$$

Torus manifold: The Torus manifold embeddings were generated from the 2D Torus manifold coordinates dᵣ and d_{R} (FIG. 21b). dᵣ is the coordinate—angle between 0-2π—for the minor circle which is the inner circle representing the Torus's tube. d_{R} is the coordinate—angle between 0-2π—for the major circle which is the outer circle on which the Torus' tube evolves. R and r are the radius values for the minor and major circles. The 3D manifold embeddings were:

$${e}_{1} = ( R + r cos ( {d}_{R} ) ) cos ( {d}_{r} ) {e}_{2} = ( R + r cos ( {d}_{R} ) ) sin ( {d}_{r} ) {e}_{3} = r sin ( {d}_{R} ) \qquad ( 10 )$$

Without loss of generality, R=4 and r=1.5 were used for the major and minor radii, respectively.

Swiss roll manifold: The below equation generates the 3D Swiss roll manifold embeddings from the 2D Swiss-roll coordinates dᵣ and dₕ, which are its circular and height coordinates, respectively (FIG. 21c):

$${e}_{1} = 0.5 {d}_{r} cos ( {d}_{r} ) {e}_{2} = {d}_{h} {e}_{3} = 0.5 {d}_{r} sin ( {d}_{r} ) \qquad ( 11 )$$

Referring now to FIG. 21, 3D manifold embeddings are shown for FIG. 21a: ring-like, FIG. 21b: Torus, and FIG. 21c: Swiss roll manifolds.

### Generating Neural Trajectories Over Manifolds.

The vector manifold coordinates of the trajectories is denoted at each time step by dₜ. Thus dₜ is [d_{θ}], [dᵣ; d_{R}] and [dᵣ; dₕ] for ring, Torus and Swiss roll manifolds, respectively. Trajectories were generated over the manifolds by first generating a walk on the manifold's local coordinate space with a linear dynamical equation:

$${d}_{t + 1} = {A}_{d} {d}_{t} + b + {q}_{t} , \qquad ( 12 )$$

where A_{d} is the diagonal state transition matrix with eigenvalues of 0.99, b is the input term to drive the trajectory at each time-step (set as 0.2), and qₜ is the white Gaussian noise with covariance Q. The standard deviation of qₜ is randomly chosen between [0.01, 0.1]. After generating the trajectories from equation (12), the manifold coordinate vector dₜ was embedded within 3D Cartesian space to get the embeddings et with equations (9)-(11) and the neural observations were achieved from:

$${y}_{t} = {Te}_{t} + {o}_{t} , \qquad ( 13 )$$

where T is the output emission matrix and oₜ is a white Gaussian noise with covariance matrix O. The matrix T∈ [symbol] ^{40×3} has its first 3 rows chosen as [1, 0, . . . , 0], [0, 1, 0, . . . , 0], [0, 0, 1, 0, . . . , 0] to form an identity transformation for the first 3 dimensions of the manifold (for visualization purposes only), and the rest of the 37 rows are randomly chosen with elements between [−5,5]. The standard deviation of oₜ is randomly chosen between [5,25].

### Dynamical Modeling for Real-Time Inference of Nonlinear Latent Factors in Multiscale Neural Activity.

Continuous real-time decoding of target variables from time-series data is desired for many applications across various domains including neuroscience. Further, these variables can be encoded across multiple time-series modalities such as discrete spiking activity and continuous field potentials that can have different timescales (i.e., sampling rates) and different probabilistic distributions, or can even be missing at some time-steps. Existing nonlinear models of multimodal neural activity do not support real-time decoding and do not address the different timescales or missing samples across modalities. Disclosed herein is a learning framework that can nonlinearly aggregate information across multiple time-series modalities with such distinct characteristics, while also enabling real-time decoding. This framework comprises 1) a multiscale encoder that nonlinearly fuses information after learning within-modality dynamics to handle different timescales and missing samples, 2) a multiscale dynamical backbone that extracts multimodal temporal dynamics and enables real-time decoding, and 3) modality-specific decoders to account for different probabilistic distributions across modalities. Smoothness regularization objectives on the learned dynamics to better decode smooth target variables such as behavioral variables and employing a dropout technique to increase the robustness for missing samples is also described herein. The model is demonstrated to aggregate information across modalities to improve target variable decoding in simulations and in a real multiscale brain dataset. Further, the method outperforms prior linear and nonlinear multimodal models.

It is desirable in many engineering and science applications to infer target variables that are encoded in multiple time-series modalities and do so in real-time (i.e., causally). An important example of such an application arises in neuroscience for the inference of cognitive or behavioral variables from multi-modal neural time-series data for example in neurotechnology and BCIs. Accurate inference of these variables requires developing nonlinear dynamical models of the multimodal time-series that can, at each time-step, aggregate information across modalities in real-time. Further, a natural challenge in developing these models arises when modalities can be missing at some time-steps due to measurement failures or interruptions or due to different timescales (i.e., sampling rates) across modalities. Therefore, a dynamical model of multimodal time-series data for real-time applications such as BCIs should address these challenges: enable temporal and multimodal data fusion, perform real-time inference, and address different timescales and/or missing samples across modalities. Prior nonlinear dynamical models have not addressed all these challenges. To that end, a new nonlinear dynamical model of multimodal time-series was developed that provides all these capabilities. The model can perform multimodal data fusion and account for different timescales and missing samples, while also enabling real-time inference. This can be used for multimodal fusion in BCIs, for example to fuse information across neuronal population spiking activity modality and LFP modalities, which can improve the accuracy of decoding behavior and make the BCIs robust to degradation of one of these signal modalities over time.

In neuroscience, real-time multimodal data fusion is important especially for the design of neurotechnologies such as BCIs. It has been shown that fusing neural modalities such as local field potentials (LFP) and spiking activity can improve the inference of arm movements. More specifically, spiking activity is a binary-valued time-series that indicates the presence of action potential events from neurons and count processes such as Poisson are employed for modeling spiking activity. LFP activity is a continuous-valued modality that measures network-level neural processes and is typically modeled with a Gaussian distribution. Further, LFPs are often obtained at a slower timescale than spikes, which are typically measured at a millisecond timescale. Multimodal data is referred to herein with different timescales as multiscale data. Thus, to fuse information across the spiking and LFP modalities and improve downstream behavior decoding tasks, their dynamics should be modeled by incorporating their cross-modality probabilistic and timescale differences. The methods described further herein can achieve this goal.

Most of the existing dynamical modeling approaches in neuroscience focus on a single modality of neural activity. These models are either in linear or switching linear form or utilize deep learning approaches for nonlinear modeling. However, these models do not capture multimodal neural dynamics. Motivated by this, recent dynamical models have been designed for multiscale neural dynamics while also enabling real-time inference and handling timescale differences, but they are in linear form and cannot capture nonlinearities. There have also been recent studies on nonlinear dynamical system reconstruction from multimodal neural data. However, their latent factor inference is done non-causally over time and is not real-time; also their latent factor inference does not handle different timescales.

Beyond neural time-series data, approaches in other domains such as natural language processing (NLP), healthcare applications, and computer vision have been proposed to combine multiple modalities to improve performance in downstream tasks. However, they do not address the challenge of different timescales and missing samples over time, and have not addressed the modeling of neural and behavior data and modeling of Poisson and Gaussian distributed modalities encountered in neuroscience.

Disclosed herein is a novel nonlinear dynamical modeling method that can nonlinearly aggregate information across multiple modalities with different distributions, distinct timescales, and/or missing samples over time, while supporting inference both in real-time and non-causally. To achieve these capabilities and enhance performance compared with baselines, (1) a multiscale encoder was designed that performs nonlinear information fusion through neural networks after learning modality-specific linear dynamical models (LDMs) that account for timescale differences and missing samples in real-time by learning temporal dynamics, (2) smoothness priors were imposed on the latent dynamics via new smoothness regularization objectives that also prevent learning trivial identity neural network transformations, and (3) a technique termed time-dropout during model training was employed to increase robustness to missing samples even further. This method is termed herein as Multiscale Real-time Inference of Nonlinear Embeddings (MRINE).

Through stochastic Lorenz attractor simulations and a real nonhuman primate (NHP) spiking and LFP neural dataset, it was shown that MRINE infers latent factors that are more predictive of target variables—i.e., true latent factors for the simulations and behavioral arm movement variables for the NHP dataset. Further, MRINE was compared with recent linear and nonlinear multimodal models of neural activity, termed multiscale subspace identification (MSID) and multimodal piecewise-linear recurrent neural networks (mmPLRNN), respectively, and with a variational autoencoder-based model of multimodal data termed multimodal variational autoencoder (MVAE). Also, herein, LFADS, a unimodal model of neural activity, was extended to the multimodal setting (abbreviated by mmLFADS). Both LFADS and mmLFADS were also included in the comparisons. As disclosed further herein, MRINE outperforms all methods in behavior decoding for the NHP dataset.

### Methodology.

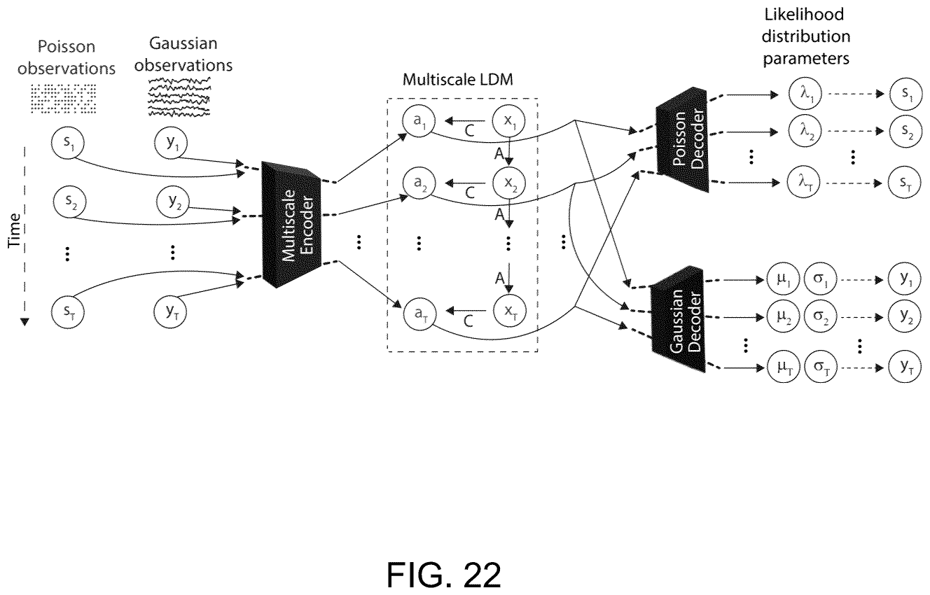

An initial assumption is that observations include discrete neural signals (e.g., spikes) sₜ∈{0,1}ⁿ^{ₛ} for t∈ [symbol] where [symbol] ={1, 2, . . . , T} and continuous neural signals (e.g., LFPs) yₜ∈ [symbol] ⁿ^{_{y}} for t∈ [symbol] ′ where [symbol] ′⊂ [symbol] . Note that the two different sets [symbol] and [symbol] ′ allow for the timescale differences of sₜ and yₜ via different time-indices. As shown in FIG. 22 and expanded on below, the neural processes generating sₜ and yₜ are described through multiscale latent and embedding factors, which in turn can be extracted by nonlinearly aggregating information across these multiple neural modalities with a multiscale encoder.

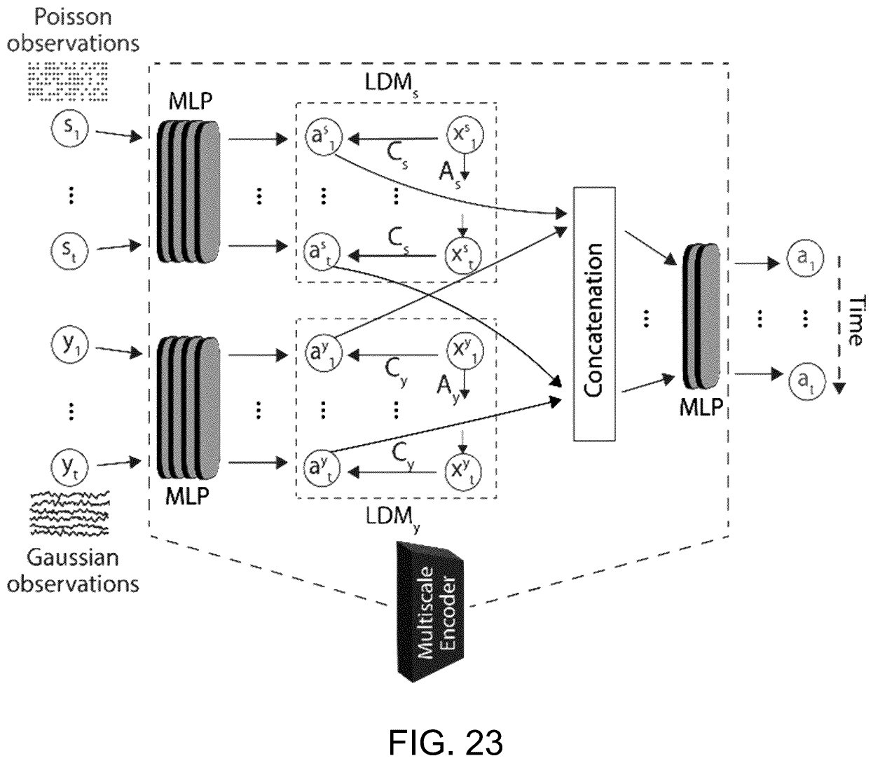

Referring now to FIG. 22, MRINE model architecture is illustrated, in accordance with various embodiments. Multiscale encoder nonlinearly (see FIG. 23) extracts multiscale embedding factors (aₜ) by fusing discrete Poisson and continuous Gaussian neural time-series in real-time (as indicated by thick dashed lines) while accounting for timescale differences and missing samples. Temporal dynamics on this multiscale embedding are then explained with a multiscale LDM whose states are the multiscale latent factors (xₜ). Embedding factors reconstruct the distribution parameters of both the Poisson and the Gaussian modalities through the modality-specific decoders.

### Model Formulation.

The model architecture is shown in FIG. 22 with its main components being a multiscale encoder for nonlinear information fusion, a multiscale LDM backbone, and decoders for each modality. The generative model is written as follows:

$${x}_{t + 1} = {Ax}_{t} + {w}_{t} \qquad ( 14 )$$

$${a}_{t} = {Cx}_{t} + {r}_{t} \qquad ( 15 )$$

$${p}_{{θ}_{s}} ( {s}_{t} \vert {a}_{t} ) = Poisson ( {s}_{t} ; λ ( {a}_{t} ) ) \qquad ( 16 )$$

$${p}_{{θ}_{y}} ( {y}_{t} \vert {a}_{t} ) = 𝒩 ( {y}_{t} ; μ ( {a}_{t} ) , σ ) . \qquad ( 17 )$$

Here, equations (14) and (15) form a multiscale LDM. In this LDM, aₜ∈ [symbol] ⁿ^{ₐ}, termed multiscale embedding factors, are the observations. aₜ is obtained as the nonlinear aggregation of multimodal information through the multiscale encoder. Further, xₜ∈ [symbol] ⁿ^{ₓ}, termed multiscale latent factors, are the LDM state and model the linear dynamics in the nonlinear embedding space. Correspondingly, A∈ [symbol] ⁿ^{ₓ}^{×n}^{ₓ} and C∈ [symbol] ⁿ^{ₐ}^{×n}^{ₓ} are the state transition and observation matrices in the multiscale LDM, respectively; wₜ∈ [symbol] ⁿ^{ₓ} and rₜ∈ [symbol] ⁿ^{ₐ} are zero-mean Gaussian dynamics and observation noises with covariance matrices W∈ [symbol] ⁿ^{ₓ}^{×n}^{ₓ} and R∈ [symbol] ⁿ^{ₐ}^{×n}^{ₐ}.

The observations from different modalities sₜ and yₜ are then generated from aₜ as in equations (16) and (17), respectively, with the likelihood distributions denoted by p_{θ}_{ₛ}(sₜ|aₜ) and p_{θ}_{_{y}}(yₜ|aₜ). Assuming that data modalities are conditionally independent given aₜ, the discrete spiking activity sₜ was modeled with a Poisson distribution and the continuous neural signals yₜ with a Gaussian distribution, given that these distributions have shown success in modeling each of these modalities. The means of the corresponding distributions λ(aₜ)∈ [symbol] ⁿ^{ₛ} and μ(aₜ)∈ [symbol] ⁿ^{_{y}} are parametrized by neural networks with parameters θₛ and θ_{y}. Practically, it was observed that learning the variance of the Gaussian likelihood yielded suboptimal performance, thus it could be set to a constant value, i.e., unit variance.

### Encoder Design and Inferring Multiscale Factors.

To infer aₜ and xₜ from sₜ and yₜ, the mapping was first constructed from sₜ and yₜ to aₜ as:

$${a}_{t} = {f}_{ϕ} ( {s}_{t} , {y}_{t} ) \qquad ( 18 )$$

where f_{ϕ}(⋅) represents the multiscale encoder network parametrized by a neural network with parameters ϕ.

One obstacle in the design of the encoder network is accounting for the different timescales without using augmentation techniques such as zero-padding as commonly done since they can yield suboptimal performance and distort the information during latent factor inference. Thus, it is important to account for timescale differences and the possibility of missing samples when designing the multiscale encoder. Additionally, a goal was to perform multimodal fusion aₜ each time-step while also allowing for real-time inference of factors. These problems were addressed with a multiscale encoder network design shown in FIG. 23.

In the multiscale encoder (FIG. 23), first, each modality (sₜ and yₜ) is processed by separate multilayer perception (MLP) networks with parameters ϕₛ and ϕ_{y} to obtain modality-specific embedding factors, aₜ^{s}∈ [symbol] ⁿ^{ₐ} and aₜ^{y}∈ [symbol] ⁿ^{ₐ}, respectively. Then, modality-specific LDMs are constructed for each modality, whose observations are their corresponding embedding factors:

$$\begin{matrix}{x}_{t + 1}^{s} = {A}_{s} {x}_{t}^{s} + {w}_{t}^{s} \\ {a}_{t}^{s} = {C}_{s} {x}_{t}^{s} + {r}_{t}^{s}\end{matrix} \qquad ( 19 )$$

$$\begin{matrix}{x}_{t + 1}^{y} = {A}_{y} {x}_{t}^{y} + {w}_{t}^{y} \\ {a}_{t}^{y} = {C}_{y} {x}_{t}^{y} + {r}_{t}^{y}\end{matrix} \qquad ( 20 )$$

where xₜ^{s}, xₜ^{y}∈ [symbol] ⁿ^{ₐ} are modality-specific latent factors, Aₛ, A_{y}∈ [symbol] ⁿ^{ₐ}^{×n}^{ₐ} are the state transition matrices, Cₛ, C_{y}∈ [symbol] ⁿ^{ₐ}^{×n}^{ₐ} are the emission matrices, wₜ^{s}, wₜ^{y}∈ [symbol] ⁿ^{ₐ} are the zero-mean dynamics noises with covariances Wₛ, W_{y}∈ [symbol] ⁿ^{ₐ}^{×n}^{ₐ}, and rₜ^{s} and rₜ^{y} are the zero-mean Gaussian observation noises with covariances Rₛ, R_{y}∈ [symbol] ⁿ^{ₐ}^{×n}^{ₐ} for modalities sₜ and yₜ, respectively. The modality-specific LDM parameters were denoted by ψₛ={Aₛ, Cₛ, Wₛ, Rₛ} and ψ_{y}={A_{y}, C_{y}, W_{y}, R_{y}} for sₜ and yₜ, respectively.

Referring now to FIG. 23, the MRINE multiscale encoder design is illustrated in accordance with various embodiments. Modality-specific LDMs learn within-modality dynamics and account for timescale differences or missing samples via Kalman filtering. Then, filtered modality-specific embedding factors (a_{t|t}^{s} and a_{t|t}^{y}) are fused and processed by another fusion network to obtain the multiscale embedding factors.

The modality-specific LDMs account for missing samples whether due to timescale differences or missed measurements by using the learned within-modality state dynamics to predict these samples forward in time, while maintaining the operation fully real-time/causal. Specifically, given the modality-specific LDMs in equations (19) and (20), the modality-specific latent factors, x_{t|t}^{s} and x_{t|t}^{y} can be obtained with Kalman filtering, which is real-time and constitutes the optimal minimum mean-squared error estimator for these models. The subscript i|j is used to denote the factors inferred at time i given all observations up to time j. As such, subscripts t|t, t|T and t+k|t denote causal/real-time filtering, non-causal smoothing and k-step-ahead prediction, respectively.

At this stage, if t is an intermittent time-step such that yₜ is missing, x_{t|t}^{y} is obtained with forward prediction using the Kalman predictor as x_{t|t}^{y}=A_{y}x_{t-1|t-1}^{y}, and similarly for x_{t|t}^{s} if sₜ is missing. Therefore, the information flow from any missing observations is prevented during latent factor inference but the learned dynamics (e.g., A_{y}) can be utilized to infer the factors when observations are missing. Having done this for each modality, information fusion can be performed by concatenating the modality-specific embedding factors and passing them through a fusion network with parameters ϕₘ to obtain the initial representation for aₜ, which later becomes the noisy observations of the multiscale LDM formed by equations (14) and (15) (also see FIG. 22). The learnable multiscale encoder network parameters are denoted by ϕ={ϕₛ, ϕ_{y}, ψₛ, ψ_{y}, ϕₘ}.

The multiscale LDM now allows us to infer x_{t|t} with real-time (causal) Kalman filtering, or infer x_{t|T} with non-causal Kalman smoothing. Similarly, k-step-ahead predicted multiscale latent factors x_{t+k|t} can be obtained by forward propagating x_{t|t} k-times into the future with Eq. 13, i.e., x_{t+k|t}=A^{k}x_{t|t}. The parameters of the multiscale LDM were denoted by ψₘ={A, C, W, R}. The filtered, smoothed, and k-step-ahead predicted parameters of the likelihood functions in equations (16) and (17) can now be obtained by first using equation (15) to compute the corresponding multiscale embedding factors—i.e. a_{i|j}=Cx_{i|j}, where i|j is t|t, t|T and t+k|t, respectively—and then forward passing these factors through each modality's decoder network parametrized by θₛ or θ_{y} (FIG. 22).

### Learning the Model Parameters.

k-step ahead prediction: To learn the MRINE model parameters and encourage learning the dynamics, as part of the loss, the multi-horizon k-step-ahead prediction loss was defined as:

$${ℒ}_{k} = - {\sum }_{k ∈ 𝒦} ( {\sum }_{\begin{matrix}t ∈ 𝒯 \\ t \geq k\end{matrix}} τ log ( {p}_{{θ}_{s}} ( {s}_{t} \vert {a}_{t \vert t - k} ) ) + {\sum }_{\begin{matrix}t ∈ 𝒯 ′ \\ t \geq k\end{matrix}} log ( {p}_{{θ}_{y}} ( {y}_{t} \vert {a}_{t \vert t - k} ) ) ) \qquad ( 21 )$$

where [symbol] and [symbol] ′ denote the time-steps when sₜ and yₜ are observed, respectively. τ is the scaling parameter as the log-likelihood values of different modalities are of different scales, and [symbol] is the set of future prediction horizons. k-step-ahead prediction is performed by computing k-step-ahead predicted multiscale latent factors, x_{t+k|t}, rather than modality-specific ones.

Smoothed reconstruction: In addition to the k-step-ahead prediction, the reconstruction was optimized from smoothed multiscale factors:

$${ℒ}_{smooth} = - ( {\sum }_{t ∈ 𝒯} τ log ( {p}_{{θ}_{s}} ( {s}_{t} \vert {a}_{t \vert T} ) ) + {\sum }_{t ∈ 𝒯 ′} log ( {p}_{{θ}_{y}} ( {y}_{t} \vert {a}_{t \vert T} ) ) ) \qquad ( 22 )$$

where T is the last time-step that any modality is observed.

Smoothness regularization: To impose a smoothness prior on learned dynamics and to prevent the model from overfitting by learning trivial identity encoder/decoder transformations, in the loss, smoothness regularization was applied on p_{θ}_{ₛ}(sₜ|a_{1:T}), p_{θ}_{_{y}}(yₜ|a_{1:T}) and p(xₜ|a_{1:T}) by minimizing the KL-divergence between the distributions in consecutive time-steps. Here, this technique was extended to Poisson-distributed modalities. Let [symbol] ₛₘ be the smoothness regularization penalty, defined as:

$${ℒ}_{sm} = {γ}_{s} {\underbrace{{\sum }_{i = 1}^{\vert 𝒯 \vert - 1} {\sum }_{j = 1}^{{n}_{s}} d ( {p}_{{θ}_{s}} ( {s}_{{𝒯}_{i}}^{j} \vert {a}_{{𝒯}_{i} \vert T} ) , {p}_{{θ}_{s}} ( {s}_{{𝒯}_{i + 1}}^{j} \vert {a}_{{𝒯}_{i + 1} \vert T} ) )}}_{Smoothness on {s}_{t}} + {γ}_{y} {\underbrace{\begin{matrix}{\sum }_{i = 1}^{\vert 𝒯 ′ \vert - 1} {\sum }_{j = 1}^{{n}_{y}} d ( {p}_{{θ}_{y}} ( {y}_{𝒯 {′}_{i}}^{j} \vert & {a}_{𝒯 {′}_{i} \vert T} ) , {p}_{{θ}_{y}} ( {y}_{𝒯 {′}_{i + 1}}^{j} \vert {a}_{𝒯 {′}_{i + 1} \vert T} ) )\end{matrix}}}_{Smoothness on {y}_{t}} + {γ}_{x} {\underbrace{\begin{matrix}{\sum }_{t = 1}^{T} & {\sum }_{j = 1}^{⌊ \frac{{n}_{x}}{2} ⌋} d ( p ( {x}_{t}^{j} \vert {a}_{t \vert T} ) , p ( {x}_{t + 1}^{j} \vert {a}_{t + 1 \vert T} ) )\end{matrix}}}_{Smoothness on {x}_{t}} \qquad ( 23 )$$

where d(⋅,⋅) is the KL-divergence between given distributions, subscript i denotes the i^{th} element of the set, superscript j is the j^{th} component of the vector (e.g., [symbol] ), and p_{θ}_{ₛ}(sₜ|a_{t|T}) and p_{θ}_{_{y}}(yₜ|a_{t|T}) are as in equations (16) and (17), respectively. Here γₛ, γ_{y} and γₓ are the scaling hyperparameters.

The smoothness penalties on sₜ and yₜ are computed over the time-steps that they are observed. The penalty on xₜ is obtained over all time-steps as xₜ is inferred for all time-steps. After extracting a_{1:T} with multiscale encoder, p(xₜ|a_{1:T}) can be obtained with the Kalman smoother, which provides the posterior distribution for the multiscale LDM:

$$p ( {x}_{t} \vert {a}_{1 : T} ) = 𝒩 ( {x}_{t} ; {x}_{t \vert T} , {Σ}_{t \vert T} ) \qquad ( 24 )$$

where x_{t|T} and Σ_{t|T} are the smoothed multiscale latent factors and their error covariances, respectively. To allow the model to learn both fast and slow dynamics, the smoothness regularization were put on xₜ on half of its dimensions.

To assess the impact of incorporating smoothness regularization terms in equation (23) and smoothed reconstruction in equation (22), an ablation study was performed as described further herein. This study demonstrated that each term contributes to the improved performance. Further, in the ablation study described herein on the effect of multiscale modeling, it was shown that MRINE's multiscale encoder design is another important contributing factor to improved performance, compared to the case where missing samples are imputed by zeros and removed from the training objectives above.

Finally, the loss was formed as the sum of the above elements and regularization terms, and minimized via mini-batch gradient descent using the Adam optimizer to learn the model parameters {ϕ, ψ, θs, θ_{y}} (note that any other optimizer or optimizer parameters can also be used to optimize the loss (i.e., the learning cost function)):

$${ℒ}_{MRINE} = {ℒ}_{k} + {ℒ}_{smooth} + {ℒ}_{sm} + {γ}_{r} {L}_{2} ( {θ}_{s} , {θ}_{y} , {ϕ}_{s} , {ϕ}_{y} ) \qquad ( 25 )$$

where L₂(⋅) is the L₂ regularization penalty on the MLP weights and γᵣ is the scaling hyperparameter. Further, MRINE parameters can be optimized in a variational manner by incorporating KL divergence term between a fixed prior distribution and approximate posterior distribution obtained via multiscale encoder and Kalman filtering/smoothing, for example, in equation (25). Finally, any other optimizer or optimizer parameters can also be used to optimize the loss (i.e., the learning cost function).

Moreover, a dropout technique termed time-dropout was employed during training to increase the robustness of MRINE to missing samples even further.

### Stochastic Lorenz Attractor Simulations.

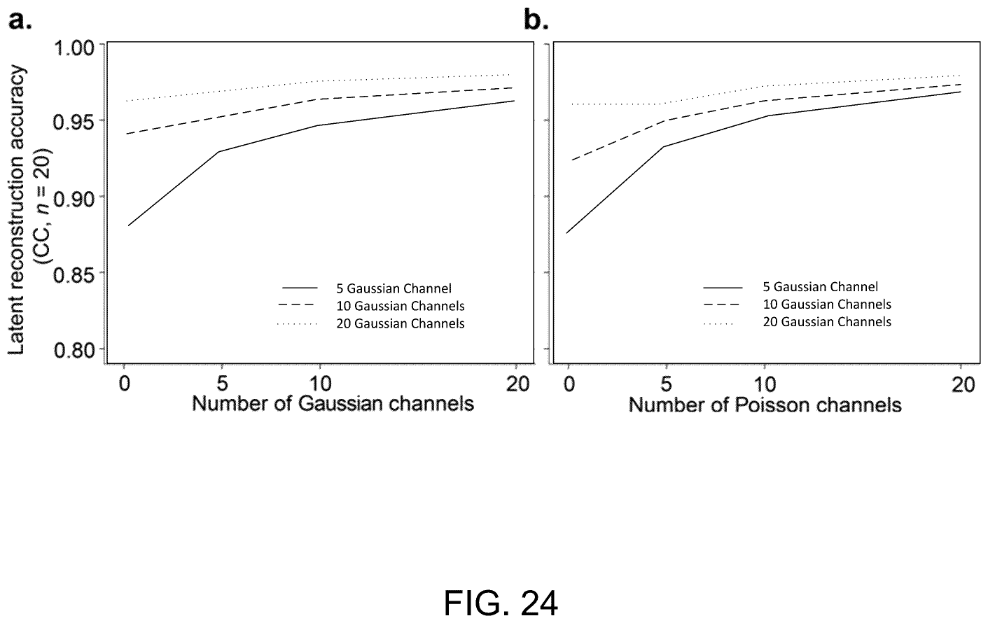

Referring now to FIG. 24, latent reconstruction accuracies for the stochastic Lorenz attractor simulations is illustrated in accordance with various embodiments. FIG. 24a shows accuracies when 5, 10, or 20 Poisson channels were the primary modality to which Gaussian channels were gradually added. Solid lines show the mean. FIG. 24b is similar to FIG. 24a but with the Gaussian channels being the primary modality.

First, it was validated that MRINE can successfully aggregate information across multiple modalities by performing simulations with the stochastic Lorenz attractor dynamics defined in equation (31). To do so, Poisson and Gaussian observations with 5, 10 and 20 dimensions were generated. 4 systems with different random seeds were generated and 5-fold cross-validation was performed for each system. Then, MRINE was trained as well as single-scale networks with either only Gaussian observations or only Poisson observations. To assess MRINE's ability to aggregate multimodal information, its latent reconstruction accuracies were compared with those of single-scale networks. For each model, these accuracies were obtained by computing the average correlation coefficient (CC) between the true and reconstructed latent factors. Each observation dimension is referred to as a channel for simplicity.

The Poisson modality was first considered as the primary modality and fused with 5, 10, and 20 Gaussian channels as the secondary modality. As shown in FIG. 24a, for all different numbers of Poisson channels, gradually fusing Gaussian channels significantly improved the latent reconstruction accuracies (P<10⁻⁵, N=20, one-sided Wilcoxon signed-rank test). As expected, these improvements were higher in the low information regime where fewer primary Poisson channels were available (5 and 10) compared to the high information regime (20 Poisson channels). Likewise, when the Gaussian modality was the primary modality, latent reconstruction accuracies again showed consistent improvement across all regimes as Poisson channels were fused (FIG. 24b, P<10⁻⁵, N=20, one-sided Wilcoxon signed-rank test).

### MRINE Fused Multiscale Information in Behavior Decoding for the NHP Dataset.

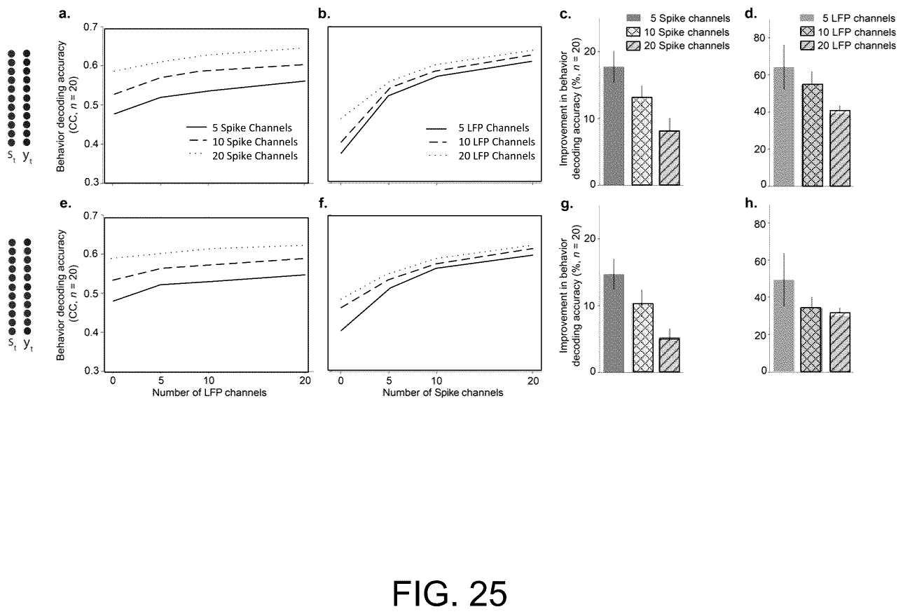

Referring now to FIG. 25, behavior decoding accuracies for the NHP dataset when spike and LFP channels had the same (top row) and different (bottom row) timescales are illustrated, in accordance with various embodiments. Error bars represent SEM. FIG. 25a shows accuracies when 5, 10, or 20 spike channels where the primary modality and an increasing number of LFP channels were fused. FIG. 25b is similar to FIG. 25a when LFP channels were the primary modality. FIG. 25c illustrates percentage improvements in decoding accuracy when 20 LFP channels were added to 5, 10, and 20 spike channels. FIG. 25d is similar to FIG. 25c, when 20 spike channels were added to 5, 10, and 20 LFP channels. FIGS. 25e-h are the same as FIGS. 25a-d but when spike and LFP channels had different timescales.

To test MRINE's information aggregation capabilities in a real dataset, a publicly available NHP dataset was used. In this dataset, discrete spiking activity and LFP signals were recorded while the subject was performing sequential 2D reaches to random targets appearing in a virtual-reality environment (details provided further herein). The 2D cursor velocity was considered in the x and y directions as the target behavior variables to decode from inferred latent factors. Single-scale models were trained with 5, 10, and 20 channels of spike and LFP signals, and MRINE models for every combination of these multimodal channel sets. In the analyses, 4 recorded experimental sessions were used on different days and 5-fold cross-validation for each session was performed.

First, MRINE's behavior decoding performance was tested when both spike and LFP modalities had the same timescale, i.e., were observed every 10 ms (abbreviated LFPs as 10 ms LFPs). When spiking signals were taken as the primary modality, fusing them with increasing numbers of LFP channels steadily improved the behavior decoding accuracy for all different numbers of primary spike channels (FIG. 25a, P<0.007, N=20, one-sided Wilcoxon signed-rank test). Similar to simulation results, improvements in behavior decoding accuracy were higher in the low-information regimes, i.e., for 5 and 10 primary spike channels. For instance, adding 20 LFP channels to 5, 10, and 20 spike channels improved behavior decoding accuracy by 17.7%, 12.6%, and 8.3%, respectively (FIG. 25c). Similarly, when LFP signals were considered as the primary modality, behavior decoding accuracies again improved significantly when spike channels were fused (FIG. 25b, P<10⁻⁴, N=20, one-sided Wilcoxon signed-rank test). As illustrated in FIG. 25d, the improvements in this scenario were higher compared to when spiking activity was the primary modality (FIG. 25c), i.e., adding 20 spike channels to 5, 10 and 20 LFP channels improved behavior decoding accuracy by 64.2%, 54.9%, and 39.1%, respectively, indicating that spiking activity encoded more information than LFP signals about the target behavior in this dataset. Overall, the bidirectional improvements here suggest that spike and LFP modalities may encode non-redundant information about behavior variables that can be fused nonlinearly with MRINE.

MRINE was tested when modalities had different timescales, i.e., spikes were observed every 10 ms and LFPs every 50 ms (abbreviated as 50 ms LFPs). As expected, fusing spikes with 50 ms LFPs resulted in smaller improvements in behavior decoding compared to fusion with 10 ms LFPs. Nevertheless, as shown in FIG. 25e,f, MRINE again improved behavior decoding accuracies significantly when LFP channels were added to spike channels (P<0.05, N=20, one-sided Wilcoxon signed-rank test) and spike channels were added to LFP channels (P<10⁻⁴, N=20, one-sided Wilcoxon signed-rank test). For instance, adding 20 channels of 50 ms LFP improved behavior decoding accuracy by 14.7%, 10.4%, and 5.3% when fused with 5, 10, and 20 spike channels (FIG. 25g), respectively. Compared to the previous case, percentage improvements had a maximum decrease of 3 percentage points, even when MRINE was trained with 5 times fewer LFP samples. These findings show that MRINE can aggregate multimodal information even when modalities have different timescales; MRINE utilizes the information in the undersampled (slower timescale) modality to infer faster timescale latent factors that are more predictive of the downstream task (here behavior decoding).

### MRINE's Information Aggregation was Robust to Missing Samples.

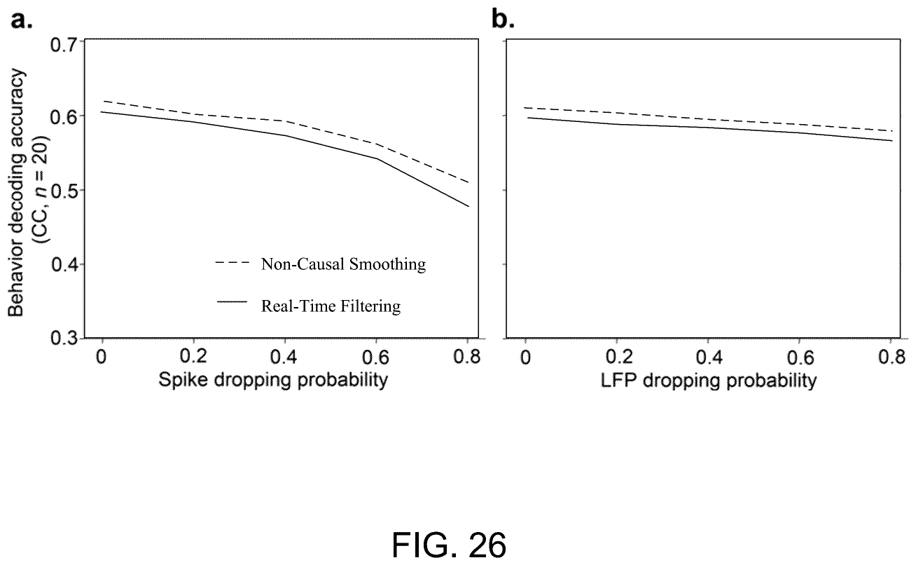

Referring now to FIG. 26, behavior decoding accuracies in the NHP dataset when spike and LFP channels had both missing samples and different timescales is illustrated, in accordance with various embodiments. FIG. 26a illustrates accuracies of MRINE when the sample dropping probability of LFPs was fixed at 0.2 while that of spikes was varied as shown on the x-axis. Lines represent mean. FIG. 26b is similar to FIG. 26a when sample dropping probability of spikes was fixed at 0.2 while that of LFPs was varied.

Next, the robustness of MRINE inference to missing samples was studied. Here, in addition to having different timescales, various sample dropping probabilities to drop spike or LFP samples in the NHP dataset were used. For MRINE models that were trained with 20 channels of both spikes and 50 ms LFP, the dropping probability was fixed for LFP samples as 0.2 while varying that of spike samples (FIG. 26a), and vice versa (FIG. 26b) during inference. Behavior decoding accuracies of MRINE remained robust, decreasing by only 4.3% and 17% when 40% and 80% of spike samples were missing, respectively, in addition to 20% of LFP samples missing (FIG. 26a). Further, behavior decoding accuracies were more robust to missing LFP samples (FIG. 26b), again indicating the dominance of spiking activity in behavior decoding for this dataset. Finally, both causal filtering and non-causal smoothing were robust to missing samples.

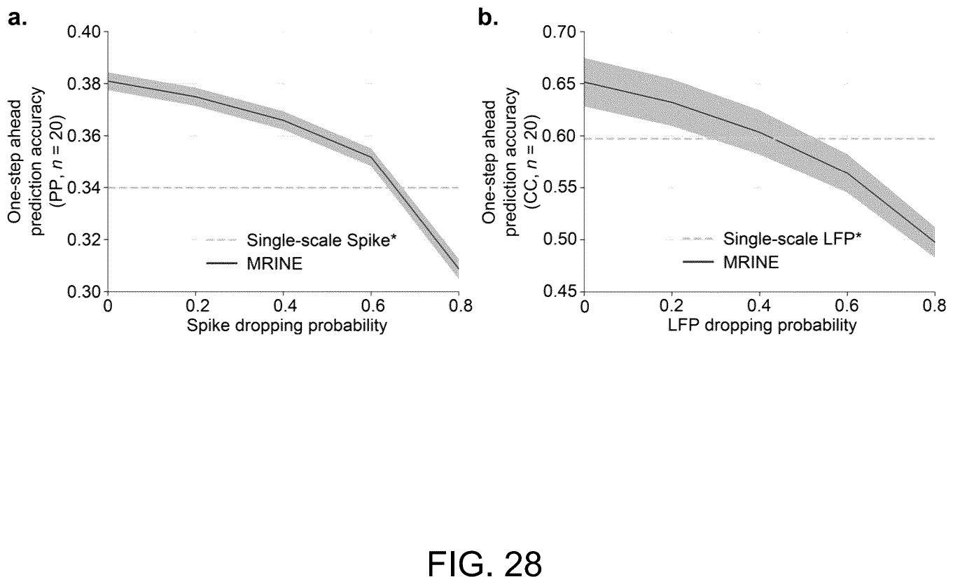

In addition to behavior decoding, MRINE's information aggregation capabilities were evaluated in cross-modal imputed predictions of spike and LFP signals. Similar to the previous case, in addition to having different timescales, one modality was dropped with various sample dropping probabilities where the other modality was fully observed. It was found that MRINE outperforms single-scale models in neural cross-modal prediction even when up to 60% of spike samples (FIG. 28a) and 40% of LFP samples were dropped (FIG. 28b) where single-scale model predictions were obtained with fully available observations.

MRINE Improved Behavior Decoding Compared with Prior Multimodal Modeling Methods.

MRINE was compared with prior multimodal methods, namely the recent MSID, mmPLRNN, and MVAE. Further, herein, the unimodal LFADS model was extended to the multimodal setting (denoted by mmLFADS) by modeling spikes and LFPs with separate observation models (similar to equations (16) and (17)). LFADS models were also trained on multimodal data with the same likelihood by treating the multimodal data as a single modality, the results of which are denoted by LFADS below. An ablation study on the effect of different observation models was also performed as described further below.

MRINE, MSID, and MVAE were trained with 5, 10, or 20 channels of spikes and 50 ms LFPs as they allow for different timescales but the same timescale (10 ms) was used for both spike and LFP signals to train mmPLRNN, LFADS and mmLFADS as they do not account for different timescales. Further, mmPLRNN, LFADS and mmLFADS decodings were performed non-causally unlike MRINE and MSID since mmPLRNN, LFADS, and mmLFADS do not support real-time recursive inference. For all numbers of primary channels (i.e., all information regimes), MRINE significantly outperformed all of MSID, mmPLRNN, MVAE, LFADS, and mmLFADS in behavior decoding (Table 2, P<0.06, N=20, one-sided Wilcoxon signed-rank test).

TABLE 2

| | 5 Spike | 10 Spike | 20 Spike |
|---|---|---|---|
| Method | 5 LFP | 10 LFP | 20 LFP |
| MVAE | 0.326 ± | 0.386 ± | 0.425 ± |
| | 0.011 | 0.009 | 0.009 |
| MSID | 0.380 ± | 0.440 ± | 0.519 ± |
| | 0.021 | 0.015 | 0.012 |
| mmPLRNN | 0.455 ± | 0.478 ± | 0.533 ± |
| | 0.012 | 0.011 | 0.012 |
| LFADS | 0.467 ± | 0.495 ± | 0.548 ± |
| | 0.017 | 0.015 | 0.011 |
| mmLFADS | 0.468 ± | 0.507 ± | 0.547 ± |
| | 0.016 | 0.015 | 0.011 |
| MRINE | 0.487 ± | 0.555 ± | 0.611 ± |
| | 0.007 | 0.011 | 0.012 |

Behavior decoding accuracies for the NHP dataset with 5, 10, and 20 spike and LFP channels for MRINE, MSID, mmPLRNN, MVAE, LFADS and mmLFADS.
The best-performing method is in bold, ± represents SEM.

In various embodiments, MRINE can nonlinearly and in real-time aggregate information across multiple time-series modalities, even with different timescales or with missing samples. To achieve this, a novel multiscale encoder design was developed that first extracts modality-specific representations while accounting for their timescale differences and missing samples, and then performs nonlinear fusion to aggregate multimodal information. This encoder was combined with a multiscale LDM backbone to achieve real-time multiscale fusion. Through stochastic Lorenz attractor simulations and a real NHP dataset, MRINE's ability to causally fuse information across modalities even with different timescales or with missing samples was shown. MRINE outperforms the recent linear and nonlinear multimodal models including MSID, mmPLRNN, and MVAE, a unimodal model termed LFADS that is trained on concatenated multimodal neural signals, and the multimodal extension of LFADS that was developed herein, named mmLFADS. These comparisons in addition to ablation studies herein on the effect of loss terms, multiscale modeling, and using different observation models show the importance of MRINE's multiscale nonlinear fusion and training objective outlined previously herein. MRINE can also be extended to track temporal variability such as with switching dynamics or adaptive approaches. Overall, it is shown that MRINE enables real-time multiscale decoding and cross-modality prediction that can handle both timescale differences and missing samples, while also providing competitive performance. Thus, MRINE can be especially important for real-time systems such as brain-computer interfaces (BCIs), closed-loop deep brain stimulation (DBS) systems, closed-loop neurostimulation, and any other neurotechnologies.

### Time-Dropout.

To improve the robustness of MRINE against missing samples, a regularization technique denoted as “time-dropout” was developed. Before training MRINE, based on the availability of the observations denoted by [symbol] and [symbol] ′, mask vectors m^{s}, m^{y}∈ [symbol] ^{T} for sₜ and yₜ were defined respectively:

$${m}_{t}^{y} = \{ \begin{matrix}1 , & if {y}_{t} is observed at t \\ 0 , & otherwise\end{matrix} \qquad ( 26 )$$

$${m}_{t}^{s} = \{ \begin{matrix}1 , & if {s}_{t} is observed at t \\ 0 , & otherwise\end{matrix} \qquad ( 27 )$$

where subscript t is the t^{th} component of the vector. The general assumption is that [symbol] ′⊂ [symbol] , such that sₜ is available for all time-steps where yₜ is observed—this choice is motivated by the faster timescale of spikes compared with field potentials. However, this scenario may not always hold as recording devices can have independent failures leading to dropped samples at any time. To mimic the partially missing scenario where either modality can be missing, as well as the fully missing scenarios where both can be missing, elements of m^{s} and m^{y} were randomly replaced (dropped) by 0 at every training step, with the same dropout probabilities ρₜ for both modalities. Masked time-steps (time-steps with 0 mask value) were not used during the latent factor inference described previously herein or in the computation of loss terms in equations (21) and (22) so that the inference and model learning were not distorted by missing samples. Instead, the inference procedure uses the learned model of dynamics to account for missing samples during both inference and learning. The original masks (as defined in equations (26) and (27), before applying time-dropout) were used while computing Lₛₘ in equation (23), as it was desired to obtain smooth representations for all available observations. Note that time-dropout differs from masked training that is commonly used for training transformer-based networks. Masked training aims to predict masked samples from existing samples unlike the training objective herein. Herein, the goal of time-dropout is to increase the robustness to missing samples by artificially introducing partially and fully missing samples during model training, rather than being the training objective itself. See the ablation study on the effect of time-dropout further herein, which shows that MRINE models trained with time-dropout had more robust behavior decoding performance and the effect of time-dropout was more prominent with more missing samples.

In addition to the time-dropout, regular dropout was also applied in the encoder's input and output layers with probability ρ_{d}.

### Training Details.

### Training Single-Scale Networks.

For the case of single-scale networks, a special case of the architecture in FIG. 22 was used by replacing the multiscale encoder with an MLP encoder, and by just using a single-scale LDM with one modality's decoder network. In particular, for field potentials, a Gaussian decoder was used, and for the spikes a Poisson decoder was used to obtain the corresponding likelihood distribution parameters. Unlike MRINE's modality-specific LDMs used in the multiscale encoder, the single-scale networks have an MLP. Also, instead of the multiscale LDM of MRINE, this MLP is then followed by a single-scale LDM to perform inference both in real-time and non-causally. During learning of the single-scale networks, the terms related to the discarded modality were dropped from loss functions in equations (21), (22), and (23).

### Setting the Likelihood Scaling Parameter τ.

The log-likelihood values of modalities with different likelihood distributions may be of different scales, e.g., Poisson log-likelihood has a smaller scale than Gaussian log-likelihood in this case (and this can change arbitrarily by simply multiplying the Gaussian modality with any constant). To prevent the model from putting more weight on one modality vs. the other due to a higher log-likelihood scale while learning the dynamics, the log-likelihood of the modality with a smaller scale was scaled by a parameter t. To set this parameter, the time averages of each modality was first computed over [symbol] and [symbol] ′ for sₜ and yₜ, respectively, as:

$$λ = \frac{1}{\vert 𝒯 \vert} {\sum }_{t ∈ 𝒯} {s}_{t} \qquad ( 28 )$$

$$μ = \frac{1}{\vert 𝒯 ′ \vert} {\sum }_{t ∈ 𝒯 ′} {y}_{t} \qquad ( 29 )$$

where λ∈ [symbol] ⁿ^{ₛ} and μ∈ [symbol] ⁿ^{_{y}}. Then, the corresponding log-likelihoods of sₜ and yₜ were computed by using these time averages as the means of their likelihood distributions (assuming unit variance for Gaussian distribution). Finally, τ was set as the ratio between the higher and smaller scale log-likelihoods:

$$τ = \frac{\frac{1}{\vert 𝒯 ′ \vert} {\sum }_{t ∈ 𝒯 ′} log ( 𝒩 ( {y}_{t} ; μ , 1 ) )}{\frac{1}{\vert 𝒯 \vert} {\sum }_{t ∈ 𝒯} log ( Poisson ( {s}_{t} ; λ ) )} \qquad ( 30 )$$

where 1∈ [symbol] ⁿ^{_{y}} is the 1's vector denoting the unit variances for the Gaussian likelihood. The above allows us to balance the contribution of both modalities in the loss function during learning.

### Hyperparameters.

Tables 3, 4, 5 provide the hyperparameters and network architectures used for training single-scale networks and MRINE on stochastic Lorenz simulations and analyses of the real NHP dataset.

For all models, a cyclical learning rate scheduler was used starting with a minimum learning rate of 0.001, and reaching the maximum learning rate of 0.01 in 10 epochs. The maximum learning rate is exponentially decreased by a scale of 0.99. Across all experiments, batch size was set to 32, MLP weights were initialized by Xavier-normal initialization, and tanh function was used as the activation function of hidden layers. All models were trained on CPU servers (AMD Epyc 7513 and 7542, 2.90 GHz with 32 cores) with parallelization. Note that these hyperparameters are just examples and any desired hyperparameter values can be used.

TABLE 3
Hyperparameters used for the stochastic Lorenz attractor simulations. SS denotes single-scale network.
The architecture's various MLP encoders and decoders are represented with their parameter notations,
and for each, the number of hidden layers and hidden units in order, separated by commas, are provided.
Specifically, ϕₛ and ϕ_{y} - i.e., MLP blocks through which sₜ and yₜ are passed in FIG. 23 - represent
the modality-specific encoder networks for Poisson and Gaussian modalities, respectively. ϕₘ is the
fusion network (the last MLP block in FIG. 23). Modality-specific decoder networks are θₛ and θ_{y} for
Poisson and Gaussian modalities, respectively. nₐ and nₓ represent dimensions of aₜ and xₜ, respectively. [symbol] is
the set of future prediction horizons in equation (21). ρₜ is the time dropout probability on
the mask vectors, and ρ_{d} denotes the dropout probability applied in the input and output layers of
the encoder network. GC represents the global gradient clipping norm on learnable parameters. γₛ, γ_{y},
and γₓ are scaling parameters for smoothness regularization penalty in equation (23). γᵣ is the L₂
penalty on MLP weights of the encoder and decoder networks. TE denotes the number of training epochs.

| | Hyperparameters | | | | | | | | | | | | | | | |
|---|---|---|---|---|---|---|---|---|---|---|---|---|---|---|---|---|
| Models | ϕₛ | ϕ_{y} | ϕₘ | θₛ | θ_{y} | nₐ | nₓ | [symbol] | ρₜ | ρ_{d} | GC | γₛ | γ_{y} | γₓ | γᵣ | TE |
| SS-Poisson | 3,128 | — | — | 3,128 | — | 32 | 32 | 1, 2, 3, 4 | 0.3 | 0.4 | 0.1 | 100 | — | 30 | 0.0001 | 200 |
| SS-Gaussian | — | 3,128 | — | — | 3,128 | 32 | 32 | 1, 2, 3, 4 | 0.3 | 0.4 | 0.1 | — | 50 | 30 | 0.0001 | 200 |
| MRINE | 3,128 | 3,128 | 1,128 | 3,128 | 3,128 | 32 | 32 | 1, 2, 3, 4 | 0.3 | 0.4 | 0.1 | 250 | 10 | 30 | 0.001 | 200 |

MSID training.

Multiscale subspace identification (MSID) is a recently proposed linear multiscale dynamical model of neural activity that assumes linear dynamics. MRINE was compared with MSID and it was shown herein that compared with the linear approach of MSID, the nonlinear information aggregation enabled by MRINE can improve downstream behavior decoding while still allowing for real-time recursive inference and for handling different timescales. To train MSID, the implementation provided by the original authors was used and the horizon hyperparameters were set to the values provided in their manuscript, i.e., h_{y}=h_{z}=10. For the comparisons reported in Table 2, as recommended by the developers in their manuscript, MSID models were fitted with various latent dimensionalities consisting of [8, 16, 32, 64] and the one that had the best behavior decoding accuracy, found with inner-cross validation done on the training data, was picked.

TABLE 4
Hyperparameters used for the NHP dataset analysis with same timescales for
both modalities. Hyperparameter definitions are the same as in Table 3.

| | Hyperparameters | | | | | | | | | | | | | | | |
|---|---|---|---|---|---|---|---|---|---|---|---|---|---|---|---|---|
| Models | ϕₛ | ϕ_{y} | ϕₘ | θₛ | θ_{y} | nₐ | nₓ | [symbol] | ρₜ | ρ_{d} | GC | γₛ | γ_{y} | γₓ | γᵣ | TE |
| SS-Poisson | 3,128 | — | — | 3,128 | — | 64 | 64 | 1, 2, 3, 4 | 0.3 | 0.1 | 0.1 | 100 | — | 30 | 0.0001 | 500 |
| SS-Gaussian | — | 3,128 | — | — | 3,128 | 64 | 64 | 1, 2, 3, 4 | 0.3 | 0.1 | 0.1 | — | 10 | 30 | 0.0001 | 500 |
| MRINE | 3,128 | 3,128 | 1,128 | 3,128 | 3,128 | 64 | 64 | 1, 2, 3, 4 | 0.3 | 0.1 | 0.1 | 250 | 10 | 30 | 0.001 | 500 |

TABLE 5
Hyperparameters used for the NHP dataset analysis with different timescales for
the different modalities. Hyperparameter definitions are the same as in Table 3.

| | Hyperparameters | | | | | | | | | | | | | | | |
|---|---|---|---|---|---|---|---|---|---|---|---|---|---|---|---|---|
| Models | ϕₛ | ϕ_{y} | ϕₘ | θₛ | θ_{y} | nₐ | nₓ | [symbol] | ρₜ | ρ_{d} | GC | γₛ | γ_{y} | γₓ | γᵣ | TE |
| SS-Poisson | 3,128 | — | — | 3,128 | — | 64 | 64 | 1, 2, 3, 4 | 0.3 | 0.1 | 0.1 | 100 | — | 30 | 0.0001 | 500 |
| SS-Gaussian | — | 3,128 | — | — | 3,128 | 64 | 64 | 1, 2, 3, 4 | 0.3 | 0.1 | 0.1 | — | 5 | 30 | 0.0001 | 500 |
| MRINE | 3,128 | 3,128 | 1,128 | 3,128 | 3,128 | 64 | 64 | 1, 2, 3, 4 | 0.3 | 0.1 | 0.1 | 250 | 5 | 30 | 0.001 | 500 |

mmPLRNN Training.

Multimodal piecewise-linear recurrent neural networks (mmPLRNN) is a recent multimodal framework that assumes piecewise-linear latent dynamics coupled with modality-specific observation models. The inference network of mmPLRNN operates non-causally in time and assumes the same timescale between modalities, unlike MRINE. Therefore, for the comparisons provided in Table 2, the behavior decoding with mmPLRNN was performed non-causally and with neural modalities of the same timescale (10 ms) unlike MRINE and MSID. To train mmPLRNN, the variational inference training code provided by the authors in their manuscript was used. However, the default implementation of mmPLRNN only supports Gaussian and categorical distributed modalities. Thus, the Poisson observation model was implemented herein. Further, the default linear decoder networks were replaced with nonlinear MLP networks for a fair comparison and better performance.

Finally, all mmPLRNN models were trained for 100 epochs. Hyperparameter searches were also performed for latent state dimension, learning rate, and number of neurons in encoder/decoder layers over grids of [16, 32, 64], [1e-4, 5e-4, 1e-3, 1e-2] and [32, 64, 128], respectively.

As shown in Table 2, MRINE outperformed mmPLRNN in behavior decoding for the NHP dataset across all information regimes, even though MRINE was trained on neural modalities of different timescales. The future-step-ahead prediction training objective along with new smoothness regularization terms and smoothed reconstruction are important elements contributing to such performance gap, whereas mmPLRNN is trained on optimizing ELBO, whose optimization can be challenging due to KL-divergence term.

LFADS and mmLFADS Training.

LFADS is a sequential autoencoder-based model of unimodal neural activity. The results reported for LFADS were obtained by training LFADS models on concatenated multimodal data which corresponds to treating multimodal data as a single modality. Further, herein, LFADS was extended to support multimodal neural activity with different observation models (denoted by mmLFADS), i.e. Poisson and Gaussian observation models for spikes and LFP, respectively. To achieve that, LFADS' unimodal decoder network that maps factors to observation model parameters was replaced with multimodal decoder networks similar to equations (16) and (17). The LFADS authors' codebase was used to train LFADS models and implement the multimodal extension, i.e., mmLFADS. The hyperparameters in the second row of Supplementary Table 1 in the original LFADS manuscript with a factor dimension of 64 were used, and the default learning rate scheduler and early stopping criterion in the codebase were used. As shown further herein, MRINE's training objectives and multiscale encoder design are contributing factors to its improved performance over LFADS and mmLFADS.

### MVAE Training.

Multimodal variational autoencoder (MVAE) is a variational autoencoder-based architecture that can account for partially paired multimodal datasets by a mixture of experts posterior distribution factorization. However, the notion of partial observations herein and in MVAE are different. In MVAE, partial observations refer to having partially missing data tuples in each element of the batch, which would translate to having completely missing LFP or spike signals for a given trial/segment of multimodal neural activity. However, modeling multimodal neural activities with different sampling rates, i.e., partially missing time-steps rather than missing either of the signals completely is of interest herein. Further, the latent factor inference in MVAE is designed to encode each modality to a single factor, whereas MRINE is designed to infer latent factors for each time-step so that behavior decoding can be performed at each time-step. To account for all these differences, MVAE models were trained without a dynamic backbone by treating each time-step as a different data point that allowed us to train MVAE models with partially missing time-steps as done for MRINE. As shown in Table 2, MVAE showed the lowest performance among all methods, which could be caused by lacking a dynamical backbone, unlike other methods.

### Stochastic Lorenz Attractor Simulations.

### Dynamical System.

The following set of dynamical equations defines the stochastic Lorenz attractor system:

$$\begin{matrix}{dx}_{1} = σ ( {x}_{2} - {x}_{1} ) dt + {q}_{1} \\ {dx}_{2} = ( ρ {x}_{1} - {x}_{1} {x}_{3} - {x}_{2} ) dt + {q}_{2} \\ {dx}_{3} = ( {x}_{1} {x}_{2} - β {x}_{3} ) dt + {q}_{3}\end{matrix} \qquad ( 31 )$$

where x₁, x₂, and x₃ are the latent factors of the Lorenz attractor dynamics, dt denotes the discretization time-step of the continuous system and d is the change of variables in dt time. σ=10, ρ=28,

$$β = \frac{8}{3}$$

and dt=0.006 were used. q₁, 9₂, and q₃ are zero-mean Gaussian dynamic noises with variances of 0.01. 750 trials were generated, each containing 200 time-steps, and the initial condition of each trial was obtained by running the system for 500 burn-in steps starting from a random point. Then, trajectories were normalized to have zero mean and a maximum value of 1 across time for each latent dimension.

### Generating High Dimensional Observations.

To generate the Gaussian-distributed modalities, the normalized latent factors were multiplied by a random matrix C_{y}∈ [symbol] ⁿ^{_{y}}^{×3} and zero mean Gaussian noise with variance of 5 was added to generate noisy observations.

To generate the Poisson-distributed modalities, firing rates were generated by multiplying the normalized trajectories by another random matrix Cₛ∈ [symbol] ⁿ^{ₛ}^{×3} and a log baseline firing rate of 5 spikes/sec was added with bin-size of 5 ms, followed by exponentiation. Spiking activity was then generated by sampling from the Poisson process whose mean was the simulated firing rates.

For MRINE and each single-scale network trained only on Poisson or Gaussian modalities, the smoothed single-scale or multiscale latent factors x_{t|T}, t∈{1, 2, . . . , T} were obtained for each trial in the training and test sets. To quantify how well the inferred latent factors can reconstruct the true latent factors, a linear regression model was fitted from the inferred latent factors of the training set to the corresponding true latent factors. Using the same linear regression model, the true latent factors were reconstructed from the inferred latent factors of the test set. Then, the Pearson correlation coefficient (CC) was computed between the true and reconstructed latent factors for each trial and latent dimension. The reported values are averaged over trials and latent dimensions.

### Real Dataset Analysis.

### Nonhuman Primate (NHP) Dataset.

In this publicly available dataset, a macaque monkey performed a 2D target-reaching task by controlling a cursor in a 2D virtual environment. Monkey I was trained to perform continuous reaches to circular targets with a 5 mm visual radius randomly appearing on an 8-by-8 square or an 8-by-17 rectangular grid. The cursor was controlled by the monkey's fingertips, and the targets were acquired if the cursor stayed within a 7.5 mm-by-7.5 mm target acceptance zone for 450 ms. Even though there was no inter-trial interval between sequential reaches, there existed a 200 ms lockout interval after a target acquisition during which no target could be acquired. After the lockout interval, a new target was randomly drawn from the set of possible targets with replacement. Fingertip position was recorded with a six-axis electromagnetic position sensor at 250 Hz and non-causally low-pass filtered to reject the sensor noise (4th order Butterworth, with 10 Hz cut-off frequency). The cursor position was computed by a linear transformation of the fingertip position, and 2D cursor velocity was computed using discrete differentiation of the 2D cursor position in the x and y directions. In the analysis, the 2D cursor velocity was used as the behavior variable to decode.

One 96-channel silicon microelectrode array (Blackrock Microsystems) was chronically implanted into the subject's right hemisphere primary motor cortex. Each array consisted of 96 electrodes, spaced at 400 μm and covering a 4 mm-by-4 mm area. Multi-unit spiking activity obtained at a 10 ms timescale was used, and LFP signals were extracted from the raw neural signals by low-pass filtering with 300 Hz cut-off frequency, and down sampling to either 100 Hz (10 ms timescale) or 20 Hz (50 ms timescale). In the study, the top spiking and LFP channels were picked based on their individual behavior prediction accuracies and a maximum of 20 channels for each modality was considered. As this dataset consists of continuous recordings without a clear trial structure, 1-second non-overlapping segments were created from continuous recordings to form trials so that mini-batch gradient descent during model learning could be utilized.

### Behavior Decoding.

In the analysis, 2D cursor velocity was taken in the x and y directions as the behavior variables for downstream decoding. After smoothed (or filtered) multiscale (or single-scale) latent factors xₜ were inferred from MRINE or single-scale networks for both training and test sets, a linear regression model was fitted from inferred latent factors of the training set to the corresponding behavior variables. Then, the same linear regression model was used to decode the behavior variables from the inferred latent factors in the test set. The behavior decoding accuracy was quantified by computing the CC between the true and reconstructed behavior variables across time and averaging over behavior dimensions. Unless otherwise stated, all decodings were performed from smoothed latent factors.

When MRINE was trained with spiking activity and LFP signals with timescales of 10 ms and 50 ms, respectively, behavior decoding was performed at the 10 ms timescale for comparisons between MRINE and single-scale networks trained with spike channels. To provide a fair comparison between MRINE and single-scale networks trained with 50 ms LFP signals, inferred latent factors of MRINE were downsampled to 50 ms from 10 ms, and behavior was decoded at every 50 ms in these comparisons with LFP.

Behavior Decoding with Missing Samples.

In this analysis, MRINE models were first trained with 20 spike and 20 LFP channels with different timescales (whose behavior decoding accuracies are shown in FIG. 25e,f). To test the robustness of MRINE to missing samples, samples were randomly dropped in time during inference with fixed sample dropping probabilities for both modalities. Then, latent factors were inferred at all time-steps using only the available observations after sample dropping and behavior decoding was performed as described above. Note that even though time-series observations were missing in time, behavior variables were decoded at all time-steps using MRINE's inference method that accounts for missing observations with the learned local dynamics.

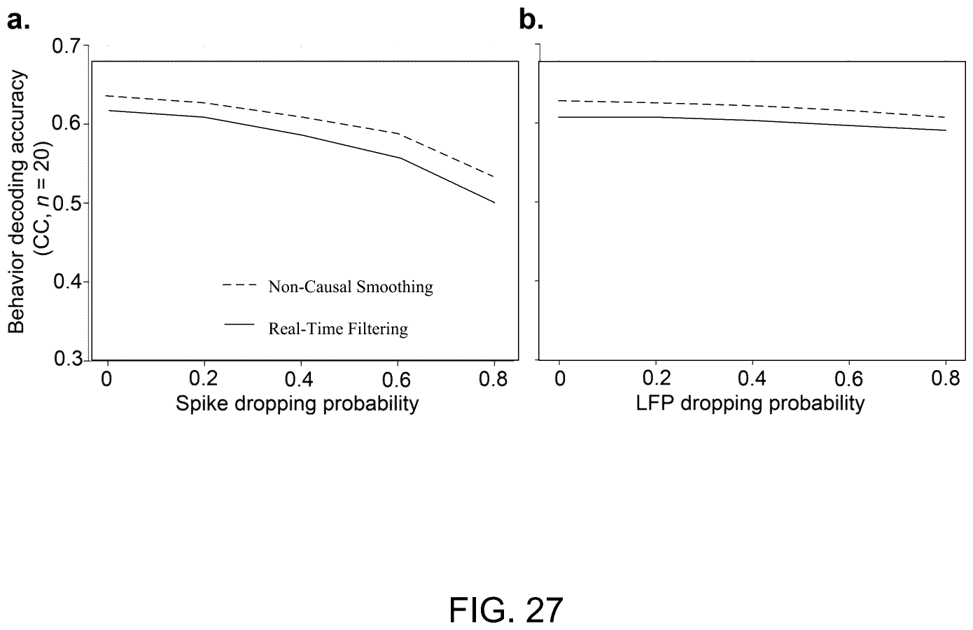

Referring now to FIG. 27, behavior decoding accuracies is illustrated for the NHP dataset when spike and LFP channels had missing samples and the same timescale, in accordance with various embodiments. FIG. 27a shows accuracies for MRINE trained with 20 spike and 20 LFP channels. Sample dropping probability of LFPs was fixed at 0.2 while that of spikes was varied as shown on the x-axis. Lines represent mean. Similar to FIG. 27a, FIG. 27b shows when sample dropping probability of spikes was fixed at 0.2 while that of LFPs was varied.

In addition to the different timescales scenario (FIG. 26) the same missing sample robustness analysis was performed for MRINE models trained with modalities of the same timescale. As shown in FIG. 27, MRINE was again robust to missing samples for both modalities. Compared to dropping 50 ms LFP samples, MRINE was more robust to missing LFP samples in this case where both LFPs and spikes had a 10 ms timescale, and thus LFPs were more abundant. Further, in general, the decoding was more robust to missing LFPs than missing spikes in this dataset (compare FIG. 27b vs. FIG. 27a), which, consistent with earlier findings, again indicates the dominance of spiking activity in behavior decoding for this dataset.

### Cross-Modal Imputation.

To evaluate MRINE's information aggregation capabilities beyond behavior decoding, cross-modal imputed one-step-ahead prediction accuracies of both modalities were computed under various sample dropping probabilities in addition to having different timescales. To do that, the modality of interest was randomly dropped when the other modality was fully observed. Therefore, the one-step-ahead predictions of the missing modality were generated by leveraging the learned modality-specific and multiscale dynamics that allow for cross-modal imputations. Unlike MRINE, one-step-ahead prediction accuracies of single-scale networks were obtained with fully available observations.

For LFP signals modeled with Gaussian likelihood, the one-step-ahead prediction accuracy was quantified by computing the CC between the one-step-ahead predicted mean of the Gaussian likelihood distribution (μ(a_{t+1|t})) and the true observations across time.

For spike signals modeled with Poisson likelihood, one-step-ahead prediction accuracy was quantified using the prediction power (PP) measure, which is defined as PP=2AUC−1 where AUC denotes the area under the curve of the receiver operating characteristic (ROC) curve. The ROC was constructed by using the one-step-ahead predicted firing rates, i.e., λ(a_{t+1|t}), as the classification scores to determine whether a time-step contained a spike or not. Both metrics were averaged over observation dimensions.

As shown in FIG. 28, MRINE outperformed single-scale networks in one-step-ahead prediction accuracy even when 60% of spike samples (FIG. 28a) and 40% of LFP samples (FIG. 28b) were missing. This result suggests that MRINE's information aggregation capabilities are not only limited to behavior decoding, but can also enable cross-modal prediction under missing sample scenarios.

Referring now to FIG. 28, cross-modal one-step-ahead prediction accuracies is illustrated for the NHP dataset when spike and LFP channels had different timescales, in accordance with various embodiments. FIG. 28a shows the one-step-ahead prediction accuracies of the spike channels. Sample dropping probability of spikes was varied as shown on the x-axis while LFP channels were fully available. The yellow dashed line represents the single-scale network's performance with fully available spike channels. Lines represent mean. Similar to FIG. 28a, FIG. 28b shows when sample dropping probability of LFPs was varied while spike channels were fully available.

### Visualizations of Latent Dynamics.

To compute trial-averaged 3D PCA visualizations, for each algorithm, 3D PCA projections of latent factors were computed, split based on trial start and end indices, interpolated to a fixed length (due to variable-length trials), and their trial averages for each of 8 different reach directions were obtained. As expected, all models recovered rotational neural population dynamics. Among all algorithms, MRINE had the most clear rotations.

### Effect of Time-Dropout.

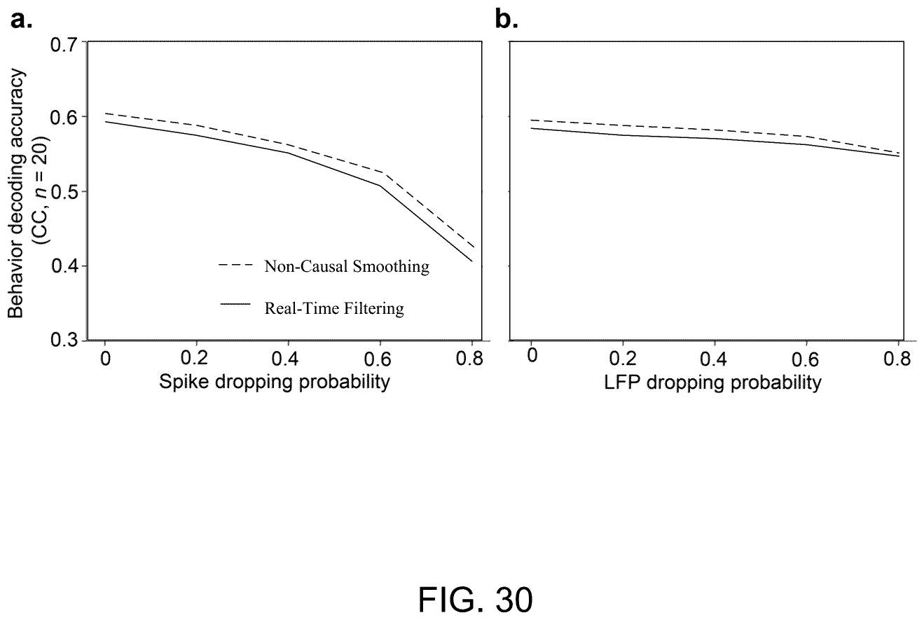

To test the effectiveness of time-dropout, an ablation study was performed with the same setting used to generate FIG. 26 but the time-dropout (ρₜ=0) was disabled. The remaining hyperparameters were as in Table 5. As shown in FIG. 30a without time-dropout, the behavior decoding accuracies of MRINE decreased by 6.3% and 28.9% when 40% and 80% of spike samples were missing (in addition to 20% of LFP samples missing), whereas MRINE models trained with time-dropout experienced smaller performance drops of 4.3% and 17% in the same missing sample settings (see FIG. 26). Similarly, MRINE models trained with time-dropout were more robust to missing LFP samples (FIG. 30b vs. FIG. 26b). In this case, the performance drops were smaller due to spiking activity being the dominant modality for behavior decoding in this dataset. As expected, the effect of time-dropout was more prominent in the high sample dropping probability regimes (i.e., more missing samples).

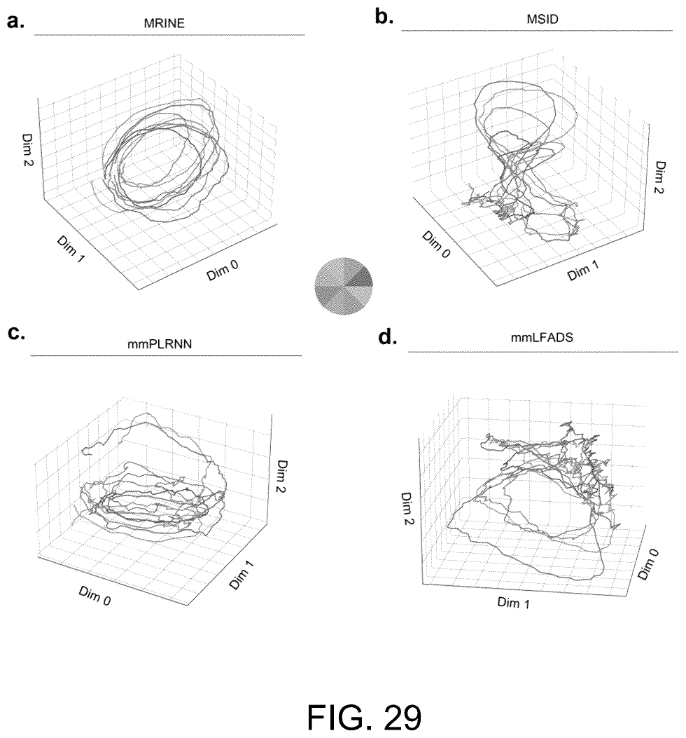

Referring now to FIG. 29, 3D PCA visualizations of trial-averaged latent factors inferred by a) MRINE (FIG. 29a), b) MSID (FIG. 29b), c) mmPLRNN (FIG. 29c), and d) mmLFADS (FIG. 29d) are illustrated, in accordance with various embodiments.

Referring now to FIG. 30, Behavior decoding accuracies in the NHP dataset are illustrated when time-dropout was disabled (ρₜ=0) and spike and LFP channels had both missing samples and different timescales. The figure conventions are the same as in FIG. 26.

### Effect of Loss Terms in the Behavior Decoding Performance.

To gain intuition on the improved performance with MRINE, an ablation study was performed on the effect of smoothness regularization terms in equation (23) and smoothed reconstruction term in equation (22) on behavior decoding performance. To achieve that, MRINE models were trained with 20 channels of 10 ms spike and 20 channels of 10 ms LFP signals by removing equation (22) and individual terms in equation (23) from the training objective in equation (25). Then, behavior decoding was performed with these MRINE models.

As shown in Table 6, both smoothness regularization terms in equation (23) and smoothed reconstruction term in equation (22) are important factors contributing to improved behavior decoding. It was observed that applying smoothness regularization on xₜ is an important contributing factor to improved performance (row 3 vs row 5) as well as smoothing reconstruction term (row 2 vs row 3). Also, smoothness regularizations on sₜ and yₜ play a crucial role when combined with smoothness regularization on xₜ (comparing row 1 and row 5).

TABLE 6

| | Behavior |
|---|---|
| | Decoding |
| Model | (CC) |
| MRINE | 0.621 ± 0.010 |
| MRINE w/o | 0.524 ± 0.013 |
| Eq. 22 and Eq. 23 | |
| MRINE w/o | 0.565 ± 0.012 |
| Eq. 23 | |
| MRINE w/o | 0.566 ± 0.016 |
| xₜ in Eq. 23 | |
| MRINE w/o | 0.598 ± 0.012 |
| sₜ and yₜ in Eq. 23 | |

Behavior decoding accuracies for the NHP dataset with 20 channels of 10 ms spike and 20 channels of 10 ms LFP signals for MRINE models trained without (w/o) loss terms denoted in the first column.
The best-performing method is in bold, ± represents SEM.
Eq. is abbreviation for equation.

### Effect of Using Different Observation Models.

While designing models of multimodal neural activity, a natural design choice is to treat modalities with different statistical properties as a single modality with the same observation model, e.g., modeling spikes with Gaussian likelihood as LFPs. Even though this modeling approach would not be effective when modalities are recorded with different timescales due to requiring imputation for missing time-steps, it would allow the training of unimodal models of neural activity on multimodal neural signals when recorded with the same timescale.

To test the effect of treating each modality with their corresponding observation models, MRINE models were trained with 20 channels of spike and LFP signals sampled at 10 ms resolution where spikes were modeled with Gaussian or Poisson observation models, as done for LFADS and mmLFADS results in Table 2.

TABLE 7

| | Behavior |
|---|---|
| | Decoding |
| Model | (CC) |
| MRINE | 0.621 ± 0.010 |
| MRINE w/Same | 0.606 ± 0.009 |
| Observation Model | |
| LFADS | 0.548 ± 0.011 |
| mmLFADS | 0.547 ± 0.011 |

Behavior decoding accuracies for the NHP dataset with 20 channels of 10 ms spike and 20 channels of 10 ms LFP signals for MRINE and LFADS models trained with same and different observation models.
The best-performing method is in bold, ± represents SEM.

As shown in Table 7, MRINE models trained with different observation models, i.e., Poisson and Gaussian observation models for spikes and LFPs, respectively, outperforms MRINE models trained with Gaussian observation model. It was observed that LEADS performance does not improve with mmLFADS when spiking activity is treated with a separate Poisson observation model, unlike MRINE. However, the performance gap between MRINE models trained with different and same observation models indicate that treating the modalities with appropriate observation models can indeed improve performance in MRINE.

### Effect of Multiscale Encoder Design.

As discussed previously herein, accounting for different sampling rates for neural signals is an important consideration for MRINE's encoder design shown in FIG. 23. To achieve that, modality-specific LDMs were learned in MRINE's encoder that can leverage within-modality state dynamics to account for missing samples whether due to timescale differences or missed measurements. Therefore, MRINE can perform inference without relying on augmentations to impute missing samples, such as zero-imputation as done in common practice that can yield suboptimal performance.

To investigate this, 50 ms LFP signals were upsampled to 10 ms with zero-imputation (note that zero-imputation translates to mean-imputation since LFP signals are z-scored before training) and MRINE, mmPLRNN and mmLFADS models were trained with 20 channels of 10 ms spike and 10 ms zero-imputed LFP signals. For all models, 2 versions were trained where reconstructions/predictions of zero-imputed LFP time-steps are either included ( [symbol] ′= [symbol] ) or masked ( [symbol] ′⊂ [symbol] ) in the training objective. For both versions of MRINE, zero-imputed LFP time-steps were not treated as missing samples during latent factor inference (even if they were masked in the training objective for the second version).

TABLE 8

| | Behavior |
|---|---|
| | Decoding |
| Model | (CC) |
| MRINE | 0.611 ± 0.012 |
| MRINE w/Zero Imputation | 0.523 ± 0.013 |
| MRINE w/Zero Imputation | 0.581 ± 0.014 |
| and Loss Masking | |
| mmPLRNN w/Zero Imputation | 0.498 ± 0.009 |
| mmPLRNN w/Zero Imputation | 0.539 ± 0.011 |
| and Loss Masking | |
| mmLFADS w/Zero Imputation | 0.280 ± 0.022 |
| mmLFADS w/Zero Imputation | 0.253 ± 0.023 |
| and Loss Masking | |

Behavior decoding accuracies for the NHP dataset with 20 channels of 10 ms spike and 20 channels of 10 ms zero-imputed LFP signals for MRINE, mmPLRNN, and mmLFADS where zero- imputed LFP time-steps are either included or masked in the training objective.
The best-performing method is in bold, ± represents SEM.

As shown in Table 8, the performance of MRINE models trained with zero-imputed LFP signals degraded compared to MRINE models trained with 50 ms LFP signals (row 1 vs rows 2 and 3). As expected, in MRINE, masking zero-imputed LFP time-steps in the loss function improved behavior decoding performance compared to the scenario where they are included in the loss function (row 2 vs row 3). Overall, MRINE with all the developed elements herein had the highest performance (row 1), showing the importance of MRINE's multiscale encoder design.

Even though the performance of mmPLRNN improved when zero-imputed LFP time-steps were masked in the training objective (row 4 vs row 5), mmLFADS performance did not show a similar improvement. This is likely caused by mmLFADS' inference procedure that requires summarization of the input signal into an initial condition for the generator network. In contrast, MRINE does not require such a summarization process. Overall, these results show the importance of MRINE's encoder design when modeling modalities with different timescales.

System and Methods for Nonlinear Inference/Decoding of Latent Factors and/or Behavior from Brain Signals.

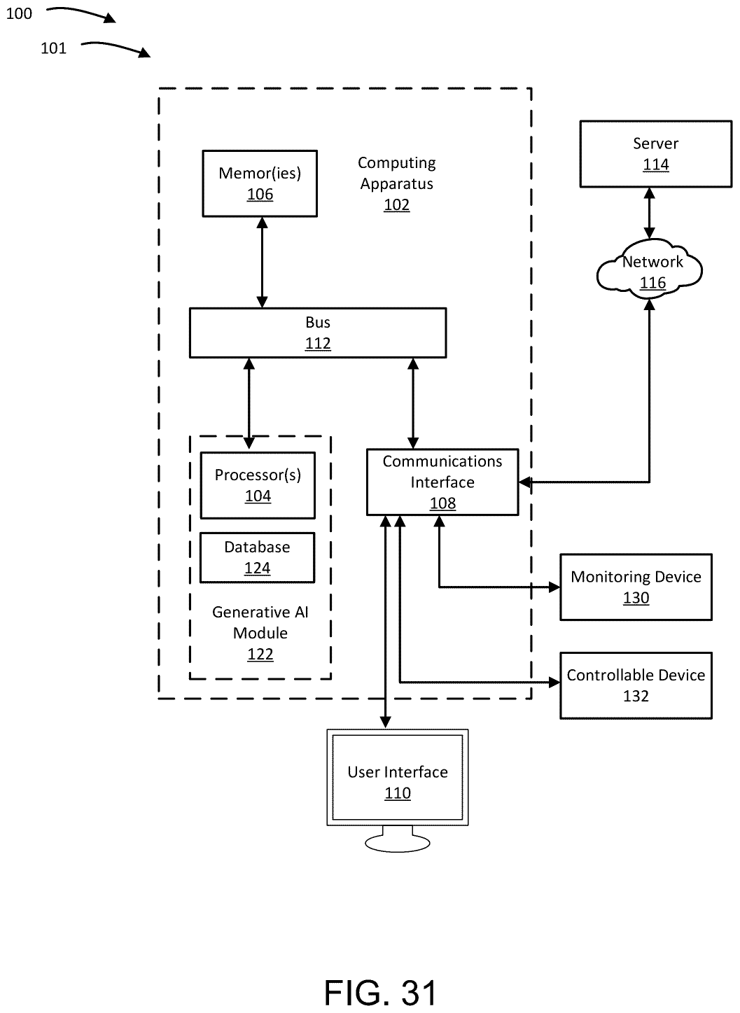

Referring now to FIG. 31, a system 100 for at least one of nonlinear flexible inference of latent factors and flexible decoding of behavior from brain signals is disclosed herein. The system 100 (e.g., a computing system) may include a computing apparatus 102. The computing apparatus 102 may include one or more processors 104, one or more memories 106 and/or one or more buses 112 and/or other mechanisms for communicating between the one or more processors 104. The system 100 may be a cloud computing system including processors, servers, storage, databases, networking, software, analytics, and/or intelligence accessed or performed over or using the Internet (“the cloud”). The one or more processors 104 may be implemented as a single processor or as multiple processors. The one or more processors 104 may execute instructions stored in the one or more memories 106 to implement the applications and/or detection of the system 100.

The one or more processors 104 may be coupled to the one or more memories 106. The one or more memories 106 may include one or more of a Random Access Memory (RAM) or other volatile or non-volatile memory. The one or more memories 106 may be a non-transitory memory or a data storage device, such as a hard disk drive, a solid-state disk drive, a hybrid disk drive, or other appropriate data storage, and may further store machine-readable instructions, which may be loaded and executed by the one or more processors 104.

The one or more memories 106 may include one or more of random-access memory (“RAM”), static memory, cache, flash memory and any other suitable type of storage device or computer readable storage medium, which is used for storing instructions to be executed by the one or more processors 104. The storage device or the computer readable storage medium may be a read only memory (“ROM”), flash memory, and/or memory card, that may be coupled to a bus 112 or other communication mechanism. The storage device may be a mass storage device, such as a magnetic disk, optical disk, and/or flash disk that may be directly or indirectly, temporarily, or semi-permanently coupled to the bus 112 or other communication mechanism and be electrically coupled to some or all the other components within the system 100 including the one or more memories 106, a user interface 110 and/or the communications interface 108 via the bus 112.

The term “computer-readable medium” is used to define any medium that can store and provide instructions and other data to a processor, particularly where the instructions are to be executed by a processor and/or other peripheral of the processing system. Such medium can include non-volatile storage, volatile storage, and transmission media. Non-volatile storage may be embodied on media such as optical or magnetic disks. Storage may be provided locally and in physical proximity to a processor or remotely, typically by use of network connection. Non-volatile storage may be removable from computing system, as in storage or memory cards or sticks that can be easily connected or disconnected from a computer using a standard interface.

The system 100 may include a user interface 110. The user interface 110 may include a wireless input/output device (e.g., Bluetooth®, Wi-Fi, or any other wireless connection). The input/output device may receive user input, such as a user interface element, hand-held controller that provides tactile/proprioceptive feedback, a button, a dial, a microphone, a keyboard, or a touch screen, and/or provides output, such as a display, a speaker, an audio and/or visual indicator, or a refreshable braille display. The display may be a computer display, a tablet display, a mobile phone display, an augmented reality display or a virtual reality headset. The display may output or provide latent factors and/or behavior that are inferred and decoded from brain signals.

The user interface 110 may include an input/output device that receives user input, such as a user interface element, a button, a dial, a microphone, a keyboard, or a touch screen, and/or provides output, such as a display, a speaker, headphones, an audio and/or visual indicator, a device that provides tactile/proprioceptive feedback or a refreshable braille display. The speaker may be used to output audio associated with the audio conference and/or the video conference. The user interface 110 may receive user input that may include configuration settings for one or more user preferences, such as a selection of joining an audio conference or a video conference when both options are available, for example.

The system 100 may have a network 116 connected to a server 114. The network 116 may be a local area network (LAN), a wide area network (WAN), a cellular network, the Internet, or combination thereof, that connects, couples and/or otherwise communicates between the various components of the system 100 with the server 114. The server 114 may be a remote computing device or system that includes a memory, a processor and/or a network access device coupled together via a bus. The server 114 may be a computer in a network that is used to provide services, such as accessing files or sharing peripherals, to other computers in the network.

The system 100 may include a communications interface 108, such as a network access device. The communications interface 108 may include a communication port or channel, such as one or more of a Dedicated Short-Range Communication (DSRC) unit, a Wi-Fi unit, a Bluetooth® unit, a radio frequency identification (RFID) tag or reader, or a cellular network unit for accessing a cellular network (such as 3G, 4G or 5G). The communication interface may transmit data to and receive data from the different components.

The server 114 may include a database. A database is any collection of pieces of information that is organized for search and retrieval, such as by a computer, and the database may be organized in tables, schemas, queries, reports, or any other data structures. A database may use any number of database management systems. The information may include real-time information, periodically updated information, or user-inputted information.

In various embodiments, the computing apparatus 102 can include a generative artificial intelligence (“AI”) module 122. The generative AI module 122 can include the one or more processors 104. Stated another way, the generative AI module 122 can be run, or operated by the one or more processors 104. In various embodiments, the generative AI module 122 can perform the steps of the methods claimed herein and output or provide latent factors inferred from the brain signals and/or behavior decoded from brain signals to the user interface 110.

In various embodiments, the generative AI module 122 is configured to infer latent factors and/or decode behavior from brain signals from a database 124 as described further herein. In this regard, the generative AI module 122 is configured to update a generative AI model (e.g., a trained neural network, such as DFINE or MRINE) based on the brain signals and data received from the database 124. In various embodiments, the generative AI module 122, as described previously herein can include the methods described herein (e.g., DFINE, MRINE, or any other method described herein).

In various embodiments, the system 100 further comprises a monitoring device 130 (e.g., an implantable device or a wearable device). In various embodiments, the monitoring device 130 is configured to detect brain signals in real-time from a user. In various embodiments, the monitoring device 130 is configured to detect at least one of brain signals and behavioral signals from a user. In various embodiments, the device 130 is configured to communicate with the computing apparatus (e.g., via a transmitter, a transceiver, or a direct connection). In various embodiments, the system 100 can comprise a brain-computer interface. The brain-computer interface 101 can comprise the computing apparatus 102, the device 130, and a controllable device 132. In this regard, the computing apparatus 102 of brain-computer interface 101 can be configured to receive a plurality of brain signals from the monitoring device 130, infer latent factors and/or decode behavior from the plurality of brain signals, and based on the decoding command a controllable device 132 (e.g., remote-controlled device or external device such as a prosthetic limb, a robot, a computer, a phone, a tablet, or a digital interface).

In various embodiments, the computing apparatus 102 is a decoding device that is in wireless communication with the monitoring device 130. In this regard, the decoding device can perform the methods described herein (e.g., DFINE, MRINE, or any other method described herein) based on wirelessly receiving a plurality of brain signals from the monitoring device 130. Stated another way, the methods disclosed herein facilitate the capability of decoding a plurality of brain signals that are received wirelessly even if the plurality of brain signals are missing brain signal samples at random time-steps or over a period of time or if the connection becomes disrupted for brief periods of time, in accordance with various embodiments.

In various embodiments, the computing apparatus 102 is a decoding device that is in communication with the monitoring device 130. In this regard, the decoding device can perform the methods described herein (e.g., DFINE, MRINE, or any other method described herein) based on receiving a plurality of brain signals. In some embodiments, some samples of the plurality of brain signals communicated to the computing apparatus 102 may be dropped/missing at random time-steps or over a period of time due to any failure in the monitoring device 130 or due to any communication disruption between the monitoring device 130 and computing apparatus 102. Stated another way, the methods disclosed herein (e.g., DFINE, MRINE, or any other method described herein) facilitate the capability of decoding a plurality of brain signals that are received even if the plurality of brain signals are missing brain signal samples at random time-steps or over a period of time due to any device failure or due to any communication disruption, in accordance with various embodiments.

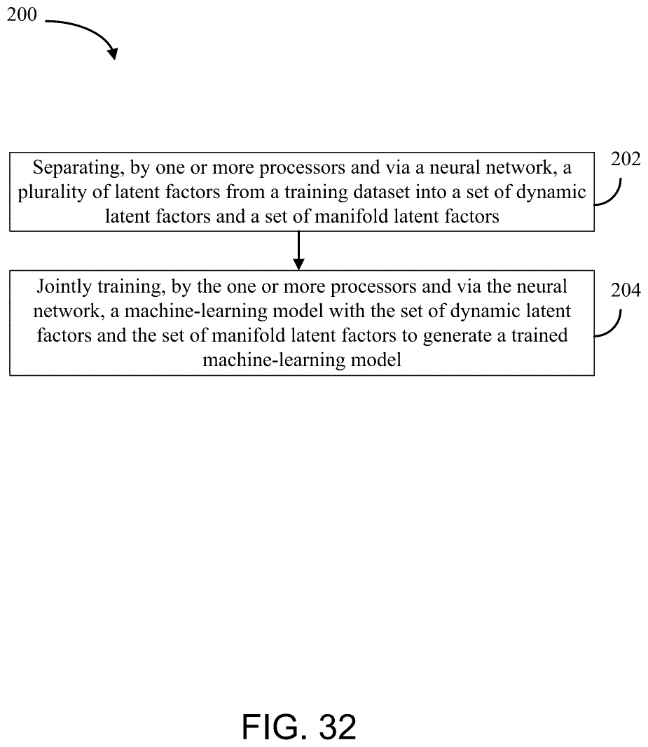

Referring now to FIG. 32, a method 200 for training a neural network to form a trained machine learning model (e.g., a trained neural network) is illustrated, in accordance with various embodiments. The method 200 can be a sub-step in a method for at least one of inferring spatiotemporal dynamics in a plurality of brain signals or decoding behavior from a plurality of brain signals or inferring latent factors from a plurality of brain signals, in accordance with various embodiments.

The method 200 can comprise separating, by one or more processors (e.g., the one or more processors 104 from FIG. 31) and via a neural network, a plurality of latent factors from a training dataset into a set of dynamic latent factors and a set of manifold latent factors (step 202). In various embodiments, the training dataset comprising at least one of a plurality of training brain signals and a plurality of training behavior signals. In various embodiments, the training dataset comprises both the plurality of training brain signals and the plurality of training behavior signals. In various embodiments, the training dataset only comprises the plurality of training brain signals.

The method 200 further comprises jointly training, by the one or more processors and via the neural network, a machine-learning model with the set of dynamic latent factors and the set of manifold latent factors to generate a trained machine-learning model (step 204). In this regard, the trained machine learning model can then be utilized for performing at least one of flexible inference and flexible decoding. In various embodiments, the trained machine learning model can be installed onto another computer-readable medium (e.g., a brain-computer interface or any other device that may be readily apparent to one skilled in the art). In various embodiments, the trained machine learning model can remain on the one or more processors that it was trained on. The present disclosure is not limited in this regard.

In various embodiments, the jointly training the machine learning model in step 204 further comprises predicting, by the one or more processors, at least one of a plurality of current or future brain signals and a plurality of current or future behavior signals, at least at one of a current time-step or time-steps in a future time period. In various embodiments, the jointly training in step 204 further comprises relating, by the one or more processors and via a nonlinear embedding, the set of manifold latent factors to the plurality of training brain signals in the training dataset. In various embodiments, the nonlinear embedding is an autoencoder. In various embodiments, the autoencoder includes an encoder and a decoder, which each are optionally a multi-layer perceptron (MLP). In various embodiments, the jointly training in step 204 further comprises relating, by the one or more processors and via a mapper neural network, the set of manifold latent factors to a plurality of training behavior signals. In various embodiments, the mapper neural network is a multi-layer perceptron (MLP).

In various embodiments, the plurality of training brain signals are multimodal brain signals. In various embodiments, the jointly training in step 204 further comprises modeling the set of dynamic latent factors in time with a linear Gaussian model. In various embodiments, the jointly training in step 204 further comprises modeling the training dataset as at least one of a Gaussian, generalized linear, exponential family, Poisson or Point process distributions to generate the trained machine-learning model. In various embodiments, the jointly training in step 204 further comprises modeling, via the neural network, the multimodal brain signals by a combination of different probability distributions to generate the trained machine-learning model. In various embodiments, the jointly training in step 204 further comprises optimizing a learning cost function to learn model parameters of the nonlinear neural network. In various embodiments, the learning cost function includes a future-step-ahead prediction of at least one of the plurality of brain signals. In various embodiments, the learning cost function is supervised with the plurality of training behavior signals and includes a behavior-relevant term so that the plurality of training behavior signals is more accurately decoded relative to decoding without including the behavior-relevant term in the learning cost function. In various embodiments, the learning cost function includes a mix of predictions of at least one of the plurality of brain signals and at least one of the plurality of behavior signals, at least at one of a current time-step or future time-steps. In various embodiments, the learning cost function includes predictions of at least one of the plurality of training brain signals or the plurality of training behavior signals, at least at one of a current time-step or future time-steps. In various embodiments, the learning cost function has regularization terms including at least one of norm regularization on the model parameters/weights, smoothness regularization on decoder outputs, smoothness regularization on the latent factors, dropout in time to imitate a missing sample scenario, and dropout. In various embodiments, the learning cost function includes a log-likelihood of brain signal distributions at least at one of a current time-step or future time-steps, wherein the log-likelihood of brain signal distributions is at least one of Gaussian, generalized linear, exponential family, Poisson, or Point Process. In various embodiments, other elements are included in the learning cost function, optionally including variational elements.

In various embodiments, during the jointly training the machine-learning model in step 204, data inputs are given to at least one of the set of dynamic latent factors or the set of manifold latent factors, and wherein the data inputs are optionally sensory inputs or neurostimulation inputs such as deep brain stimulation (DBS). In various embodiments, the jointly training in step 204 further comprises fusing together two or more modalities of the multimodal brain signals by passing them through a multiscale encoder to obtain an initial estimate of multiscale embedding factors, wherein the initial estimate of multiscale embedding factors become observations of multiscale latent factors within a multiscale linear dynamical model (LDM).

In various embodiments, the jointly training the machine-learning model in step 204 further comprises fusing together two or more modalities of the multimodal brain signals in a multiscale encoder by passing each modality through a separate neural-network to obtain modality-specific embedding factors which become observations of modality-specific latent factors within modality-specific linear dynamical models (LDM), inferring these modality-specific latent factors with flexible inference, concatenating the modality-specific embedding factors that were previously inferred, and then passing a concatenated inferred modality-specific embedding factors through a final neural-network to get the multiscale embedding factors, wherein the separate neural-networks and the final neural-network each optionally include a multi-layer perceptron (MLP). In various embodiments, the multiscale latent factors that were previously inferred are passed to decoder networks that predict log-likelihood parameters of multiple modalities of the multimodal brain signals.

In various embodiments, the trained machine-learning model is configured to capture, by separating the plurality of latent factors into the set of dynamic latent factors and the set of manifold latent factors, nonlinearity with a link between the set of manifold latent factors and the plurality of training brain signals in the training dataset, while keeping dynamics on the set of manifold latent factors one of linear, locally linear, or piece-wise linear. In various embodiments, the set of manifold latent factors are observations of the set of dynamic latent factors. In various embodiments, a recursion of the set of dynamic latent factors in time is one of linear, locally linear, or piece-wise linear.

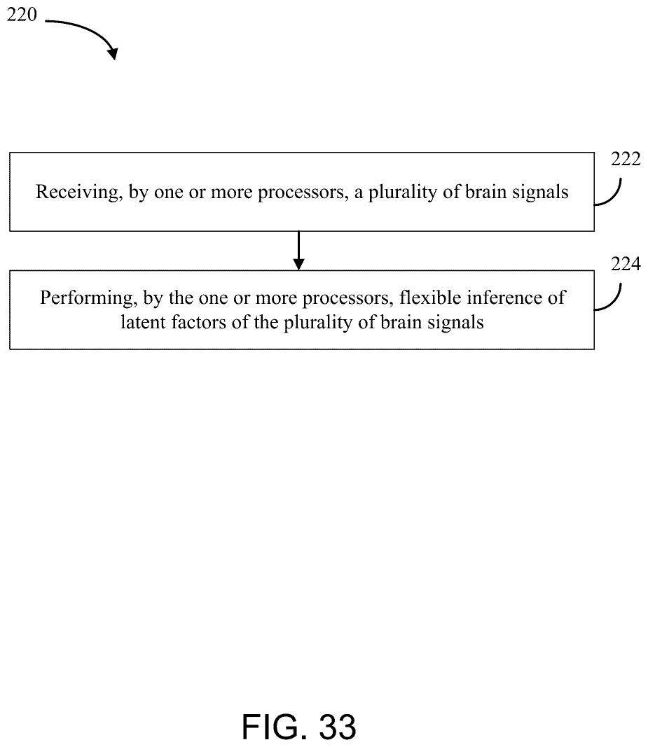

Referring now to FIG. 33, a method 220 for utilizing the trained machine learning model from method 200 in FIG. 32 is illustrated, in accordance with various embodiments. The method 220 can be a sub-step in a method for at least one of inferring spatiotemporal dynamics in a plurality of brain signals or decoding behavior from a plurality of brain signals or inferring latent factors from a plurality of brain signals, in accordance with various embodiments.

In various embodiments, the method 220 comprises receiving, by one or more processors, a plurality of brain signals (step 222) and performing, by the one or more processors, flexible inference of latent factors of the plurality of brain signals (step 224). In various embodiments, the receiving the plurality of brain signals in step 222 is continuous. In various embodiments, the receiving the plurality of brain signals is simultaneous (e.g., all at once). The present disclosure is not limited in this regard. In various embodiments, the plurality of brain signals in step 222 are discrete brain signals, continuous brain signals, or a mixture of discrete and continuous brain signals.

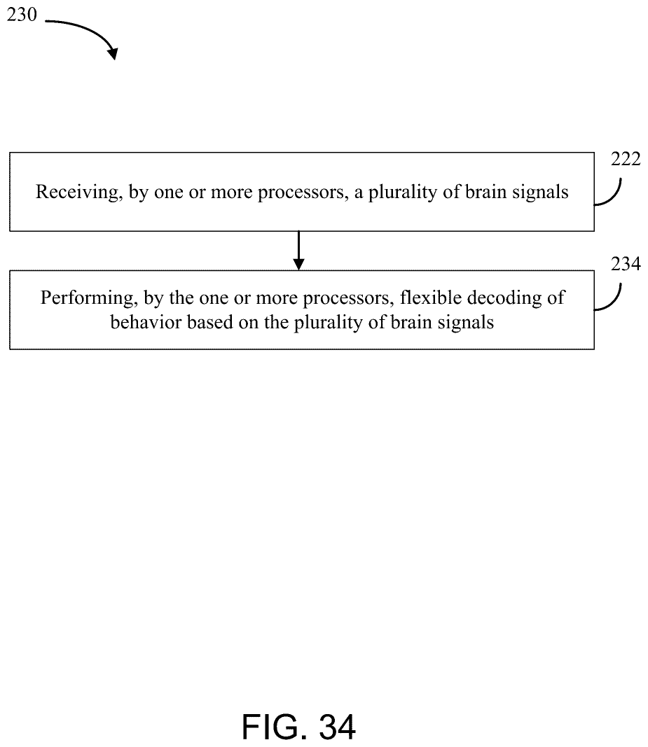

In various embodiments, each of the steps referred to herein regarding step 204 for jointly training the model in method 200 from FIG. 32 can be steps in performing the flexible inference in step 224 of method 220 or performing the flexible decoding in step 234 of method 230 as described further herein. Similarly, each of the steps referred to herein regarding step 224 of method 220 from FIG. 33 or regarding step 234 of method 230 from FIG. 34 as described further herein can be performed in the jointly training the model step (i.e., step 204) from method 200 in FIG. 32. The present disclosure is not limited in this regard.

In various embodiments, prior to the performing the flexible inference, the one or more processors receive a selection to perform the flexible inference via one of causal inference or non-causal inference. In various embodiments, the flexible inference is performed despite one or more missing samples at any time-step of at least one of the plurality of brain signals. In various embodiments, the performing the flexible inference is recursively done, and current time-step's inference is used for next time-step's inference recursively.

In various embodiments, the flexible inference of latent factors comprises a causal inference of latent factors that includes obtaining an initial estimate of the manifold latent factors from the nonlinear embedding and then using them to infer the dynamic latent factors and the manifold latent factors using a Kalman filter. In various embodiments, the flexible inference of latent factors comprises a non-causal inference of latent factors that includes obtaining an initial estimate of the manifold latent factors from the nonlinear embedding and then using them to infer the dynamic latent factors and the manifold latent factors using a Kalman smoother. In various embodiments, the flexible inference of latent factors at time-steps when there are missing brain signal samples from the plurality of brain signals includes inferring the dynamic latent factors and the manifold latent factors using a Kalman predictor based on the dynamic latent factors in previous time-steps.

In various embodiments, at least one of the multiscale latent factors or the multiscale embedding factors are inferred using the flexible inference, wherein the flexible inference comprises at least one of a causal inference or a non-causal inference. In various embodiments, the causal inference includes computing the multiscale latent factors based on the initial estimate of multiscale embedding factors using Kalman filtering. In various embodiments, the non-causal inference includes computing the multiscale latent factors based on the initial estimate of multiscale embedding factors using Kalman smoothing. In various embodiments, the flexible inference includes causal inference, which includes getting modality-specific latent factors based on the modality-specific embedding factors using Kalman filtering.

In various embodiments, prior to the receiving step (i.e., step 222 in method 220), the method 220 can further comprise receiving a selection for a selected mode of operation, the selected mode of operation including one of a causal inference mode of operation; a non-causal inference mode of operation; a missing samples inference mode of operation; a causal inference mode of operation and the missing samples inference mode of operation; the non-causal inference mode of operation and the missing samples inference mode of operation. In this regard, responsive to the receiving the selection, performing the flexible inference of latent factors of the plurality of brain signals in step 224 is performed in the selected mode of operation.

In various embodiments, the operations performed during the jointly training in FIG. 32 are also performed during the inference of the latent factors in FIG. 33. In various embodiments, fusing together two or more modalities of the multimodal brain signals by passing them through a multiscale encoder as done in FIG. 32 are also done after the jointly training in FIG. 33 using the trained multiscale encoder to perform the flexible inference of latent factors. In various embodiments, the methods and steps performed during the flexible inference of latent factors in FIG. 33 are also utilized during the jointly training in FIG. 32.

Referring now to FIG. 34, a method 230 for utilizing the trained machine learning model from method 200 in FIG. 32 is illustrated, in accordance with various embodiments. The method 220 can be a sub-step in a method for at least one of inferring spatiotemporal dynamics in a plurality of brain signals or decoding behavior from a plurality of brain signals or inferring latent factors from a plurality of brain signals, in accordance with various embodiments.

In various embodiments, the method 230 comprises the receiving, by one or more processors, a plurality of brain signals from step 222 in method 220 and performing, by the one or more processors, flexible decoding of behavior based on the plurality of brain signals (step 234). In various embodiments, the performing the flexible decoding of behavior further comprises decoding, by the one or more processors and via the nonlinear embedding, the plurality of brain signals from the set of manifold latent factors. In various embodiments, behavior is decoded from the plurality of brain signals based on at least one of the manifold latent factors or the dynamic latent factors. In various embodiments, behavior is decoded from the at least one of the dynamic latent factors or the manifold latent factors by passing these factors through at least one of a linear matrix multiplication, a neural-network, or a multi-layer perceptron that are trained based on the plurality of brain signals and a plurality of training behavior signals in a training dataset. In various embodiments, the trained neural network further comprises a mapper neural network configured to relate the manifold latent factors to behavior signals. In various embodiments, the mapper neural network is a multi-layer perceptron (MLP).

In various embodiments, the behavior is decoded based on at least one of the multiscale latent factors or the multiscale embedding factors that were previously inferred. In various embodiments, the behavior is decoded from the at least one of the multiscale latent factors or the multiscale embedding factors, which were previously inferred, by passing these factors through at least one of a linear matrix multiplication or a neural-network or a multi-layer perceptron that are trained based on the multimodal brain signals and behavior signals in the training dataset.

In various embodiments, prior to the receiving the plurality of brain signals in step 222 of method 230, the method 230 can further comprise receiving a selection for a selected mode of operation, the selected mode of operation including one of: a causal decoding mode of operation; a non-causal decoding mode of operation; a missing samples decoding mode of operation; a causal decoding mode of operation and the missing samples decoding mode of operation; a non-causal decoding mode of operation and the missing samples decoding mode of operation. In this regard, responsive to the receiving the selection, the method 230 performs the flexible decoding of behavior based on the plurality of brain signals in the selected mode of operation.

In various embodiments, the operations performed during the jointly training in FIG. 32 are also performed during the decoding of behavior in FIG. 34. In various embodiments, the methods and steps performed during the decoding of behavior in FIG. 34 are also utilized during the jointly training in FIG. 32.

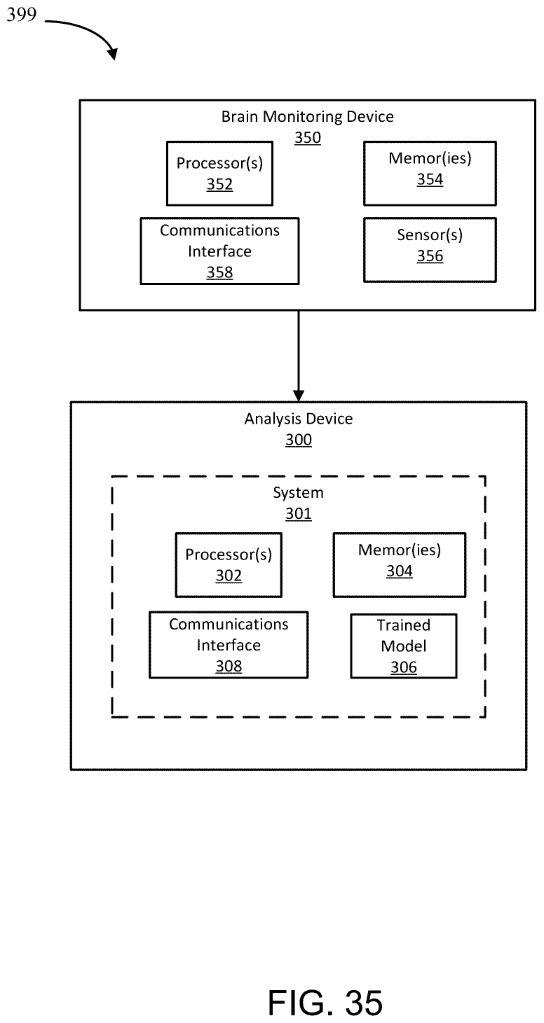

Referring now to FIG. 35, a system 399 for modeling a plurality of brain signals is illustrated, in accordance with various embodiments. The system 399 comprises a brain monitoring device 350 and an analysis device 300. In various embodiments, the brain monitoring device 350 comprises one of an implantable device (e.g., configured to be implanted in a brain of a user) or a wearable device (e.g., a device configured to be worn by a user, such as on a user's head).

The brain monitoring device 350 comprises one or more processors 352, one or more memories 354, one or more sensors 356, and a communications interface 358. In various embodiments, the analysis device comprises one or more processors 302, one or more memories 304 having a trained model 306 stored therein, and a communications interface 308. In various embodiments, the communications interface 308 and the communications interface 358 are configured to be electronically coupled (e.g., wirelessly or wired). For example, the communications interface 358 can comprise a transmitter (or a transceiver) and the communications interface 308 can comprise a receiver (or a transceiver), in accordance with various embodiments. In various embodiments, the communications interface 358 and the communications interface 308 can be physically coupled together via a wired connection. The present disclosure is not limited in this regard.

The one or more sensors 356 can comprise any device capable of detecting a plurality of brain signals. For example, the one or more sensors 356 can comprise electrodes (e.g., used in electroencephalograms (EEGs), intracranial electrodes, intracortical electrodes, intracranial EEG electrodes, multielectrode arrays, stereo EEG electrodes), magnetoencephalogram (MEG) or magnetometers (e.g., used to measure magnetic flux signals caused by brain activity), optical imaging sensors, ultrasound sensors, quantum sensors, or any other sensor that may be readily apparent to one skilled in the art. In this regard, the brain monitoring device 350 is configured to detect a plurality of brain signals and transmit the plurality of brain signals to the analysis device 300 (e.g., via the communications interface 358). In various embodiments, the system 399 can be configured to transmit the plurality of brain signals in real-time. However, the present disclosure is not limited in this regard. For example, the brain monitoring device 350 can be configured to store the plurality of brain signals detected via the one or more sensors (e.g., within the one or more memories 354) and transmit the plurality of brain signals at a later time period (e.g., after a set quantity of the plurality of brain signals is obtained).

In various embodiments, the trained model 306 in system 301 is stored in the one or more memories 304, a database, or any other storage medium that may be readily apparent to one skilled in the art. In various embodiments, the trained model 306 was trained on the system 301. In various embodiments, the trained model 306 was trained on another system and loaded onto the system 301. The present disclosure is not limited in this regard.

In various embodiments, the trained model 306 comprises a trained neural network configured to perform at least one of: flexible inference of latent factors (e.g., method 220 from FIG. 33), wherein the flexible inference of latent factors is performable in a causal inference mode of operation and a non-causal inference mode of operation, and flexible decoding of behavior (e.g., method 230 from FIG. 34), wherein the flexible decoding of behavior is performable in a causal decoding mode of operation and a non-causal decoding mode of operation. In this regard, the one or more processors 302 are in operable communication with the trained neural network and is configured to: receive a plurality of brain signals (e.g., from the brain monitoring device 350); and perform, via the trained neural network, at least one of: the flexible inference of latent factors of the plurality of brain signals in at least one of the causal inference mode of operation or the non-causal inference mode of operation; and the flexible decoding of behavior based on the plurality of brain signals in at least one of the causal decoding mode of operation or the non-causal decoding mode of operation.

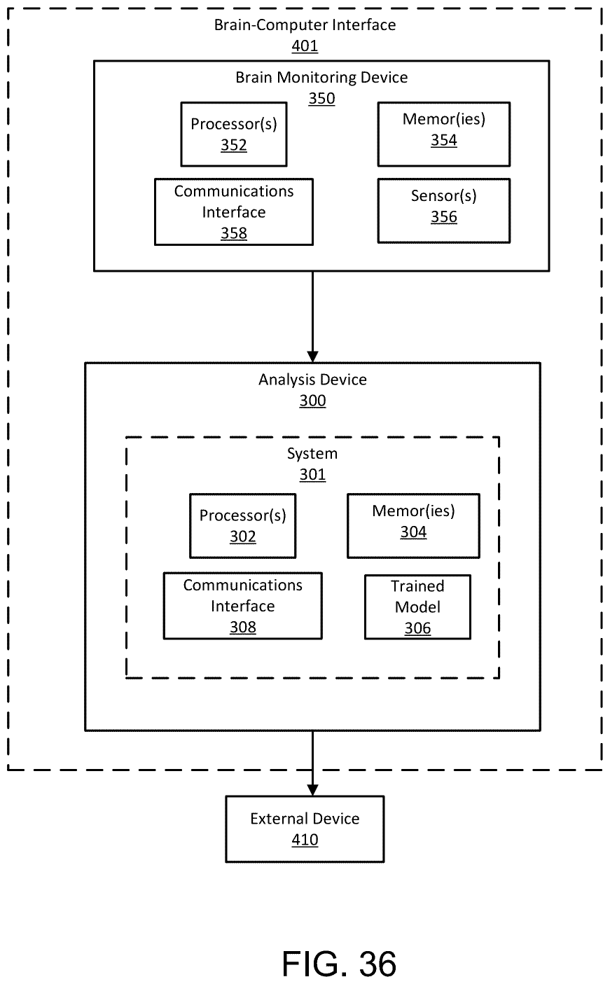

Referring now to FIG. 36, a schematic view of a brain-computer interface 401 is illustrated, in accordance with various embodiments. In various embodiments, the brain-computer interface 401 includes the brain monitoring device 350 and the analysis device 300. In various embodiments, the system 301 of the analysis device 300 is a control system. In this regard, the one or more processors 302 in system 301 can be configured to perform the methods described previously herein, and to further perform operations that include controlling, by the one or more processors 302 and based on at least one of the flexible inference of latent factors or the flexible decoding of behavior, the external device 410. In this regard, the one or more processors can transmit control signals (e.g., wirelessly or in a wired manner) through the communications interface 308 to the external device 410. In various embodiments, the external device comprises one of a prosthetic limb, a robot, a computer, a phone, a tablet, or a digital interface.

### Various Systems and Methods Embodiments

As disclosed further herein, there are various systems and methods disclosed herein.

1. A system for at least one of nonlinear inference of latent factors or decoding of behavior from brain signals, the system comprising: a trained neural network configured to perform at least one of: flexible inference of latent factors, wherein the flexible inference of latent factors is performable in a causal inference mode of operation and a non-causal inference mode of operation, or flexible decoding of behavior, wherein the flexible decoding of behavior is performable in a causal decoding mode of operation and a non-causal decoding mode of operation, and one or more processors in operable communication with the trained neural network, the one or more processors configured to: receive a plurality of brain signals; and perform, via the trained neural network, at least one of: the flexible inference of latent factors of the plurality of brain signals in at least one of the causal inference mode of operation or the non-causal inference mode of operation; or the flexible decoding of behavior based on the plurality of brain signals in at least one of the causal decoding mode of operation or the non-causal decoding mode of operation.

2. The system of subparagraph 1, wherein the one or more processors are further configured to: receive a selection for the causal inference mode of operation; and responsive to the selection, the flexible inference of latent factors is performed via causal inference of latent factors of the plurality of brain signals in the causal inference mode of operation.

3. The system of subparagraph 2, wherein the flexible inference of latent factors is done in real time.

4. The system of subparagraph 1, wherein the one or more processors are further configured to: receive a selection for the non-causal inference mode of operation; and responsive to the selection, the flexible inference of latent factors is performed via non-causal inference of latent factors of the plurality of brain signals in the non-causal inference mode of operation.

5. The system of subparagraph 1, wherein the one or more processors are further configured to: receive a selection for the causal decoding mode of operation; and responsive to the selection, the flexible decoding is performed via causal decoding of behavior based on the plurality of brain signals in the causal decoding mode of operation.

6. The system of subparagraph 5, wherein the flexible decoding of behavior is done in real time.

7. The system of subparagraph 1, wherein the one or more processors are further configured to: receive a selection for the non-causal decoding mode of operation; and responsive to the selection, the flexible decoding is performed via non-causal decoding of behavior based on the plurality of brain signals in the non-causal decoding mode of operation.

8. The system of subparagraph 1, wherein the flexible inference of latent factors further comprises a missing samples inference mode of operation where inference is performed with missing samples of the plurality of brain signals.

9. The system of subparagraph 8, wherein the one or more processors are further configured to: receive a selection for a selected mode of operation, the selected mode of operation including one of: the causal inference mode of operation; the non-causal inference mode of operation; the missing samples inference mode of operation; the causal inference mode of operation and the missing samples inference mode of operation; or the non-causal inference mode of operation and the missing samples inference mode of operation; and responsive to the selection, perform the flexible inference of latent factors of the plurality of brain signals in the selected mode of operation.

10. The system of subparagraph 9, wherein the flexible inference of latent factors is done in real time.

11. The system of subparagraph 1, wherein the flexible decoding of behavior further comprises a missing samples decoding mode of operation where decoding is performed with missing samples from the plurality of brain signals.

12. The system of subparagraph 11, wherein the one or more processors are further configured to: receive a selection for a selected mode of operation, the selected mode of operation including one of: the causal decoding mode of operation; the non-causal decoding mode of operation; the missing samples decoding mode of operation; the causal decoding mode of operation and the missing samples decoding mode of operation; or the non-causal decoding mode of operation and the missing samples decoding mode of operation; and responsive to the selection, perform the flexible decoding of behavior based on the plurality of brain signals in the selected mode of operation.

13. The system of subparagraph 12, wherein the flexible decoding is done in real time.

14. The system of subparagraph 1, wherein the trained neural network is coupled to the one or more processors, the trained neural network having at least two sets of latent factors including manifold latent factors and dynamic latent factors.

15. The system of subparagraph 14, wherein the manifold latent factors are observations of the dynamic latent factors.

16. The system of subparagraph 14, wherein a recursion of the dynamic latent factors in time is linear.

17. The system of subparagraph 14, wherein a recursion of the dynamic latent factors in time is locally linear or piece-wise linear.

18. The system of subparagraph 14, wherein the trained neural network further comprises a nonlinear embedding for relating the manifold latent factors to the plurality of brain signals.

19. The system of subparagraph 18, wherein the nonlinear embedding is an autoencoder.

20. The system of subparagraph 19, wherein the autoencoder includes an encoder and a decoder, which are each optionally a multi-layer perceptron (MLP).

21. The system of subparagraph 18, wherein the nonlinear embedding encodes the plurality of brain signals into the manifold latent factors.

22. The system of subparagraph 18, wherein the nonlinear embedding is configured to decode the plurality of brain signals from the manifold latent factors.

23. The system of subparagraph 18, wherein the flexible inference of latent factors comprises a causal inference of latent factors that includes obtaining an initial estimate of the manifold latent factors from the nonlinear embedding and then using them to infer the dynamic latent factors and the manifold latent factors using a Kalman filter.

24. The system of subparagraph 18, wherein the flexible inference of latent factors comprises a non-causal inference of latent factors that includes obtaining an initial estimate of the manifold latent factors from the nonlinear embedding and then using them to infer the dynamic latent factors and the manifold latent factors using a Kalman smoother.

25. The system of subparagraph 18, wherein the flexible inference of latent factors at time-steps when there are missing brain signal samples from the plurality of brain signals includes inferring the dynamic latent factors and the manifold latent factors using a Kalman predictor based on the dynamic latent factors in previous time-steps.

26. The system as in any of subparagraphs 23, 24, or 25, wherein behavior is decoded from the plurality of brain signals based on at least one of the manifold latent factors or the dynamic latent factors.

27. The system of subparagraph 26, wherein behavior is decoded from the at least one of the dynamic latent factors or the manifold latent factors by passing these factors through at least one of a linear matrix multiplication, a neural-network, or a multi-layer perceptron that are trained based on the plurality of brain signals and a plurality of training behavior signals in a training dataset.

28. The system of subparagraph 14, wherein the trained neural network further comprises a mapper neural network configured to relate the manifold latent factors to behavior signals.

29. The system of subparagraph 28, wherein the mapper neural network is a multi-layer perceptron (MLP).

30. The system of subparagraph 14, wherein data inputs are given to at least one of the dynamic latent factors or the manifold latent factors.

31. The system of subparagraph 30, wherein the data inputs comprise at least one of sensory inputs or neurostimulation inputs such as deep brain stimulation (DBS).

32. The system of subparagraph 1, wherein at least one of the flexible inference of latent factors or the flexible decoding of behavior is recursively done, and wherein at least one of current time-step's inference or current time-step's decoding is used recursively for next time-step's inference and next time-step's decoding.

33. The system of subparagraph 1, wherein the plurality of brain signals are continuous.

34. The system of subparagraph 1, wherein the plurality of brain signals are discrete.

35. The system of subparagraph 1, wherein the plurality of brain signals are a mix of continuous signals and discrete signals.

36. The system of subparagraph 1, wherein the plurality of brain signals are modeled as Gaussian.

37. The system of subparagraph 1, wherein the plurality of brain signals are modeled as a generalized linear model, wherein the generalized linear model optionally comprises one of exponential family of distributions or Poisson distribution or Point Process distribution.

38. The system of subparagraph 1, wherein the plurality of brain signals are multimodal brain signals, with two or more modalities.

39. The system of subparagraph 38, wherein the multimodal brain signals are modeled by a combination of Gaussian and at least one of a generalized linear, exponential family, Poisson, or Point Process distribution.

40. The system of subparagraph 38, wherein the multimodal brain signals are modeled by a combination of different probability distributions.

41. The system of subparagraph 1, wherein the trained neural network is pre-trained, via a training process, with a learning cost function that is optimized to learn model parameters.

42. The system of subparagraph 41 wherein the learning cost function includes a future-step-ahead prediction of at least one of the plurality of brain signals.

43. The system of subparagraph 41, wherein the learning cost function is supervised with a plurality of training behavior signals during the training process and includes a behavior-relevant term so that the plurality of training behavior signals is more accurately decoded relative to decoding without including the behavior-relevant term in the learning cost function.

44. The system of subparagraph 43, wherein the learning cost function includes a mix of predictions of at least one of a plurality of training brain signals and at least one of the plurality of training behavior signals, at least at one of a current time-step or future time-steps.

45. The system of subparagraph 41, wherein the learning cost function includes predictions of at least one of a plurality of training brain signals or a plurality of training behavior signals, at least at one of a current time-step or future time-steps.

46. The system of subparagraph 41, wherein the learning cost function has regularization terms including at least one of norm regularization on the model parameters/weights, smoothness regularization on decoder outputs, smoothness regularization on latent factors, dropout in time to imitate a missing sample scenario, or dropout.

47. The system of subparagraph 41, wherein the learning cost function includes a log-likelihood of brain signal distributions, at least at one of a current time-step or future time-steps, and wherein the log-likelihood of brain signal distributions is optionally at least one of Gaussian, generalized linear, exponential family, Poisson, or Point Process.

48. The system of subparagraph 41, wherein other elements are included in the learning cost function including optionally variational elements.

49. The system of subparagraph 38, wherein the trained neural network is pre-trained, via a training process, with two or more modalities of a plurality of training multimodal brain signals.

50. The system of subparagraph 49, wherein the two or more modalities of the plurality of multimodal brain signals are fused together by passing them through a multiscale encoder to obtain an initial estimate of multiscale embedding factors, wherein the initial estimate of multiscale embedding factors become observations of multiscale latent factors within a multiscale linear dynamical model (LDM).

51. The system of subparagraph 50, wherein at least one of multiscale latent factors or multiscale embedding factors are inferred using the flexible inference of latent factors.

52. The system of subparagraph 51, wherein the causal inference mode of operation includes computing the multiscale latent factors based on the initial estimate of multiscale embedding factors using Kalman filtering.

53. The system of subparagraph 51, wherein the non-causal inference mode of operation includes computing the multiscale latent factors based on the initial estimate of multiscale embedding factors using Kalman smoothing.

54. The system of subparagraph 51, wherein behavior is decoded based on at least one of the multiscale latent factors or the multiscale embedding factors that were previously inferred.

55. The system of subparagraph 54, wherein behavior is decoded from the at least one of the multiscale latent factors or the multiscale embedding factors by passing these factors through at least one of a linear matrix multiplication or a neural-network or a multi-layer perceptron that are trained based on the plurality of training multimodal brain signals and a plurality of training behavior signals in a training dataset.

56. The system of subparagraph 51, wherein the multiscale latent factors that were inferred are passed to decoder networks that predict log-likelihood parameters of multiple modalities of the plurality of multimodal brain signals.

57. The system of subparagraph 50, wherein the two or more modalities of the plurality of multimodal brain signals are fused together in the multiscale encoder by passing each modality through a separate neural-network to obtain modality-specific embedding factors which become observations of modality-specific latent factors within modality-specific linear dynamical models (LDM), inferring the modality-specific latent factors with the flexible inference of latent factors, concatenating the modality-specific embedding factors that were previously inferred, and then passing a concatenated inferred modality-specific embedding factors through a final neural-network to get multiscale embedding factors, wherein the separate neural-networks and the final neural-network each optionally include a multi-layer perceptron (MLP).

58. The system of subparagraph 57, wherein the flexible inference of latent factors is performed in the causal inference mode of operation.

59. The system of subparagraph 58, wherein the causal inference mode of operation includes getting the modality-specific latent factors based on the modality-specific embedding factors using Kalman filtering.

60. A method for at least one of inferring spatiotemporal dynamics in a plurality of brain signals or decoding behavior based on the plurality of brain signals, the method comprising: separating, by one or more processors and via a neural network, a plurality of latent factors from a training dataset into a set of dynamic latent factors and a set of manifold latent factors, the training dataset comprising at least one of a plurality of training brain signals or a plurality of training behavior signals; jointly training, by the one or more processors and via the neural network, a machine-learning model with the set of dynamic latent factors and the set of manifold latent factors to generate a trained machine-learning model; and performing, by the one or more processors and via the trained machine-learning model, at least one of: flexible inference of latent factors from the plurality of brain signals, or flexible decoding of behavior based on the plurality of brain signals.

61. The method of subparagraph 60, wherein the jointly training the machine-learning model further comprises predicting, by the one or more processors, at least one of a plurality of current or future brain signals and a plurality of current or future behavior signals, at least at one of a current time-step or time-steps in a future time period.

62. The method of subparagraph 60, wherein the trained machine-learning model is configured to capture, by separating the plurality of latent factors into the set of dynamic latent factors and the set of manifold latent factors, nonlinearity with a link between the set of manifold latent factors and the plurality of brain signals, while keeping dynamics on the set of manifold latent factors one of linear, locally linear, or piece-wise linear.

63. The method of subparagraph 60, wherein prior to the performing the flexible inference of latent factors, the one or more processors receive a selection to perform the flexible inference of latent factors via one of causal inference or non-causal inference.

64. The method of subparagraph 60, wherein the flexible inference of latent factors is performed despite one or more missing samples at any time-step of at least one of the plurality of brain signals.

65. The method of subparagraph 60, wherein the set of manifold latent factors are observations of the set of dynamic latent factors.

66. The method of subparagraph 60, wherein a recursion of the set of dynamic latent factors in time is one of linear, locally linear, or piece-wise linear.

67. The method of subparagraph 60, wherein the jointly training further comprises relating, by the one or more processors and via a nonlinear embedding, the set of manifold latent factors to the plurality of training brain signals in the training dataset.

68. The method of subparagraph 67, wherein the nonlinear embedding is an autoencoder.

69. The method of subparagraph 68, wherein the autoencoder includes an encoder and a decoder, which each are optionally a multi-layer perceptron (MLP).

70. The method of subparagraph 67, wherein the jointly training further comprises encoding, by the one or more processors and via the nonlinear embedding, the training dataset into the set of manifold latent factors.

71. The method of subparagraph 70, wherein the jointly training further comprises decoding, by the one or more processors and via the nonlinear embedding, the plurality of training brain signals from the set of manifold latent factors.

72. The method of subparagraph 60, wherein the jointly training further comprises relating, by the one or more processors and via a mapper neural network, the set of manifold latent factors to the plurality of training behavior signals.

73. The method of subparagraph 72, wherein the mapper neural network is a multi-layer perceptron (MLP).

74. The method of subparagraph 60, wherein the performing of at least one of the flexible inference of latent factors or the flexible decoding of behavior is recursively done, and wherein at least one of current time-step's inference or current time-step's decoding is used recursively for next time-step's inference and next time-step's decoding.

75. The method of subparagraph 60, further comprising receiving, by the one or more processors, the plurality of brain signals continuously over time.

76. The method of subparagraph 60, further comprising receiving, by the one or more processors, the plurality of brain signals, wherein the plurality of brain signals are discrete.

77. The method of subparagraph 60, further comprising receiving, by the one or more processors, the plurality of brain signals, wherein the plurality of brain signals are continuous.

78. The method of subparagraph 60, further comprising receiving, by the one or more processors, the plurality of brain signals, wherein the plurality of brain signals are a mix of continuous and discrete brain signals.

79. The method of subparagraph 60, wherein the jointly training further comprises modeling the set of dynamic latent factors in time with a linear Gaussian model.

80. The method of subparagraph 60, wherein the jointly training further comprises modeling the training dataset as at least one of a Gaussian, generalized linear, exponential family, Poisson, or Point Process distribution.

81. The method of subparagraph 60, wherein the plurality of training brain signals and the plurality of brain signals are multimodal brain signals.

82. The method of subparagraph 81, wherein the multimodal brain signals are modeled, via the neural network, by a combination of Gaussian and at least one of generalized linear or exponential family or Poisson or Point Process distributions to generate the trained machine-learning model.

83. The method of subparagraph 81, wherein the multimodal brain signals are modeled, via the neural network, by a combination of different probability distributions.

84. The method of subparagraph 60, wherein the jointly training further comprises optimizing a learning cost function to learn model parameters of the neural network.

85. The method of subparagraph 84, wherein the learning cost function includes a future-step-ahead prediction of at least one of the plurality of training brain signals.

86. The method of subparagraph 84, wherein the learning cost function is supervised with the plurality of training behavior signals and includes a behavior-relevant term so that the plurality of training behavior signals is more accurately decoded relative to decoding without including the behavior-relevant term in the learning cost function.

87. The method of subparagraph 86, wherein the learning cost function includes a mix of predictions of at least one of the plurality of training brain signals and at least one of the plurality of training behavior signals, at least at one of a current time-step or future time-steps.

88. The method of subparagraph 84, wherein the learning cost function includes predictions of at least one of the plurality of training brain signals or the plurality of training behavior signals, at least at one of a current time-step or future time-steps.

89. The method of subparagraph 84, wherein the learning cost function has regularization terms including at least one of norm regularization on the model parameters/weights, smoothness regularization on decoder outputs, smoothness regularization on latent factors, dropout in time to imitate a missing sample scenario, or dropout.

90. The method of subparagraph 84, wherein the learning cost function includes a log-likelihood of brain signal distributions at least at one of a current time-step or future time-steps, wherein the log-likelihood of brain signal distributions is at least one of Gaussian, generalized linear, exponential family, Poisson, or Point Process.

91. The method of subparagraph 84, wherein other elements are included in the learning cost function, optionally including variational elements.

92. The method of subparagraph 60, wherein data inputs are given to at least one of the set of dynamic latent factors or the set of manifold latent factors, and wherein the data inputs are optionally sensory inputs or neurostimulation inputs such as deep brain stimulation (DBS).

93. The method of subparagraph 81, further comprising fusing together two or more modalities of the multimodal brain signals by passing them through a multiscale encoder to obtain an initial estimate of multiscale embedding factors, wherein the initial estimate of multiscale embedding factors become observations of multiscale latent factors within a multiscale linear dynamical model (LDM).

94. The method of subparagraph 93, wherein at least one of the multiscale latent factors or multiscale embedding factors are inferred using the flexible inference of latent factors, wherein the flexible inference of latent factors is performed in at least one of a causal inference mode of operation or a non-causal inference mode of operation.

95. The method of subparagraph 94, wherein the flexible inference of latent factors is performed in the causal inference mode of operation that includes computing the multiscale latent factors based on the initial estimate of multiscale embedding factors using Kalman filtering.

96. The method of subparagraph 94, wherein the flexible inference of latent factors is performed in the non-causal inference mode of operation that includes computing the multiscale latent factors based on the initial estimate of multiscale embedding factors using Kalman smoothing.

97. The method of subparagraph 94, wherein behavior is decoded based on at least one of the multiscale latent factors or the multiscale embedding factors that were previously inferred.

98. The method of subparagraph 97, wherein behavior is decoded from the at least one of the multiscale latent factors or the multiscale embedding factors, which were previously inferred, by passing these factors through at least one of a linear matrix multiplication or a neural-network or a multi-layer perceptron that are trained based on the multimodal brain signals and behavior signals in a training dataset.

99. The method of subparagraph 93, wherein the multiscale latent factors that were previously inferred are passed to decoder networks that predict log-likelihood parameters of multiple modalities of the multimodal brain signals.

100. The method of subparagraph 93, further comprising fusing together two or more modalities of the multimodal brain signals in a multiscale encoder by passing each modality through a separate neural-network to obtain modality-specific embedding factors which become observations of modality-specific latent factors within modality-specific linear dynamical models (LDM), inferring the modality-specific latent factors with the flexible inference of latent factors, concatenating the modality-specific embedding factors that were previously inferred, and then passing a concatenated inferred modality-specific embedding factors through a final neural-network to get multiscale embedding factors, wherein the separate neural-networks and the final neural-network each optionally include a multi-layer perceptron (MLP).

101. The method of subparagraph 100, wherein the flexible inference of latent factors is performed in a causal inference mode of operation.

102. The method of subparagraph 101, wherein the flexible inference of latent factors is performed in the causal inference mode of operation, which includes getting the modality-specific latent factors based on the modality-specific embedding factors using Kalman filtering.

103. An article of manufacture including one or more non-transitory, tangible computer readable storage mediums having instructions stored thereon that, in response to execution by one or more processors, cause the one or more processors to perform operations comprising: performing, by the one or more processors and via a trained machine-learning model, at least one of: flexible inference of latent factors on a plurality of brain signals; or decoding of behavior based on the plurality of brain signals, wherein the trained machine-learning model is pre-trained by: separating, via a neural network, a plurality of latent factors from a training dataset into a set of dynamic latent factors and a set of manifold latent factors, the training dataset comprising at least one of a plurality of training brain signals or a plurality of training behavior signals; and jointly training, via the neural network, a machine-learning model with the set of dynamic latent factors and the set of manifold latent factors to generate the trained machine-learning model.

104. A brain-computer interface, comprising the article of manufacture of subparagraph 103, the brain-computer interface further comprising one of an implantable device or a wearable device.

105. The brain-computer interface of subparagraph 104, wherein the operations further comprise receiving, by the one or more processors and from the implantable device or the wearable device, the plurality of brain signals.

106. The brain-computer interface of subparagraph 105, wherein the operations of the article of manufacture further comprise controlling, by the one or more processors and based on at least one of the flexible inference of latent factors or the flexible decoding of behavior, an external device.

107. The brain-computer interface of subparagraph 106, wherein the external device comprises one of a prosthetic limb, a robot, a computer, a phone, a tablet, or a digital interface.

108. The article of manufacture of subparagraph 103, wherein at least one of the flexible inference of latent factors or the decoding of behavior is done in real-time.

109. A system for modeling a plurality of brain signals, the system comprising: a brain monitoring device comprising a transmitter and one of an implantable device or a wearable device, the brain monitoring device configured to detect the plurality of brain signals from a brain of a user; and an analysis device comprising: a receiver, one or more processors; and one or more tangible, non-transitory memories configured to communicate with the one or more processors, the one or more tangible, non-transitory memories having instructions stored thereon that, in response to execution by the one or more processors, cause the one or more processors to perform operations comprising: receiving, by the one or more processors and via the receiver, the plurality of brain signals; performing, by the one or more processors and via a trained machine-learning model, at least one of: flexible inference of latent factors based on the plurality of brain signals; or flexible decoding of behavior based on the plurality of brain signals, wherein the trained machine-learning model is pre-trained by: separating, via a neural network, a plurality of latent factors from a training dataset into a set of dynamic latent factors and a set of manifold latent factors; and jointly training, via the neural network, a machine-learning model with the set of dynamic latent factors and the set of manifold latent factors to generate the trained machine-learning model.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” “including,” “includes” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching. CLAIMS

What is claimed is:

1. A system for at least one of nonlinear inference of latent factors or decoding of behavior from brain signals, the system comprising:
a trained neural network configured to perform at least one of:
flexible inference of latent factors, wherein the flexible inference of latent factors is performable in a causal inference mode of operation and a non-causal inference mode of operation, or
flexible decoding of behavior, wherein the flexible decoding of behavior is performable in a causal decoding mode of operation and a non-causal decoding mode of operation, and
one or more processors in operable communication with the trained neural network, the one or more processors configured to:
receive a plurality of brain signals; and
perform, via the trained neural network, at least one of:
the flexible inference of latent factors of the plurality of brain signals in at least one of the causal inference mode of operation or the non-causal inference mode of operation; or
the flexible decoding of behavior based on the plurality of brain signals in at least one of the causal decoding mode of operation or the non-causal decoding mode of operation.

2. The system of claim 1, wherein the one or more processors are further configured to:
receive a selection for the causal inference mode of operation; and
responsive to the selection, the flexible inference of latent factors is performed via causal inference of latent factors of the plurality of brain signals in the causal inference mode of operation, wherein the flexible inference of latent factors is optionally done in real time.

3. The system of claim 1, wherein the one or more processors are further configured to:
receive a selection for the non-causal inference mode of operation; and
responsive to the selection, the flexible inference of latent factors is performed via non-causal inference of latent factors of the plurality of brain signals in the non-causal inference mode of operation.

4. The system of claim 1, wherein the one or more processors are further configured to:
receive a selection for the causal decoding mode of operation; and
responsive to the selection, the flexible decoding is performed via causal decoding of behavior based on the plurality of brain signals in the causal decoding mode of operation, wherein the flexible decoding of behavior is optionally done in real time.

5. The system of claim 1, wherein the one or more processors are further configured to:
receive a selection for the non-causal decoding mode of operation; and
responsive to the selection, the flexible decoding is performed via non-causal decoding of behavior based on the plurality of brain signals in the non-causal decoding mode of operation.

6. The system of claim 1, wherein:
the flexible inference of latent factors further comprises a missing samples inference mode of operation where inference is performed with missing samples of the plurality of brain signals, and
the one or more processors are further configured to:
receive a selection for a selected mode of operation, the selected mode of operation including one of:
the causal inference mode of operation;
the non-causal inference mode of operation;
the missing samples inference mode of operation;
the causal inference mode of operation and the missing samples inference mode of operation; or
the non-causal inference mode of operation and the missing samples inference mode of operation; and
responsive to the selection, perform the flexible inference of latent factors of the plurality of brain signals in the selected mode of operation.

7. The system of claim 1, wherein:
the flexible decoding of behavior further comprises a missing samples decoding mode of operation where decoding is performed with missing samples from the plurality of brain signals, and
the one or more processors are further configured to:
receive a selection for a selected mode of operation, the selected mode of operation including one of:
the causal decoding mode of operation;
the non-causal decoding mode of operation;
the missing samples decoding mode of operation;
the causal decoding mode of operation and the missing samples decoding mode of operation; or
the non-causal decoding mode of operation and the missing samples decoding mode of operation; and
responsive to the selection, perform the flexible decoding of behavior based on the plurality of brain signals in the selected mode of operation.

8. The system of claim 1, wherein:
the trained neural network is coupled to the one or more processors, the trained neural network having at least two sets of latent factors including manifold latent factors and dynamic latent factors, and at least one of:
the manifold latent factors are observations of the dynamic latent factors,
a recursion of the dynamic latent factors in time is linear,
the recursion of the dynamic latent factors in time is locally linear or piece-wise linear,
the trained neural network further comprises a nonlinear embedding for relating the manifold latent factors to the plurality of brain signals,
the trained neural network optionally further comprises a mapper neural network configured to relate the manifold latent factors to behavior signals, or
data inputs are optionally given to at least one of the dynamic latent factors or the manifold latent factors.

9. The system of claim 1, wherein:
the trained neural network is coupled to the one or more processors, the trained neural network having at least two sets of latent factors including manifold latent factors and dynamic latent factors,
the trained neural network further comprises a nonlinear embedding for relating the manifold latent factors to the plurality of brain signals, and at least one of:
the nonlinear embedding is an autoencoder;
the nonlinear embedding encodes the plurality of brain signals into the manifold latent factors;
the nonlinear embedding is configured to decode the plurality of brain signals from the manifold latent factors;
the flexible inference of latent factors comprises a causal inference of latent factors that includes obtaining an initial estimate of the manifold latent factors from the nonlinear embedding and then using them to infer the dynamic latent factors and the manifold latent factors using a Kalman filter;
the flexible inference of latent factors comprises a non-causal inference of latent factors that includes obtaining the initial estimate of the manifold latent factors from the nonlinear embedding and then using them to infer the dynamic latent factors and the manifold latent factors using a Kalman smoother; or
the flexible inference of latent factors at time-steps when there are missing brain signal samples from the plurality of brain signals includes inferring the dynamic latent factors and the manifold latent factors using a Kalman predictor based on the dynamic latent factors in previous time-steps.

10. The system of claim 9, wherein:
behavior is decoded from the plurality of brain signals based on at least one of the manifold latent factors or the dynamic latent factors, and
the behavior is decoded from the at least one of the dynamic latent factors or the manifold latent factors by passing these factors through at least one of a linear matrix multiplication, a neural-network, or a multi-layer perceptron, a regression, or any function that are trained based on the plurality of brain signals and a plurality of training behavior signals in a training dataset.

11. The system of claim 1, wherein at least one of the flexible inference of latent factors or the flexible decoding of behavior is recursively done, and wherein at least one of current time-step's inference or current time-step's decoding is used recursively for next time-step's inference and next time-step's decoding.

12. The system of claim 1, wherein the plurality of brain signals are one of continuous, discrete, or a mix of continuous signals and discrete signals.

13. The system of claim 1, wherein the plurality of brain signals are modeled as one of Gaussian, generalized linear, exponential family, Poisson, or Point Process distributions.

14. The system of claim 1, wherein:
the plurality of brain signals are multimodal brain signals, with two or more modalities, and at least one of:
the multimodal brain signals are modeled by a combination of Gaussian and at least one of a generalized linear, exponential family, Poisson, or Point Process distribution; or
the multimodal brain signals are modeled by a combination of different probability distributions.

15. The system of claim 1, wherein the trained neural network is pre-trained, via a training process, with a learning cost function that is optimized to learn model parameters, and at least one of:
the learning cost function includes a future-step-ahead prediction of at least one of the plurality of brain signals;
the learning cost function is supervised with a plurality of training behavior signals during the training process and includes a behavior-relevant term so that the plurality of training behavior signals is more accurately decoded relative to decoding without including the behavior-relevant term in the learning cost function;
the learning cost function includes predictions of at least one of a plurality of training brain signals or the plurality of training behavior signals, at least at one of a current time-step or future time-steps;
the learning cost function has regularization terms including at least one of norm regularization on model parameters/weights, smoothness regularization on decoder outputs, smoothness regularization on latent factors, dropout in time to imitate a missing sample scenario, or dropout;
the learning cost function includes a log-likelihood of brain signal distributions, at least at one of the current time-step or future time-steps, and wherein the log-likelihood of brain signal distributions is optionally at least one of Gaussian, generalized linear, exponential family, Poisson, or Point Process; or
other elements are included in the learning cost function including optionally variational elements.

16. The system of claim 1, wherein:
the plurality of brain signals are multimodal brain signals, with two or more modalities,
the trained neural network is pre-trained, via a training process, with the two or more modalities of a plurality of training multimodal brain signals,
the two or more modalities of the multimodal brain signals are fused together by passing them through a multiscale encoder to obtain an initial estimate of multiscale embedding factors, wherein the initial estimate of multiscale embedding factors become observations of multiscale latent factors within a multiscale dynamical model, and
at least one of multiscale latent factors or multiscale embedding factors are inferred using the flexible inference of latent factors.

17. The system of claim 16, wherein at least one of:
the causal inference mode of operation includes computing the multiscale latent factors based on the initial estimate of multiscale embedding factors using Kalman filtering,
the non-causal inference mode of operation includes computing the multiscale latent factors based on the initial estimate of multiscale embedding factors using Kalman smoothing,
the behavior is decoded based on at least one of the multiscale latent factors or the multiscale embedding factors that were previously inferred, or
the multiscale latent factors that were inferred are passed to decoder networks that predict log-likelihood parameters of multiple modalities of the multimodal brain signals.

18. A method for at least one of inferring spatiotemporal dynamics in a plurality of brain signals or decoding behavior based on the plurality of brain signals, the method comprising:
separating, by one or more processors and via a neural network, a plurality of latent factors from a training dataset into a set of dynamic latent factors and a set of manifold latent factors, the training dataset comprising at least one of a plurality of training brain signals or a plurality of training behavior signals;
jointly training, by the one or more processors and via the neural network, a machine-learning model with the set of dynamic latent factors and the set of manifold latent factors to generate a trained machine-learning model; and
performing, by the one or more processors and via the trained machine-learning model, at least one of:
flexible inference of latent factors from the plurality of brain signals, or
flexible decoding of behavior based on the plurality of brain signals.

19. The method of claim 18, wherein the jointly training the machine-learning model further comprises predicting, by the one or more processors, at least one of a plurality of current or future brain signals and a plurality of current or future behavior signals, at least at one of a current time-step or time-steps in a future time period.

20. The method of claim 18, wherein the trained machine-learning model is configured to capture, by separating the plurality of latent factors into the set of dynamic latent factors and the set of manifold latent factors, nonlinearity with a link between the set of manifold latent factors and the plurality of brain signals, while keeping dynamics on the set of manifold latent factors one of linear, locally linear, or piece-wise linear.

21. The method of claim 18, wherein:
prior to the performing the flexible inference of latent factors, the one or more processors receive a selection to perform the flexible inference of latent factors via one of causal inference or non-causal inference, and
herein the flexible inference of latent factors is performed despite one or more missing samples at any time-step of at least one of the plurality of brain signals.

22. The method of claim 18, wherein at least one of:
the jointly training further comprises relating, by the one or more processors and via a mapper neural network, the set of manifold latent factors to the plurality of training behavior signals; or
the jointly training further comprises giving data inputs to at least one of the set of dynamic latent factors or the set of manifold latent factors, wherein the data inputs are optionally sensory inputs or neurostimulation inputs such as deep brain stimulation (DBS.

23. The method of claim 18, wherein:
the jointly training further comprises at least one of
encoding, by the one or more processors and via the nonlinear embedding, the training dataset into the set of manifold latent factors, or
decoding, by the one or more processors and via the nonlinear embedding, the plurality of training brain signals from the set of manifold latent factors.

24. The method of claim 22, wherein the plurality of training brain signals and the plurality of brain signals are multimodal brain signals.

25. The method of claim 24, wherein at least one of
the multimodal brain signals are modeled, via the neural network, by a combination of Gaussian and at least one of generalized linear or exponential family or Poisson or Point Process distributions to generate the trained machine-learning model, or
the multimodal brain signals are modeled, via the neural network, by a combination of different probability distributions.

26. The method of claim 18, wherein the jointly training further comprises optimizing a learning cost function to learn model parameters of the neural network.

27. The method of claim 26, wherein at least one of:
the learning cost function includes a future-step-ahead prediction of at least one of the plurality of training brain signals;
the learning cost function is supervised with the plurality of training behavior signals and includes a behavior-relevant term so that the plurality of training behavior signals is more accurately decoded relative to decoding without including the behavior-relevant term in the learning cost function;
the learning cost function includes predictions of at least one of the plurality of training brain signals or the plurality of training behavior signals, at least at one of a current time-step or future time-steps;
the learning cost function has regularization terms including at least one of norm regularization on model parameters/weights, smoothness regularization on decoder outputs, smoothness regularization on latent factors, dropout in time to imitate a missing sample scenario, or dropout;
the learning cost function includes a log-likelihood of brain signal distributions at least at one of the current time-step or future time-steps, wherein the log-likelihood of brain signal distributions is at least one of Gaussian, generalized linear, exponential family, Poisson, or Point Process, or
other elements are included in the learning cost function, optionally including variational elements.

28. An article of manufacture including one or more non-transitory, tangible computer readable storage mediums having instructions stored thereon that, in response to execution by one or more processors, cause the one or more processors to perform operations comprising:
performing, by the one or more processors and via a trained machine-learning model, at least one of:
flexible inference of latent factors on a plurality of brain signals; or
flexible decoding of behavior based on the plurality of brain signals, wherein the trained machine-learning model is pre-trained by:
separating, via a neural network, a plurality of latent factors from a training dataset into a set of dynamic latent factors and a set of manifold latent factors, the training dataset comprising at least one of a plurality of training brain signals or a plurality of training behavior signals; and
jointly training, via the neural network, a machine-learning model with the set of dynamic latent factors and the set of manifold latent factors to generate the trained machine-learning model.

29. A brain-computer interface, comprising the article of manufacture of claim 28, the brain-computer interface further comprising one of an implantable device or a wearable device.

30. The brain-computer interface of claim 29, wherein the operations further comprise:
receiving, by the one or more processors and from the implantable device or the wearable device, the plurality of brain signals,
controlling, by the one or more processors and based on at least one of the flexible inference of latent factors or the flexible decoding of behavior, an external device, wherein the external device comprises at least one of a prosthetic limb, a robot, a computer, a phone, a tablet, or a digital interface.
